(19) United States
(12) Patent Application Publication
(10) Pub. No.: US 2024/0106087 A1
(43) Pub. Date: Mar. 28, 2024

(54) JOINING METHODS AND DEVICES MADE USING SAID METHODS

(71) Applicants: Ohio State Innovation Foundation, Columbus, OH (US); Soteria Battery Innovation Group, Inc., Greenville, SC (US)

(72) Inventors: Nathaniel Colvin, Columbus, OH (US); Avraham Benatar, Columbus, OH (US); Carl Hu, Greenville, SC (US); Drew Pereira, Greenville, SC (US); Brian Morin, Greenville, SC (US)

(21) Appl. No.: 18/372,224

(22) Filed: Sep. 25, 2023

Related U.S. Application Data
(60) Provisional application No. 63/409,931, filed on Sep. 26, 2022.

(51) Int. Cl. H01M 50/536; B23K 1/00; H01M 4/66; H01M 4/70

(52) U.S. Cl. CPC H01M 50/536; B23K 1/0016; H01M 4/661; H01M 4/667; H01M 4/70; H01M 2004/021

(57) ABSTRACT

Disclosed herein are joining methods (e.g., methods of forming a joined material) and devices comprising materials joined by said methods. For example, the disclosed subject matter related to methods of joining one or more metallized polymer current collectors together and/or to a tab. For example, the methods can comprise: placing one or more metallized polymer current collector proximate a tab, such that at least a portion of the metallized polymer current collector(s) overlaps with at least a portion of the tab in an overlap region; placing a conductive material proximate the overlap region; inducing flow of the conductive material such that the conductive material flows at least between the portion of the metallized polymer current collector(s) and the portion of the tab; and subsequently solidifying the conductive material, thereby forming a joint that joins the metallized polymer current collector(s) to the tab.

### CROSS-REFERENCE TO RELATED APPLICATIONS

This application claims the benefit of priority to U.S. Provisional Application Ser. No. 63/409,931 filed Sep. 26, 2022, which is hereby incorporated herein by reference in its entirety.

### STATEMENT OF GOVERNMENT SUPPORT

This invention was made with government support under contract number 1539992 awarded by the National Science Foundation. The government has certain rights in the invention.

### BACKGROUND

Lithium-ion batteries have dominated the battery market due to their numerous advantages over other battery cells/chemistries. Conversely, a disadvantage of Li-ion batteries includes potential for thermal runaway events and battery fires.

Thermal runaway in lithium-ion batteries, which can lead to fires and violent explosions, can have many different causes and characteristics. Batteries should include safety measures to prevent thermal runaway and/or internal short circuits.

One such measure to prevent thermal runaway and electrically isolate internal short circuits is by using metallized polymer current collectors (MPCC). However, due to their material characteristics (e.g., composition and/or thickness), it is difficult to join such metallized polymer current collectors together and/or to battery tabs such that the joints have sufficient electrical and/or mechanical properties. To meet mechanical and electrical performance metrics, new joining methods are needed. The methods and devices discussed herein address these and other needs.

### SUMMARY

In accordance with the purposes of the disclosed devices, methods, and systems as embodied and broadly described herein, the disclosed subject matter relates to joining methods (e.g., methods of forming a joined material) and devices comprising materials joined by said methods. For example, the disclosed subject matter related to methods of joining one or more metallized polymer current collectors together and/or to a tab.

For example, disclosed herein are joining methods (e.g., methods of forming a joined material), the methods comprising: placing one or more metallized polymer current collectors proximate a tab, such that at least a portion of the one or more metallized polymer current collectors overlaps with at least a portion of the tab in an overlap region; placing a conductive material proximate the overlap region; inducing flow of the conductive material such that the conductive material flows at least between the portion of the one or more metallized polymer current collectors and the portion of the tab in the overlap region; and subsequent to inducing flow, solidifying the conductive material, thereby forming a joint that joins the one or more metallized polymer current collectors to the tab. Each of the one or more of metallized polymer current collectors independently comprises: a polymer layer having a first surface and a second surface opposite and spaced apart from the first surface; a first metal layer disposed on the first surface of the polymer layer; and a second metal layer disposed on the second surface of the polymer layer; such that the polymer layer is sandwiched between and in physical contact with the first metal layer and the second metal layer.

In some examples, inducing flow of the conductive material comprises applying ultrasonics, applying thermal energy, or a combination thereof. In some examples, inducing flow comprises applying ultrasonics.

In some examples, the method further comprises: positioning at least a portion of the one or more polymer current collectors, at least a portion of the tab, and at least a portion of the conductive material between an ultrasonic horn and an anvil; subsequently applying ultrasonics for an amount of time via the ultrasonic horn to thereby induce flow of the conductive material; and after the amount of time, ceasing to apply ultrasonics. In some examples, the ultrasonic horn comprises a knurled horn.

In some examples, ultrasonics are applied for an amount of time of from 0.1 second to 10 seconds. In some examples, the ultrasonics are applied at an amplitude of from 1 μm to 50 μm. In some examples, the method further comprises applying a pressure to at least a portion of the one or more metallized polymer current collectors during the application of ultrasonics, wherein the pressure is from 0.1 psi to 100 psi.

In some examples, inducing flow further comprises applying thermal energy before and/or concurrently with the application of ultrasonics in order to induce flow of the conductive material.

In some examples, the method further comprises ceasing ultrasonics, removing thermal energy, or a combination thereof thereby solidifying the conductive material.

In some examples, the method further comprises forming a stack having a plurality of layers comprising the one or more metallized polymer current collectors, the stack extending from a top surface to a bottom surface, such that: placing the one or more metallized polymer current collectors on the tab comprises placing the stack on the tab, inducing flow of the conductive material further causes the conductive material to flow between at least partially between each of the plurality of layers, and the joint formed by the method further joins the plurality of layers of the stack together. In some examples, forming the stack comprises stacking and/or folding the one or more metallized polymer current collectors.

In some examples, the one or more metallized polymer current collectors comprises a plurality of metallized polymer current collectors and forming the stack comprises stacking the plurality of metallized polymer current collectors on top of each other from a first metallized polymer current collector to a last metallized polymer current collector, such that: the second metal layer of a preceding metallized polymer current collector is disposed above and proximate to the first metal layer of a subsequent metallized polymer current collector; the first metal layer of the first metallized polymer current collector is the top surface of the stack; and the second metal layer of the last metallized polymer current collector is the bottom surface of the stack.

In some examples, a gap exists between at least a portion of a preceding layer and a subsequent layer within the stack.

In some examples, at least a portion of a preceding layer is disposed on and in physical contact with a subsequent layer within the stack.

In some examples, at least a portion of one or more of the one or more metallized polymer current collectors further comprises a texture (e.g., such that said portion is not flat). In some examples, the method further comprises texturing at least a portion of one or more of the one or more metallized polymer current collectors.

In some examples, one or more of the one or more metallized polymer current collectors further comprises a puncture (e.g., one or more punctures) extending through said metallized polymer current collector. In some examples, the stack further comprises a puncture (e.g., one or more punctures) extending through the stack, the top surface, and the bottom surface. In some examples, the method further comprises creating said puncture. In some examples, creating the puncture comprises using a punching tool, a laser, ultrasonic welding, chemical etching, or a combination thereof. In some examples, inducing flow of the conductive material further causes the conductive material to flow at least partially through the puncture.

In some examples, the total number of metallized polymer current collectors is from 1 to 1000. In some examples, the total number of metallized polymer current collectors is 3 or more, 8 or more, 16 or more, 32 or more, or 64 or more.

In some examples, each of the one or more metallized polymer current collectors independently has an average thickness of from 1 micrometer to 50 micrometers.

In some examples, the polymer layer of each of the one or more metallized polymer current collectors independently has an average thickness of from 1 micrometer to 50 micrometers. In some examples, the polymer layer of each of the one or more metallized polymer current collectors independently comprises polypropylene, polyethylene, polyethylene terephthalate (PET), polyethylene napthalate (PEN), polyvinyl alcohol (PVA), polyaramid (e.g., Kevlar, Nomex), polyamides (e.g., nylon), polyimide (e.g., Kapton), derivatives thereof, or combinations thereof.

In some examples, the first metal layer of each of the one or more metallized polymer current collectors independently has an average thickness of from 10 nanometers to 5 micrometers. In some examples, the first metal layer of each of the one or more metallized polymer current collectors independently comprises Al, Cu, Zn, Sn, Si, Pb, Ti, Li, or a combination thereof.

In some examples, the second metal layer of each of the one or more metallized polymer current collectors independently has an average thickness of from 10 nanometers to 5 micrometers. In some examples, the second metal layer of each of the one or more metallized polymer current collectors independently comprises Al, Cu, Zn, Sn, Si, Pb, Ti, Li, or a combination thereof.

In some examples, the first metal layer and the second metal layer of each of the one or more metallized polymer current collectors independently are substantially the same. In some examples, each of the one or more metallized polymer current collectors is substantially the same.

In some examples, the conductive material comprises soldering material. In some examples, the method comprises ultrasonic assisted soldering. In some examples, the method comprises fluxless ultrasonic assisted soldering.

In some examples, the conductive material comprises an electrically conductive adhesive. In some examples, placing the conductive material proximate the overlap region comprises coating at least a portion of the one or more metallized polymer current collectors, at least a portion of the tab, or a combination thereof with the electrically conductive adhesive. In some examples, the electrically conductive adhesive comprises an adhesive and a plurality of electrically conductive particles. In some examples, the electrically conductive adhesive comprises an electrically conductive polymer.

In some examples, the joint and/or the joined material has improved mechanical and/or electrical properties relative to a joint and/or joined material made by a different method. In some examples, the joint has an average mechanical pull strength of from 1 Newton (N) to 100 N, an average mechanical peel strength of from 0.1 N to 20 N, or a combination thereof. In some examples, the joint and/or the joined material supports a current of 1 milliAmpere (mA) or more for an amount of time of 1 second or more. In some examples, the join and/or the joined material has a resistance of 1 ohms or less.

Also disclosed herein are devices comprising the joint and/or joined material made by any of the methods disclosed herein. In some examples, the device comprises an energy storage device, an electronic device, or a combination thereof. In some examples, the device comprises a battery, a capacitor, or a supercapacitor. In some examples, the device comprises a lithium ion battery.

Also disclosed herein are joined materials made by any of the methods disclosed herein.

Also disclosed herein are joined materials comprising: one or more metallized polymer current collectors, a tab, and a conductive material; wherein the one or more metallized polymer current collectors are joined to the tab via a joint; wherein the joint comprises a conductive material; wherein at least a portion of the joint is sandwiched between the tab and the one or more metallized current collectors. In some examples, each of the one or more of metallized polymer current collectors independently comprises: a polymer layer having a first surface and a second surface opposite and spaced apart from the first surface; a first metal layer disposed on the first surface of the polymer layer; and a second metal layer disposed on the second surface of the polymer layer; such that the polymer layer is sandwiched between and in physical contact with the first metal layer and the second metal layer.

In some examples, the conductive material is not the same material as the tab and/or the one or more metallized current collectors.

In some examples, the one or more metallized current collectors comprise a stack having a plurality of layers, the stack extending from a top surface to a bottom surface, and wherein the conductive material is further disposed between at least a portion of each of the plurality of layers such that the plurality of layers are joined together. In some examples, a gap exists between at least a portion of a preceding layer and a subsequent layer within the stack. In some examples, at least a portion of a preceding layer is disposed on and in physical contact with a subsequent layer within the stack.

In some examples, at least a portion of one or more of the one or more metallized polymer current collectors further comprises a texture (e.g., such that said portion is not flat). In some examples, one or more of the one or more metallized polymer current collectors further comprises a puncture (e.g., one or more punctures) extending through said metallized polymer current collector. In some examples, the stack further comprises a puncture (e.g., one or more punctures) extending through the stack, the top surface, and the bottom surface. In some examples, the puncture is at least partially filled with the conductive material.

In some examples, the total number of metallized polymer current collectors is from 1 to 1000. In some examples, the total number of metallized polymer current collectors is 3 or more, 8 or more, 16 or more, 32 or more, or 64 or more.

In some examples, each of the one or more metallized polymer current collectors independently has an average thickness of from 1 micrometer to 50 micrometers.

In some examples, the polymer layer of each of the one or more metallized polymer current collectors independently has an average thickness of from 1 micrometer to 50 micrometers. In some examples, the polymer layer of each of the one or more metallized polymer current collectors independently comprises polypropylene, polyethylene, polyethylene terephthalate (PET), polyethylene napthalate (PEN), polyvinyl alcohol (PVA), polyaramid (e.g., Kevlar, Nomex), polyamides (e.g., nylon), polyimide (e.g., Kapton), derivatives thereof, or combinations thereof.

In some examples, the first metal layer of each of the one or more metallized polymer current collectors independently has an average thickness of from 10 nanometers to 5 micrometers. In some examples, the first metal layer of each of the one or more metallized polymer current collectors independently comprises Al, Cu, Zn, Sn, Si, Pb, Ti, Li, or a combination thereof.

In some examples, the second metal layer of each of the one or more metallized polymer current collectors independently has an average thickness of from 10 nanometers to 5 micrometers. In some examples, the second metal layer of each of the one or more metallized polymer current collectors independently comprises Al, Cu, Zn, Sn, Si, Pb, Ti, Li, or a combination thereof.

In some examples, the first metal layer and the second metal layer of each of the one or more metallized polymer current collectors independently are substantially the same.

In some examples, each of the one or more metallized polymer current collectors is substantially the same.

In some examples, the conductive material comprises soldering material.

In some examples, the conductive material comprises an electrically conductive adhesive. In some examples, the electrically conductive adhesive comprises an adhesive and a plurality of electrically conductive particles. In some examples, the electrically conductive adhesive comprises an electrically conductive polymer.

In some examples, the joint and/or the joined material has improved mechanical and/or electrical properties. In some examples, the joint has an average mechanical pull strength of from 1 Newton (N) to 100 N, an average mechanical peel strength of from 0.1 N to 20 N, or a combination thereof. In some examples, the joint and/or the joined material supports a current of 1 milliAmpere (mA) or more for an amount of time of 1 second or more. In some examples, the join and/or the joined material has a resistance of 1 ohms or less.

Also disclosed herein are methods of making any of the joined materials disclosed herein, for example using any of the methods disclosed herein.

Also disclosed herein are devices comprising any of the joined materials disclosed herein. In some examples, the device comprises an energy storage device, an electronic device, or a combination thereof. In some examples, the device comprises a battery, a capacitor, or a supercapacitor. In some examples, the device comprises a lithium ion battery.

Additional advantages of the disclosed devices, systems, and methods will be set forth in part in the description which follows, and in part will be obvious from the description. The advantages of the disclosed devices, systems, and methods will be realized and attained by means of the elements and combinations particularly pointed out in the appended claims. It is to be understood that both the foregoing general description and the following detailed description are exemplary and explanatory only and are not restrictive of the disclosed devices, systems, and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Abuse conditions of an internal short circuit in Li-ion battery (LIB) (X. Feng et Al., “Energy Storage Materials, Vol. 10, pg. 246-267, 2018).

FIG. 2. Nail penetration and internal short circuit (ISC) of standard current collector versus metallized polymer current collector (MPCC) with thermal runaway prevention mechanism (M. Pham et al., Cell Reports Physical Science, Vol. 2, Issue 3, 2021, 100360).

FIG. 3. Schematic of Cylindrical Battery (K. W. Beard and T. B. Reddy, “Linden's Handbook of Batteries: Fifth Edition.” McGraw-Hill Education, 2019).

FIG. 4. Joining of Copper metallized polymer current collector to Nickel Tab Using Copper “Bridging” Foil, Adapted from Y. Ye et al., Nature Energy, Vol 5, pg. 786-793, 2020.

FIG. 5. Current Flow in Single Tab and Multiple Tab Battery Designs (X.-Y. Yao et al., IEEE Access, Vol. 7, pg. 24,082-24,095, 2019).

FIG. 6. Cross Section of a Metallized Film Capacitor (S. S. Park et al., “Characterization of Metal Contact Layer Prepared by Arc Spray Method and Their Effects in Metallized Film Capacitor.” Proceedings of the 5th International Conference on Properties and Applications of Dielectric Materials, 1997).

FIG. 7. Metallized film current collector/tab.

FIG. 8. Cross-sectional image of a weld divot.

FIG. 9. Cross-sectional image of a weld divot.

FIG. 10. Top view of film punctured with knurling tool after solder application.

FIG. 11. Microscopy image of the ultrasonic assisted soldering/knurling tool punctured stack.

FIG. 12. Photographs of tab side of films punctured with knurling tool.

FIG. 13. Imaging of a sample that shows that solder was found ˜6 mm from the solder joint.

FIG. 14. Layer by layer resistance measurement performed on the sample prepared from a 32 film stack perforated with the soldering iron.

FIG. 15. A Tab-film joint failed at the interface of the solder joint.

FIG. 16. Optical macroscopic image of the solder disk/hole punch joint.

FIG. 17. Optical microscopy images of the solder disk/hole punch joint.

FIG. 18. Optical microscopy images of the solder disk/hole punch joint.

FIG. 19. Optical microscopy image and analysis of the solder disk/hole punch joint.

FIG. 20. Ohmmeter resistance readings layer by layer (32 films) for 3 samples formed using the hole punch tool.

FIG. 21. Image of fixture.

FIG. 22. Schematic diagram of fixture.

FIG. 23. Image of sample prepared using fixture.

FIG. 24. Horn attachment used in an ultrasonic staking process.

FIG. 25. Image showing difficulty in aligning horn attachment with solder.

FIG. 26. Micrograph of hybrid joint.

FIG. 27. Tests were performed by dipping a tab with 8 layers of film into solder (no ultrasonics).

FIG. 28. Result of test shown in FIG. 27 shows that there was no wetting as well as film degradation due to the high solder temperature.

FIG. 29. Custom built ultrasonic solder bath using 20 kHz Branson DSX power supply.

FIG. 30. Cross-section of 32 metallized polymer current collectors between two tabs after dipping in ultrasonic solder bath.

FIG. 31. Layer-by-layer resistance measurements of seven ultrasonic metal welds.

FIG. 32. Layer-by-layer resistance measurements of 9 hybrid joints.

FIG. 33. Composite results for the layer-by-layer measurements.

FIG. 34. Results of layer-by-layer pull strength of three joints.

FIG. 35. Layer-by-layer peel strength of one joint.

FIG. 36. Results of the full stack pull testing at 80% and 100% amplitude.

FIG. 37. Results of the full stack peel testing at 80% and 100% amplitude.

FIG. 38. Results of the layer-by-layer peel testing.

FIG. 39. Results of the layer-by-layer peel testing.

FIG. 40. Results of the layer-by-layer pull testing.

FIG. 41. Results of the layer-by-layer peel testing.

### DETAILED DESCRIPTION

The devices, methods, and systems described herein may be understood more readily by reference to the following detailed description of specific aspects of the disclosed subject matter and the Examples included therein.

Before the present devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### Methods of Forming a Joined Material

Disclosed herein are joining methods (e.g., methods of forming a joined material), joined materials, and devices comprising said joined materials. For example, the disclosed subject matter relates to methods of joining one or more metallized polymer current collectors together and/or to a tab.

For example, disclosed herein are joining methods (e.g., a method of forming a joined material), the methods comprising placing one or more metallized polymer current collectors proximate a tab, such that at least a portion of the one or more metallized polymer current collectors overlaps with at least a portion of the tab in an overlap region; placing a conductive material proximate the overlap region; inducing flow of the conductive material such that the conductive material flows at least between the portion of the one or more metallized polymer current collectors and the portion of the tab in the overlap region; and subsequent to inducing flow, solidifying the conductive material, thereby forming a joint that joins the one or more metallized polymer current collectors to the tab.

The tab can comprise any suitable material, such as those generally known in the art. For example, the tab can comprise a metal or an alloy thereof. In some examples, the tab is configured to be attached to an electrode, e.g. for a battery.

Inducing flow of the conductive material can be accomplished by any suitable means. In some examples, inducing flow of the conductive material comprises applying ultrasonics, applying thermal energy (e.g., heat), or a combination thereof.

In some examples, inducing flow comprises applying ultrasonics. In some examples, the methods further comprise: positioning at least a portion of the one or more polymer current collectors, at least a portion of the tab, and at least a portion of the conductive material between an ultrasonic horn and an anvil; subsequently applying ultrasonics for an amount of time via the ultrasonic horn to thereby induce flow of the conductive material; and, after the amount of time, ceasing to apply ultrasonics.

In any of the methods, the ultrasonic horn can, for example, comprise a knurled horn.

In some examples, ultrasonics are applied for an amount of time of 0.1 seconds or more (e.g., 0.25 seconds or more, 0.5 seconds or more, 0.75 seconds or more, 1 second or more, 1.5 seconds or more, 2 seconds or more, 2.5 seconds or more, 3 seconds or more, 3.5 seconds or more, 4 seconds or more, 4.5 seconds or more, 5 seconds or more, 6 seconds or more, 7 seconds or more, 8 seconds or more, or 9 seconds or more). In some examples, ultrasonics are applied for an amount of time of 10 seconds or less (e.g., 9 seconds or less, 8 seconds or less, 7 seconds or less, 6 seconds or less, 5 seconds or less, 4.5 seconds or less, 4 seconds or less, 3.5 seconds or less, 3 seconds or less, 2.5 seconds or less, 2 seconds or less, 1.5 seconds or less, 1 seconds or less, 0.75 seconds or less, 0.5 seconds or less, or 0.25 seconds or less). The amount of time the ultrasonics are applied can range from any of the minimum values described above to any of the maximum values described above. For example, the ultrasonics can be applied for an amount of time of from 0.1 second to 10 seconds (e.g., from 0.1 to 5 seconds, from 5 to 10 seconds, from 0.1 to 1 seconds, from 1 to 10 seconds, from 0.1 to 1 seconds, from 1 to 2.5 seconds, from 2.5 to 5 seconds, from 5 to 7.5 seconds, from 7.5 to 10 seconds, from 0.1 to 9 seconds, from 0.1 to 7.5 seconds, from 0.25 to 10 seconds, from 0.5 to 10 seconds, from 0.75 to 10 seconds, from 2.5 to 10 seconds, from 0.25 to 9 seconds, from 0.5 to 7.5 seconds, or from 1 to 5 seconds).

In some examples, the ultrasonics are applied at an amplitude of 1 micrometer (μm, micron) or more (e.g., 5 μm or more, 10 μm or more, 15 μm or more, 20 μm or more, 25 μm or more, 30 μm or more, 35 μm or more, 40 μm or more, or 45 μm or more). In some examples, the ultrasonics are applied at an amplitude of 50 μm or less (e.g., 45 μm or less, 40 μm or less, 35 μm or less, 30 μm or less, 25 μm or less, 20 μm or less, 15 μm or less, 10 μm or less, or 5 μm or less). The amplitude of the applied ultrasonics can range from any of the minimum values described above to any of the maximum values described above. For example, the ultrasonics can be applied at an amplitude of from 1 micrometer (μm, micron) to 50 μm (e.g., from 1 μm to 25 μm, from 25 μm to 50 μm, from 1 μm to 10 μm, from 10 μm to 20 μm, from 20 μm to 30 μm, from 30 μm to 40 μm, from 40 μm to 50 μm, from 1 μm to 45 μm, from 1 μm to 40 μm, from 1 μm to 35 μm, from 1 μm to 30 μm, from 1 μm to 20 μm, from I um to 15 μm, from 1 μm to 5 μm, from 5 μm to 50 μm, from 10 μm to 50 μm, from 15 μm to 50 μm, from 20 μm to 50 μm, from 30 μm to 50 μm, from 35 μm to 50 μm, from 45 μm to 50 μm, from 5 μm to 45 μm, or from 10 μm to 40 μm).

In some examples, the methods can further comprise applying a pressure to at least a portion of the one or more metallized polymer current collectors during the application of ultrasonics, wherein the pressure is 0.1 psi or more (e.g., 0.25 psi or more, 0.5 psi or more, 0.75 psi or more, 1 psi or more, 2 psi or more, 3 psi or more, 4 psi or more, 5 psi or more, 10 psi or more, 15 psi or more, 20 psi or more, 25 psi or more, 30 psi or more, 35 psi or more, 40 psi or more, 45 psi or more, 50 psi or more, 60 psi or more, 70 psi or more, 80 psi or more, or 90 psi or more). In some examples, the methods can further comprise applying a pressure to at least a portion of the one or more metallized polymer current collectors during the application of ultrasonics, wherein the pressure is 100 psi or less (e.g., 90 psi or less, 80 psi or less, 70 psi or less, 60 psi or less, 50 psi or less, 45 psi or less, 40 psi or less, 35 psi or less, 30 psi or less, 25 psi or less, 20 psi or less, 15 psi or less, 10 psi or less, 5 psi or less, 4 psi or less, 3 psi or less, 2 psi or less, 1 psi or less, 0.75 psi or less, 0.5 psi or less, or 0.25 psi or less). The pressure applied can range from any of the minimum values described above to any of the maximum values described above. For example, the methods can further comprise applying a pressure to at least a portion of the one or more metallized polymer current collectors during the application of ultrasonics, wherein the pressure is from 0.1 psi to 100 psi (e.g., from 0.1 to 50 psi, from 50 to 100 psi, from 0.1 to 20 psi, from 20 to 40 psi, from 40 to 60 psi, from 60 to 80 psi, from 80 to 100 psi, from 0.1 to 90 psi, from 0.1 to 75 psi, from 0.1 to 40 psi, from 0.1 to 30 psi, from 0.1 to 25 psi, from 0.1 to 10 psi, from 1 psi to 100 psi, from 2 to 100 psi, from 3 to 100 psi, from 4 to 100 psi, from 5 to 100 psi, from 10 to 100 psi, from 15 to 100 psi, from 20 to 100 psi, from 25 to 100 psi, from 40 to 100 psi, from 75 to 100 psi, from 0.5 to 90 psi, from 1 to 75 psi, from 5 psi to 50 psi, or from 15 to 30 psi).

In some examples, the methods can further comprise applying a force to at least a portion of the one or more metallized polymer current collectors during the application of ultrasonics, wherein the force is 1 Newton (N) or more (e.g., 2 N or more, 3 N or more, 4 N or more, 5 N or more, 10 N or more, 15 N or more, 20 N or more, 25 N or more, 30 N or more, 35 N or more, 40 N or more, 45 N or more, 50 N or more, 60 N or more, 70 N or more, 80 N or more, 90 N or more, 100 N or more, 125 N or more, 150 N or more, 175 N or more, 200 N or more, 225 N or more, 250 N or more, 300 N or more, 350 N or more, 400 N or more, 450 N or more, 500 N or more, 600 N or more, 700 N or more, 800 N or more, or 900 N or more). In some examples, the methods can further comprise applying a force to at least a portion of the one or more metallized polymer current collectors during the application of ultrasonics, wherein the force is 1 kiloNewton (kN) or less (e.g., 900 N or less, 800 N or less, 700 N or less, 600 N or less, 500 N or less, 450 N or less, 400 N or less, 350 N or less, 300 N or less, 250 N or less, 225 N or less, 200 N or less, 175 N or less, 150 N or less, 125 N or less, 100 N or less, 90 N or less, 80 N or less, 70 N or less, 60 N or less, 50 N or less, 45 N or less, 40 N or less, 35 N or less, 30 N or less, 25 N or less, 20 N or less, 15 N or less, 10 N or less, 5 N or less, 4 N or less, 3 N or less, or 2 N or less). The force applied can range from any of the minimum values described above to any of the maximum values described above. For example, the methods can further comprise applying a force to at least a portion of the one or more metallized polymer current collectors during the application of ultrasonics, wherein the force is from 1 N to 1 kN (e.g., from 1 N to 500 N, from 500 N to 1 kN, from 1 to 200 N, from 200 to 400 N, from 400 N to 600 N, from 600 N to 800 N, from 800 N to 1 kN, from 1 N to 900 N, from 1 N to 750 N, from 1 N to 250 N, from 1 N to 100 N, from 5 N to 1 kN, from 10 N to 1 kN, from 25 N to 1 kN, from 50 N to 1 kN, from 75 N to 1 kN, from 100 N to 1 kN, from 250 N to 1 kN, from 750 N to 1 kN, from 5 N to 900 N, or from 10 N to 750 N).

In some examples, inducing flow further comprises applying thermal energy before and/or concurrently with the application of ultrasonics to thereby induce flow of the conductive material.

In some examples, the method further comprises ceasing ultrasonics, removing thermal energy, or a combination thereof thereby solidifying the conductive material.

The conductive material can comprise any suitable material, such as those known in the art. In some examples, the conductive material is not the same material as the tab and/or the one or more metallized current collectors. Examples of suitable conductive materials include, but are not limited to, conductive polymers, metals, alloys, composite materials, soldering materials, conductive adhesives, etc.

In some examples, the conductive material comprises soldering material (e.g., solder). The soldering material can comprise any suitable soldering material such as those known in the art. In some examples, the method comprises ultrasonic assisted soldering. In some examples, the method comprises fluxless ultrasonic assisted soldering.

In some examples, the conductive material comprises an electrically conductive adhesive. In some examples, placing the conductive material proximate the overlap region comprises coating at least a portion of the one or more metallized polymer current collectors, at least a portion of the tab, or a combination thereof with the electrically conductive adhesive.

The electrically conductive adhesive can comprise any suitable material, such as those known in the art. In some examples, the electrically conductive adhesive comprises an electrically conductive polymer. In some examples, the electrically conductive adhesive comprises an adhesive and a plurality of electrically conductive particles. In some examples, the plurality of electrically conductive particles can comprise any suitable material, such as, for example, a metal and/or an alloy. The adhesive can comprise any suitable adhesive.

Each of the one or more metallized polymer current collectors can, for example, comprise those known in the art, such as those made by Soteria Battery Innovation Group and/or those described in any of U.S. Pat. Nos. 10,700,339; 10,763,481; 10,854,868; 10,957,956; 11,139,510; US Published Patent Application 2021/0057706; US Published Patent Application 2021/0057712; US Published Patent Application 2021/0159507; US Published Patent Application 2021/0226308; US Published Patent Application 2022/0037738; and US Published Patent Application 2022/0045403.

In some examples, each of the one or more metallized polymer current collectors independently comprises: a polymer layer having a first surface and a second surface opposite and spaced apart from the first surface; a first metal layer disposed on the first surface of the polymer layer; and a second metal layer disposed on the second surface of the polymer layer; such that the polymer layer is sandwiched between and in physical contact with the first metal layer and the second metal layer.

The total number of metallized polymer current collectors can, for example, be 1 or more (e.g., 2 or more, 3 or more, 4 or more, 5 or more, 6 or more, 7 or more, 8 or more, 9 or more, 10 or more, 15 or more, 20 or more, 25 or more, 30 or more, 35 or more, 40 or more, 45 or more, 50 or more, 55 or more, 60 or more, 70 or more, 80 or more, 90 or more, 100 or more, 125 or more, 150 or more, 175 or more, 200 or more, 225 or more, 250 or more, 300 or more, 350 or more, 400 or more, 450 or more, 500 or more, 600 or more, 700 or more, 800 or more, or 900 or more). In some examples, the total number of metallized polymer current collectors can be 1000 or less (e.g., 900 or less, 800 or less, 700 or less, 600 or less, 500 or less, 450 or less, 400 or less, 350 or less, 300 or less, 250 or less, 225 or less, 200 or less, 175 or less, 150 or less, 125 or less, 100 or less, 90 or less, 80 or less, 70 or less, 60 or less, 55 or less, 50 or less, 45 or less, 40 or less, 35 or less, 30 or less, 25 or less, 20 or less, 15 or less, 10 or less, 9 or less, 8 or less, 7 or less, 6 or less, 5 or less, 4 or less, 3 or less, or 2 or less). The total number of metallized polymer current collectors can range from any of the minimum values described above to any of the maximum values described above. For example, the total number of metallized polymer current collectors can be from 1 to 1000 (e.g., from 1 to 500, from 500 to 1000, from 1 to 200, from 200 to 400, from 400 to 600, from 600 to 800, from 800 to 1000, from 2 to 1000, from 3 to 1000, from 5 to 1000, from 8 to 1000, from 16 to 1000, from 25 to 1000, from 32 to 1000, from 50 to 1000, from 64 to 1000, from 100 to 1000, from 120 to 1000, from 250 to 1000, from 750 to 1000, from 1 to 900, from 1 to 800, from 1 to 750, from 1 to 400, from 1 to 250, from 1 to 120, from 1 to 100, from 1 to 64, from 1 to 50, from 1 to 32, from 1 to 25, from 1 to 16, from 1 to 8, from 1 to 5, from 2 to 900, from 3 to 800, or from 5 to 500). For example, the total number of metallized polymer current collectors can be 2 or more, 3 or more, 8 or more, 16 or more, 32 or more, 64 or more, 120 or more, 250 or more, or 500 or more.

Each of the one or more metallized polymer current collectors can independently have an average thickness of, for example, 1 micrometer or more (e.g., 2 micrometers or more, 3 micrometers or more, 4 micrometers or more, 5 micrometers or more, 6 micrometers or more, 7 micrometers or more, 8 micrometers or more, 9 micrometers or more, 10 micrometers or more, 11 micrometers or more, 12 micrometers or more, 13 micrometers or more, 14 micrometers or more, 15 micrometers or more, 16 micrometers or more, 17 micrometers or more, 18 micrometers or more, 19 micrometers or more, 20 micrometers or more, 25 micrometers or more, 30 micrometers or more, 35 micrometers or more, 40 micrometers or more, or 45 micrometers or more). In some examples, each of the one or more metallized polymer current collectors can independently have an average thickness of 50 micrometers or less (e.g., 45 micrometers or less, 40 micrometers or less, 35 micrometers or less, 30 micrometers or less, 25 micrometers or less, 20 micrometers or less, 19 micrometers or less, 18 micrometers or less, 17 micrometers or less, 16 micrometers or less, 15 micrometers or less, 14 micrometers or less, 13 micrometers or less, 12 micrometers or less, 11 micrometers or less, 10 micrometers or less, 9 micrometers or less, 8 micrometers or less, 7 micrometers or less, 6 micrometers or less, 5 micrometers or less, 4 micrometers or less, 3 micrometers or less, or 2 micrometers or less). The average thickness of each of the one or more metallized polymer current collectors can independently range from any of the minimum values described above to any of the maximum values described above. For example, each of the one or more metallized polymer current collectors can independently have an average thickness of from 1 micrometer to 50 micrometers (e.g., from 1 to 25 micrometers, from 25 to 50 micrometers, from 1 to 10 micrometers, from 10 to 20 micrometers, from 20 to 30 micrometers, from 30 to 40 micrometers, from 40 to 50 micrometers, from 1 to 45 micrometers, from 1 to 40 micrometers, from 1 to 30 micrometers, from 1 to 20 micrometers, from 1 to 15 micrometers, from 1 to 5 micrometers, from 2 to 50 micrometers, from 3 to 50 micrometers, from 4 to 50 micrometers, from 5 to 50 micrometers, from 10 to 50 micrometers, from 15 to 50 micrometers, from 20 to 50 micrometers, from 30 to 50 micrometers, from 35 to 50 micrometers, from 45 to 50 micrometers, from 2 to 45 micrometers, from 5 to 45 micrometers, or from 1 to 20 micrometers).

The polymer layer of each of the one or more metallized polymer current collectors can independently comprise any suitable material. For example, the polymer layer of each of the one or more metallized polymer current collectors can independently comprises polypropylene, polyethylene, polyethylene terephthalate (PET), polyethylene napthalate (PEN), polyvinyl alcohol (PVA), polyaramid (e.g., Kevlar, Nomex), polyamides (e.g., nylon), polyimide (e.g., Kapton), cellulose, derivatives thereof, or combinations thereof.

In some examples, the polymer layer of each of the one or more metallized polymer current collectors can independently have an average thickness of 1 micrometer or more (e.g., 2 micrometers or more, 3 micrometers or more, 4 micrometers or more, 5 micrometers or more, 6 micrometers or more, 7 micrometers or more, 8 micrometers or more, 9 micrometers or more, 10 micrometers or more, 11 micrometers or more, 12 micrometers or more, 13 micrometers or more, 14 micrometers or more, 15 micrometers or more, 16 micrometers or more, 17 micrometers or more, 18 micrometers or more, 19 micrometers or more, 20 micrometers or more, 25 micrometers or more, 30 micrometers or more, 35 micrometers or more, 40 micrometers or more, or 45 micrometers or more). In some examples, each of the one or more metallized polymer current collectors can independently have an average thickness of 50 micrometers or less (e.g., 45 micrometers or less, 40 micrometers or less, 35 micrometers or less, 30 micrometers or less, 25 micrometers or less, 20 micrometers or less, 19 micrometers or less, 18 micrometers or less, 17 micrometers or less, 16 micrometers or less, 15 micrometers or less, 14 micrometers or less, 13 micrometers or less, 12 micrometers or less, 11 micrometers or less, 10 micrometers or less, 9 micrometers or less, 8 micrometers or less, 7 micrometers or less, 6 micrometers or less, 5 micrometers or less, 4 micrometers or less, 3 micrometers or less, or 2 micrometers or less). The average thickness of each of the one or more metallized polymer current collectors can independently range from any of the minimum values described above to any of the maximum values described above. For example, each of the one or more metallized polymer current collectors can independently have an average thickness of from 1 micrometer to 50 micrometers (e.g., from 1 to 25 micrometers, from 25 to 50 micrometers, from 1 to 10 micrometers, from 10 to 20 micrometers, from 20 to 30 micrometers, from 30 to 40 micrometers, from 40 to 50 micrometers, from 1 to 45 micrometers, from 1 to 40 micrometers, from 1 to 30 micrometers, from 1 to 20 micrometers, from 1 to 15 micrometers, from 1 to 5 micrometers, from 2 to 50 micrometers, from 3 to 50 micrometers, from 4 to 50 micrometers, from 5 to 50 micrometers, from 10 to 50 micrometers, from 15 to 50 micrometers, from 20 to 50 micrometers, from 30 to 50 micrometers, from 35 to 50 micrometers, from 45 to 50 micrometers, from 2 to 45 micrometers, from 5 to 45 micrometers, or from 1 to 20 micrometers).

The first metal layer of each of the one or more metallized polymer current collectors can independently comprise any suitable material. For example, the first metal layer of each of the one or more metallized polymer current collectors can independently comprise a metal (e.g., one or more pure metals, alloy(s), or a combination thereof). For example, the first metal layer of each of the one or more metallized polymer current collectors can independently comprise a metal selected from the group consisting of Li, Be, B, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Tc, Ru, Rh, Pd, Ag, Cd, In, Sn, Sb, Te, Cs, Ba, Hf, Ta, W, Re, Os, Ir, Pt, Au, Hg, TI, Pb, Bi, La, Ce, Pr, Nd, Pm, Sm, Eu, Gd, Tb, Dy, Ho, Er, Tm, Yb, and combinations thereof. In some examples, the first metal layer of each of the one or more metallized polymer current collectors can independently comprise Al, Cu, Zn, Sn, Si, Pb, Ti, Li, or a combination thereof.

In some examples, the first metal layer of each of the one or more metallized polymer current collectors independently has an average thickness of 10 nanometers or more (e.g., 15 nanometers or more, 20 nanometers or more, 25 nanometers or more, 30 nanometers or more, 35 nanometers or more, 40 nanometers or more, 45 nanometers or more, 50 nanometers or more, 60 nanometers or more, 70 nanometers or more, 80 nanometers or more, 90 nanometers or more, 100 nanometers or more, 125 nanometers or more, 150 nanometers or more, 175 nanometers or more, 200 nanometers or more, 225 nanometers or more, 250 nanometers or more, 300 nanometers or more, 350 nanometers or more, 400 nanometers or more, 450 nanometers or more, 500 nanometers or more, 600 nanometers or more, 700 nanometers or more, 800 nanometers or more, 900 nanometers or more, 1 micrometer or more, 1.25 micrometers or more, 1.5 micrometers or more, 1.75 micrometers or more, 2 micrometers or more, 2.25 micrometers or more, 2.5 micrometers or more, 3 micrometers or more, 3.5 micrometers or more, 4 micrometers or more, or 4.5 micrometers or more). In some examples, the first metal layer of each of the one or more metallized polymer current collectors independently has an average thickness of 5 micrometers or less (e.g., 4.5 micrometers or less, 4 micrometers or less, 3.5 micrometers or less, 3 micrometers or less, 2.5 micrometers or less, 2.25 micrometers or less, 2 micrometers or less, 1.75 micrometers or less, 1.5 micrometers or less, 1.25 micrometers or less, 1 micrometer or less, 900 nanometers or less, 800 nanometers or less, 700 nanometers or less, 600 nanometers or less, 500 nanometers or less, 450 nanometers or less, 400 nanometers or less, 350 nanometers or less, 300 nanometers or less, 250 nanometers or less, 225 nanometers or less, 200 nanometers or less, 175 nanometers or less, 150 nanometers or less, 125 nanometers or less, 100 nanometers or less, 90 nanometers or less, 80 nanometers or less, 70 nanometers or less, 60 nanometers or less, 50 nanometers or less, 45 nanometers or less, 40 nanometers or less, 35 nanometers or less, 30 nanometers or less, 25 nanometers or less, 20 nanometers or less, or 15 nanometers or less). The average thickness of the first metal layer of each of the one or more metallized polymer current collectors can independently range from any of the minimum values described above to any of the maximum values described above. For example, the first metal layer of each of the one or more metallized polymer current collectors independently can have an average thickness of from 10 nanometers to 5 micrometers (e.g., from 10 nm to 500 nanometers, from 500 nanometers to 5 micrometers, from 10 nanometers to 100 nanometers, from 100 nanometers to 1 micrometer, from 1 micrometer to 5 micrometers, from 10 nanometers to 2.5 micrometers, from 10 nanometers to 1 micrometer, from 10 nanometers to 750 nanometers, from 10 nanometers to 250 nanometers, from 25 nanometers to 5 micrometers, from 50 nanometers to 5 micrometers, from 100 nanometers to 5 micrometers, from 250 nanometers to 5 micrometers, from 750 nanometers to 5 micrometers, from 25 nanometers to 4 micrometers, from 50 nanometers to 2.5 micrometers, or from 100 nanometers to 1 micrometer).

The second metal layer of each of the one or more metallized polymer current collectors can independently comprise any suitable material. For example, the second metal layer of each of the one or more metallized polymer current collectors can independently comprise a metal (e.g., one or more pure metals, alloy(s), or a combination thereof). For example, the second metal layer of each of the one or more metallized polymer current collectors can independently comprise a metal selected from the group consisting of Li, Be, B, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Tc, Ru, Rh, Pd, Ag, Cd, In, Sn, Sb, Te, Cs, Ba, Hf, Ta, W, Re, Os, Ir, Pt, Au, Hg, TI, Pb, Bi, La, Ce, Pr, Nd, Pm, Sm, Eu, Gd, Tb, Dy, Ho, Er, Tm, Yb, and combinations thereof. In some examples, the second metal layer of each of the one or more metallized polymer current collectors can independently comprise Al, Cu, Zn, Sn, Si, Pb, Ti, Li, or a combination thereof.

In some examples, the second metal layer of each of the one or more metallized polymer current collectors independently has an average thickness of 10 nanometers or more (e.g., 15 nanometers or more, 20 nanometers or more, 25 nanometers or more, 30 nanometers or more, 35 nanometers or more, 40 nanometers or more, 45 nanometers or more, 50 nanometers or more, 60 nanometers or more, 70 nanometers or more, 80 nanometers or more, 90 nanometers or more, 100 nanometers or more, 125 nanometers or more, 150 nanometers or more, 175 nanometers or more, 200 nanometers or more, 225 nanometers or more, 250 nanometers or more, 300 nanometers or more, 350 nanometers or more, 400 nanometers or more, 450 nanometers or more, 500 nanometers or more, 600 nanometers or more, 700 nanometers or more, 800 nanometers or more, 900 nanometers or more, 1 micrometer or more, 1.25 micrometers or more, 1.5 micrometers or more, 1.75 micrometers or more, 2 micrometers or more, 2.25 micrometers or more, 2.5 micrometers or more, 3 micrometers or more, 3.5 micrometers or more, 4 micrometers or more, or 4.5 micrometers or more). In some examples, the second metal layer of each of the one or more metallized polymer current collectors independently has an average thickness of 5 micrometers or less (e.g., 4.5 micrometers or less, 4 micrometers or less, 3.5 micrometers or less, 3 micrometers or less, 2.5 micrometers or less, 2.25 micrometers or less, 2 micrometers or less, 1.75 micrometers or less, 1.5 micrometers or less, 1.25 micrometers or less, 1 micrometer or less, 900 nanometers or less, 800 nanometers or less, 700 nanometers or less, 600 nanometers or less, 500 nanometers or less, 450 nanometers or less, 400 nanometers or less, 350 nanometers or less, 300 nanometers or less, 250 nanometers or less, 225 nanometers or less, 200 nanometers or less, 175 nanometers or less, 150 nanometers or less, 125 nanometers or less, 100 nanometers or less, 90 nanometers or less, 80 nanometers or less, 70 nanometers or less, 60 nanometers or less, 50 nanometers or less, 45 nanometers or less, 40 nanometers or less, 35 nanometers or less, 30 nanometers or less, 25 nanometers or less, 20 nanometers or less, or 15 nanometers or less). The average thickness of the second metal layer of each of the one or more metallized polymer current collectors can independently range from any of the minimum values described above to any of the maximum values described above. For example, the second metal layer of each of the one or more metallized polymer current collectors independently can have an average thickness of from 10 nanometers to 5 micrometers (e.g., from 10 nm to 500 nanometers, from 500 nanometers to 5 micrometers, from 10 nanometers to 100 nanometers, from 100 nanometers to 1 micrometer, from 1 micrometer to 5 micrometers, from 10 nanometers to 2.5 micrometers, from 10 nanometers to 1 micrometer, from 10 nanometers to 750 nanometers, from 10 nanometers to 250 nanometers, from 25 nanometers to 5 micrometers, from 50 nanometers to 5 micrometers, from 100 nanometers to 5 micrometers, from 250 nanometers to 5 micrometers, from 750 nanometers to 5 micrometers, from 25 nanometers to 4 micrometers, from 50 nanometers to 2.5 micrometers, or from 100 nanometers to 1 micrometer).

In some examples, the first metal layer and the second metal layer of each of the one or more metallized polymer current collectors independently are substantially the same. In some examples, each of the one or more metallized polymer current collectors is substantially the same.

In some examples, the methods can further comprise forming a stack having a plurality of layers comprising the one or more metallized polymer current collectors, the stack extending from a top surface to a bottom surface, such that: placing the one or more metallized polymer current collectors on the tab comprises placing the stack on the tab, inducing flow of the conductive material further causes the conductive material to flow between at least partially between each of the plurality of layers, and the joint formed by the method further joins the plurality of layers of the stack together. Forming the stack can, for example, comprise stacking and/or folding the one or more metallized polymer current collectors.

In some examples, a gap exists between at least a portion of a preceding layer and a subsequent layer within the stack (e.g., a gap exists between at least a portion of the second metal layer of the preceding layer and at least a portion of the first metal layer of the subsequent layer). For example, the gap can be due to the texturing.

In some examples, at least a portion of a preceding layer is disposed on and in physical contact with a subsequent layer within the stack (e.g., at least a portion of the second metal layer of the preceding layer is disposed on and in physical contact with at least a portion of the first metal layer of the subsequent layer).

In some examples, the one or more metallized polymer current collectors comprises a plurality of metallized polymer current collectors and forming the stack comprises stacking the plurality of metallized polymer current collectors on top of each other from a first metallized polymer current collector to a last metallized polymer current collector, such that: the second metal layer of a preceding metallized polymer current collector is disposed above and proximate to the first metal layer of a subsequent metallized polymer current collector; the first metal layer of the first metallized polymer current collector is the top surface of the stack; and the second metal layer of the last metallized polymer current collector is the bottom surface of the stack.

In some examples, at least a portion of one or more of the one or more metallized polymer current collectors further comprises a texture (e.g., such that said portion is not flat). For example, the textured portion can include one or more protrusions and/or indentations. For example, the textured portion can be corrugated, grooved, ridged, knurled, etc. In some examples, the methods can further comprise texturing at least a portion of one or more of the one or more metallized polymer current collectors. In some examples, the methods can further comprise texturing at least a portion of one or more of the one or more metallized polymer current collectors before or after forming the stack.

In some examples, one or more of the one or more metallized polymer current collectors further comprises a puncture (e.g., one or more punctures) extending through said metallized polymer current collector. In some examples, the stack further comprises a puncture (e.g., one or more punctures) extending through the stack, the top surface, and the bottom surface.

In some examples, the methods can further comprise creating said puncture(s). Creating the puncture can, for example, comprise using a punching tool, a laser, ultrasonic welding, chemical etching, or a combination thereof.

In some examples, inducing flow of the conductive material further causes the conductive material to flow at least partially through the puncture.

The joint and/or the joined material can, for example, have improved mechanical and/or electrical properties relative to a joint and/or joined material made by a different method.

In some examples, the joint can have an average mechanical pull strength of 1 Newton (N) or more (e.g., 2 N or more, 3 N or more, 4 N or more, 5 N or more, 10 N or more, 15 N or more, 20 N or more, 25 N or more, 30 N or more, 35 N or more, 40 N or more, 45 N or more, 50 N or more, 55 N or more, 60 N or more, 65 N or more, 70 N or more, 75 N or more, 80 N or more, 85 N or more, 90 N or more, or 95 N or more). In some examples, the joint can have an average mechanical pull strength of 100 N or less (e.g., 95 N or less, 90 N or less, 85 N or less, 80 N or less, 75 N or less, 70 N or less, 65 N or less, 60 N or less, 55 N or less, 50 N or less, 45 N or less, 40 N or less, 35 N or less, 30 N or less, 25 N or less, 20 N or less, 15 N or less, 10 N or less, 5 N or less, 4 N or less, 3 N or less, or 2 N or less). The average mechanical pull strength of the joint can range from any of the minimum values described above to any of the maximum values described above. For example, the joint can have an average mechanical pull strength of from 1 N to 100 N (e.g., from 1 N to 50 N, from 50 N to 100 N, from 1 N to 20 N, from 20 N to 40 N, from 40 N to 60 N, from 60 N to 80 N, from 80 N to 100 N, from 1 N to 90 N, from 1 N to 80 N, from 1 N to 70 N, from 1 N to 60 N, from 1 N to 40 N, from 1 N to 30 N, from 1 N to 10 N, from 1 N to 5 N, from 2 N to 100 N, from 3 N to 100 N, from 4 N to 100 N, from 5 N to 100 N, from 10 N to 100 N, from 20 N to 100 N, from 30 N to 100 N, from 40 N to 100 N, from 60 N to 100 N, from 70 N to 100 N, from 90 N to 100 N, from 2 N to 90 N, from 3 N to 75 N, from 4 N to 50 N, or from 5 N to 25 N).

In some examples, the joint can have an average mechanical peel strength of 0.1 Newton (N) or more (e.g., 0.2 N or more, 0.3 N or more, 0.4 N or more, 0.5 N or more, 0.75 N or more, 1 N or more, 1.25 N or more, 1.5 N or more, 1.75 N or more, 2 N or more, 2.5 N or more, 3 N or more, 3.5 N or more, 4 N or more, 4.5 N or more, 5 N or more, 6 N or more, 7 N or more, 8 N or more, 9 N or more, 10 N or more, 11 N or more, 12 N or more, 13 N or more, 14 N or more, 15 N or more, 16 N or more, 17 N or more, 18 N or more, or 19 N or more). In some examples, the joint can have an average mechanical peel strength of 20 N or less (e.g., 19 N or less, 18 N or less, 17 N or less, 16 N or less, 15 N or less, 14 N or less, 13 N or less, 12 N or less, 11 N or less, N or less, 9 N or less, 8 N or less, 7 N or less, 6 N or less, 5 N or less, 4.5 N or less, 4 N or 10 less, 3.5 N or less, 3 N or less, 2.5 N or less, 2 N or less, 1.75 N or less, 1.5 N or less, 1.25 N or less, 1 N or less, 0.75 N or less, 0.5 N or less, 0.4 N or less, 0.3 N or less, or 0.2 N or less). The average mechanical peel strength of the joint can range from any of the minimum values described above to any of the maximum values described above. For example, the joint can have an average mechanical peel strength of from 0.1 N to 20 N (e.g., 0.1 N to 10 N, from 10 N to 20 N, from 0.1 N to 5 N, from 5 N to 10 N, from 50 N to 15 N, from 15 N to 20 N, from 0.1 N to 15 N, from 0.1 N to 10 N, from 0.5 N to 20 N, from 1 N to 20 N, from 5 N to 20 N, 15 N to 20 N, from 0.5 N to 18 N, or from 1 N to 15 N).

In some examples, the joint and/or the joined material made by the methods herein supports a current of 1 milliAmpere (mA) or more for an amount of time (e.g., 2 mA or more, 3 mA or more, 4 mA or more, 5 mA or more, 10 mA or more, 15 mA or more, 20 mA or more, 25 mA or more, 30 mA or more, 35 mA or more, 40 mA or more, 45 mA or more, 50 mA or more, 60 mA or more, 70 mA or more, 80 mA or more, 90 mA or more, 100 mA or more, 125 mA or more, 150 mA or more, 175 mA or more, 200 mA or more, 225 mA or more, 250 mA or more, 300 mA or more, 350 mA or more, 400 mA or more, 450 mA or more, 500 mA or more, 600 mA or more, 700 mA or more, 800 mA or more, 900 mA or more, 1 Ampere (A, Amp) or more, 2 A or more, 3 A or more, 4 A or more, 5 A or more, 10 A or more, 15 A or more, 20 A or more, 25 A or more, 30 A or more, 35 A or more, 40 A or more, 45 A or more, 50 A or more, 60 A or more, 70 A or more, 80 A or more, or 90 A or more). In some example, the joint and/or the joined material made by the methods herein supports a current of 100 Amperes (A, Amps) or less for an amount of time (e.g., 90 A or less, 80 A or less, 70 A or less, 60 A or less, 50 A or less, 45 A or less, 40 A or less, 35 A or less, 30 A or less, 25 A or less, 20 A or less, 15 A or less, 10 A or less, 5 A or less, 4 A or less, 3 A or less, 2 A or less, 1 A or less, 900 mA or less, 800 mA or less, 700 mA or less, 600 mA or less, 500 mA or less, 450 mA or less, 400 mA or less, 350 mA or less, 300 mA or less, 250 mA or less, 225 mA or less, 200 mA or less, 175 mA or less, 150 mA or less, 125 mA or less, 100 mA or less, 90 mA or less, 80 mA or less, 70 mA or less, 60 mA or less, 50 mA or less, 45 mA or less, 40 mA or less, 35 mA or less, 30 mA or less, 25 mA or less, 20 mA or less, 15 mA or less, 10 mA or less, 5 mA or less, 4 mA or less, 3 mA or less, or 2 mA or less). The current supported by the joint and/or the joined material made by the methods herein can range from any of minimum values described above to any of the maximum values described above. For example, the joint and/or the joined material made by the methods herein supports a current of from 1 mA to 100 A (e.g., from 1 mA to 1 A, from 1 A to 100 A, from 1 mA to 500 mA, from 500 mA to 1 A, from 1 A to 50 A, from 50 A to 100 A, from 1 mA to 75 A, from 1 mA to 50 A, from 1 mA to 25 A, from 1 mA to 10 A, from 1 mA to 900 mA, from 1 mA to 750 mA, from 1 mA to 250 mA, from 1 mA to 100 mA, from 5 mA to 100 A, from 10 mA to 100 A, from 25 mA to 100 A, from 50 mA to 100 A, from 75 mA to 100 A, from 100 mA to 100 A, from 250 mA to 100 A, from 500 mA to 100 A, from 750 mA to 100 A, from 5 A to 100 A, from 10 A to 100 A, from 25 A to 100 A, from 75 A to 100 A, from 5 mA to 90 A, from 10 mA to 80 A, from 50 mA to 75 A, from 100 mA to 50 A, or from 250 mA to 25 A).

In some examples, the amount of time the joint and/or the joined material made by the methods herein supports the current can be 1 second or more (e.g., 2 seconds or more, 3 seconds or more, 4 seconds or more, 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 1 minute or more, 2 minutes or more, 3 minutes or more, 4 minutes or more, 5 minutes or more, 10 minutes or more, 15 minutes or more, 20 minutes or more, 25 minutes or more, 30 minutes or more, 35 minutes or more, 40 minutes or more, 45 minutes or more, 50 minutes or more, 55 minutes or more, 1 hour or more, 1.5 hours or more, 2 hours or more, 2.5 hours or more, 3 hours or more, 4 hours or more, 5 hours or more, 6 hours or more, 8 hours or more, 10 hours or more, 12 hours or more, 14 hours or more, 16 hours or more, 18 hours or more, 20 hours or more, 22 hours or more, 1 day or more, 1.5 days or more, 2 days or more, 2.5 days or more, 3 days or more, 4 days or more, 5 days or more, 6 days or more, 1 week or more, 1.5 weeks or more, 2 weeks or more, 2.5 weeks or more, 3 weeks or more, 3.5 weeks or more, 1 month or more, 1.5 months or more, 2 months or more, 2.5 months or more, 3 months or more, 3.5 months or more, 4 months or more, 5 months or more, 6 months or more, 7 months or more, 8 months or more, 9 months or more, 10 months or more, 11 months or more, 1 year or more, 1.5 years or more, 2 years or more, 2.5 years or more, 3 years or more, 3.5 years or more, 4 years or more, 4.5 years or more, 5 years or more, 6 years or more, 7 years or more, 8 years or more, or 9 years or more). In some examples, the amount of time the joint and/or the joined material made by the methods herein supports the current can be 10 years or less (e.g., 9 years or less, 8 years or less, 7 years or less, 6 years or less, 5 years or less, 4.5 years or less, 4 years or less, 3.5 years or less, 3 years or less, 2.5 years or less, 2 years or less, 1.5 years or less, 1 year or less, 11 months or less, 10 months or less, 9 months or less, 8 months or less, 7 months or less, 6 months or less, 5 months or less, 4 months or less, 3.5 months or less, 3 months or less, 2.5 months or less, 2 months or less, 1.5 months or less, 1 month or less, 3.5 weeks or less, 3 weeks or less, 2.5 weeks or less, 2 weeks or less, 1.5 weeks or less, 1 week or less, 6 days or less, 5 days or less, 4 days or less, 3 days or less, 2.5 days or less, 2 days or less, 1.5 days or less, 1 day or less, 22 hours or less, 20 hours or less, 18 hours or less, 16 hours or less, 14 hours or less, 12 hours or less, 10 hours or less, 8 hours or less, 6 hours or less, 5 hours or less, 4 hours or less, 3 hours or less, 2.5 hours or less, 2 hours or less, 1.5 hours or less, 1 hour or less, 55 minutes or less, 50 minutes or less, 45 minutes or less, 40 minutes or less, 35 minutes or less, 30 minutes or less, 25 minutes or less, 20 minutes or less, 15 minutes or less, 10 minutes or less, 5 minutes or less, 4 minutes or less, 3 minutes or less, 2 minutes or less, 1 minute or less, 55 seconds or less, 50 seconds or less, 45 seconds or less, 40 seconds or less, 35 seconds or less, 30 seconds or less, 25 seconds or less, 20 seconds or less, 15 seconds or less, 10 seconds or less, 5 seconds or less, 4 seconds or less, 3 seconds or less, or 2 seconds or less). The amount of time that the joint and/or the joined material made by the methods herein supports the current can range from any of the minimum values described above to any of the maximum values described above. For example, the amount of time the joint and/or the joined material made by the methods herein supports the current can be from 1 second to 10 years (e.g., from 1 second to 1 week, from 1 week to 10 years, from 1 second to 1 minute, from 1 minute to 1 hour, from 1 hour to 1 day, from 1 day to 1 week, from 1 week to 1 month, from 1 month to 1 year, from 1 year to 10 years, from 10 seconds to 10 years, from 1 hour to 10 years, from 1 day to 10 years, from 1 week to 10 years, from 1 month to 10 years, from 1 year to 10 years, from 1 second to 5 years, from 1 second to 1 year, from 1 second to 1 month, from 1 second to 1 week, from 1 second to 1 day, from 1 second to 1 hour, from 1 second to 1 minute, from 5 seconds to 5 years, or from 10 seconds to 1 year).

In some examples, the joint and/or the joined material made by the methods herein supports a current of 1 milliAmpere (mA) or more for an amount of time of 1 second or more. In some examples, the joint and/or the joined material made by the methods herein supports a current of from 1 mA to 100 A for an amount of time from 1 second to 10 years.

In some examples, the joint and/or the joined material made by the methods herein has a resistance of 1 ohms or less (e.g., 900 milliohms or less, 800 milliohms or less, 700 milliohms or less, 600 milliohms or less, 500 milliohms or less, 450 milliohms or less, 400 milliohms or less, 350 milliohms or less, 300 milliohms or less, 250 milliohms or less, 225 milliohms or less, 200 milliohms or less, 175 milliohms or less, 150 milliohms or less, 125 milliohms or less, 100 milliohms or less, 90 milliohms or less, 80 milliohms or less, 70 milliohms or less, 60 milliohms or less, 50 milliohms or less, 45 milliohms or less, 40 milliohms or less, 35 milliohms or less, 30 milliohms or less, 25 milliohms or less, 20 milliohms or less, 15 milliohms or less, 10 milliohms or less, 5 milliohms or less, 4 milliohms or less, 3 milliohms or less, or 2 milliohms or less). In some examples, the joint and/or the joined material made by the methods herein has a resistance of 1 milliohm or more (e.g., 2 milliohms or more, 3 milliohms or more, 4 milliohms or more, 5 milliohms or more, 10 milliohms or more, 15 milliohms or more, 20 milliohms or more, 25 milliohms or more, 30 milliohms or more, 35 milliohms or more, 40 milliohms or more, 45 milliohms or more, 50 milliohms or more, 60 milliohms or more, 70 milliohms or more, 80 milliohms or more, 90 milliohms or more, 100 milliohms or more, 125 milliohms or more, 150 milliohms or more, 175 milliohms or more, 200 milliohms or more, 225 milliohms or more, 250 milliohms or more, 300 milliohms or more, 350 milliohms or more, 400 milliohms or more, 450 milliohms or more, 500 milliohms or more, 600 milliohms or more, 700 milliohms or more, 800 milliohms or more, or 900 milliohms or more). The resistance of the joint and/or the joined material made by the methods herein can range from any of the minimum values described above to any of the maximum values described above. For example, the joint and/or the joined material made by the methods herein can have a resistance of from 1 milliohm to 1 ohm (e.g., from 1 milliohm to 500 milliohms, from 500 milliohms to 1 ohm, from 1 milliohms to 200 milliohms, from 200 milliohms to 400 milliohms, from 400 milliohms to 600 milliohms, from 600 milliohms to 800 milliohms, from 800 milliohms to 1 ohm, from 1 milliohms to 900 milliohms, from 1 milliohms to 800 milliohms, from 1 milliohms to 700 milliohms, from 1 milliohms to 600 milliohms, from 1 milliohms to 400 milliohms, from 1 milliohms to 300 milliohms, from 1 milliohms to 200 milliohms, from 1 milliohms to 100 milliohms, from 1 milliohms to 50 milliohms, or from 1 milliohms to 10 milliohms).

### Joined Materials

Also disclosed herein are the joints and/or the joined materials made by any of the methods disclosed herein.

Also disclosed herein are joined materials comprising one or more metallized polymer current collectors, a tab, and a conductive material; wherein the one or more metallized polymer current collectors are joined to the tab via a joint; wherein the joint comprises a conductive material; wherein at least a portion of the joint is sandwiched between the tab and the one or more metallized current collectors.

The tab can comprise any suitable material, such as those generally known in the art. For example, the tab can comprise a metal or an alloy thereof. In some examples, the tab is configured to be attached to an electrode, e.g. for a battery.

The conductive material can comprise any suitable material, such as those known in the art. In some examples, the conductive material is not the same material as the tab and/or the one or more metallized current collectors. Examples of suitable conductive materials include, but are not limited to, conductive polymers, metals, alloys, composite materials, soldering materials, conductive adhesives, etc.

In some examples, the conductive material comprises soldering material (e.g., solder). The soldering material can comprise any suitable soldering material such as those known in the art.

In some examples, the conductive material comprises an electrically conductive adhesive. The electrically conductive adhesive can comprise any suitable material, such as those known in the art. In some examples, the electrically conductive adhesive comprises an electrically conductive polymer. In some examples, the electrically conductive adhesive comprises an adhesive and a plurality of electrically conductive particles. In some examples, the plurality of electrically conductive particles can comprise any suitable material, such as, for example, a metal and/or an alloy. The adhesive can comprise any suitable adhesive.

Each of the one or more metallized polymer current collectors can, for example, comprise those known in the art, such as those made by Soteria Battery Innovation Group and/or those described in any of U.S. Pat. Nos. 10,700,339; 10,763,481; 10,854,868; 10,957,956; 11,139,510; US Published Patent Application 2021/0057706; US Published Patent Application 2021/0057712; US Published Patent Application 2021/0159507; US Published Patent Application 2021/0226308; US Published Patent Application 2022/0037738; and US Published Patent Application 2022/0045403.

In some examples, each of the one or more metallized polymer current collectors independently comprises: a polymer layer having a first surface and a second surface opposite and spaced apart from the first surface; a first metal layer disposed on the first surface of the polymer layer; and a second metal layer disposed on the second surface of the polymer layer; such that the polymer layer is sandwiched between and in physical contact with the first metal layer and the second metal layer.

The total number of metallized polymer current collectors can, for example, be 1 or more (e.g., 2 or more, 3 or more, 4 or more, 5 or more, 6 or more, 7 or more, 8 or more, 9 or more, 10 or more, 15 or more, 20 or more, 25 or more, 30 or more, 35 or more, 40 or more, 45 or more, 50 or more, 55 or more, 60 or more, 70 or more, 80 or more, 90 or more, 100 or more, 125 or more, 150 or more, 175 or more, 200 or more, 225 or more, 250 or more, 300 or more, 350 or more, 400 or more, 450 or more, 500 or more, 600 or more, 700 or more, 800 or more, or 900 or more). In some examples, the total number of metallized polymer current collectors can be 1000 or less (e.g., 900 or less, 800 or less, 700 or less, 600 or less, 500 or less, 450 or less, 400 or less, 350 or less, 300 or less, 250 or less, 225 or less, 200 or less, 175 or less, 150 or less, 125 or less, 100 or less, 90 or less, 80 or less, 70 or less, 60 or less, 55 or less, 50 or less, 45 or less, 40 or less, 35 or less, 30 or less, 25 or less, 20 or less, 15 or less, 10 or less, 9 or less, 8 or less, 7 or less, 6 or less, 5 or less, 4 or less, 3 or less, or 2 or less). The total number of metallized polymer current collectors can range from any of the minimum values described above to any of the maximum values described above. For example, the total number of metallized polymer current collectors can be from 1 to 1000 (e.g., from 1 to 500, from 500 to 1000, from 1 to 200, from 200 to 400, from 400 to 600, from 600 to 800, from 800 to 1000, from 2 to 1000, from 3 to 1000, from 5 to 1000, from 8 to 1000, from 16 to 1000, from 25 to 1000, from 32 to 1000, from 50 to 1000, from 64 to 1000, from 100 to 1000, from 120 to 1000, from 250 to 1000, from 750 to 1000, from 1 to 900, from 1 to 800, from 1 to 750, from 1 to 400, from 1 to 250, from 1 to 120, from 1 to 100, from 1 to 64, from 1 to 50, from 1 to 32, from 1 to 25, from 1 to 16, from 1 to 8, from 1 to 5, from 2 to 900, from 3 to 800, or from 5 to 500). For example, the total number of metallized polymer current collectors can be 2 or more, 3 or more, 8 or more, 16 or more, 32 or more, 64 or more, 120 or more, 250 or more, or 500 or more.

Each of the one or more metallized polymer current collectors can independently have an average thickness of, for example, 1 micrometer or more (e.g., 2 micrometers or more, 3 micrometers or more, 4 micrometers or more, 5 micrometers or more, 6 micrometers or more, 7 micrometers or more, 8 micrometers or more, 9 micrometers or more, 10 micrometers or more, 11 micrometers or more, 12 micrometers or more, 13 micrometers or more, 14 micrometers or more, 15 micrometers or more, 16 micrometers or more, 17 micrometers or more, 18 micrometers or more, 19 micrometers or more, 20 micrometers or more, 25 micrometers or more, 30 micrometers or more, 35 micrometers or more, 40 micrometers or more, or 45 micrometers or more). In some examples, each of the one or more metallized polymer current collectors can independently have an average thickness of 50 micrometers or less (e.g., 45 micrometers or less, 40 micrometers or less, 35 micrometers or less, 30 micrometers or less, 25 micrometers or less, 20 micrometers or less, 19 micrometers or less, 18 micrometers or less, 17 micrometers or less, 16 micrometers or less, 15 micrometers or less, 14 micrometers or less, 13 micrometers or less, 12 micrometers or less, 11 micrometers or less, 10 micrometers or less, 9 micrometers or less, 8 micrometers or less, 7 micrometers or less, 6 micrometers or less, 5 micrometers or less, 4 micrometers or less, 3 micrometers or less, or 2 micrometers or less). The average thickness of each of the one or more metallized polymer current collectors can independently range from any of the minimum values described above to any of the maximum values described above. For example, each of the one or more metallized polymer current collectors can independently have an average thickness of from 1 micrometer to 50 micrometers (e.g., from 1 to 25 micrometers, from 25 to 50 micrometers, from 1 to 10 micrometers, from 10 to 20 micrometers, from 20 to 30 micrometers, from 30 to 40 micrometers, from 40 to 50 micrometers, from 1 to 45 micrometers, from 1 to 40 micrometers, from 1 to 30 micrometers, from 1 to 20 micrometers, from 1 to 15 micrometers, from 1 to 5 micrometers, from 2 to 50 micrometers, from 3 to 50 micrometers, from 4 to 50 micrometers, from 5 to 50 micrometers, from 10 to 50 micrometers, from 15 to 50 micrometers, from 20 to 50 micrometers, from 30 to 50 micrometers, from 35 to 50 micrometers, from 45 to 50 micrometers, from 2 to 45 micrometers, from 5 to 45 micrometers, or from 1 to 20 micrometers).

The polymer layer of each of the one or more metallized polymer current collectors can independently comprise any suitable material. For example, the polymer layer of each of the one or more metallized polymer current collectors can independently comprises polypropylene, polyethylene, polyethylene terephthalate (PET), polyethylene napthalate (PEN), polyvinyl alcohol (PVA), polyaramid (e.g., Kevlar, Nomex), polyamides (e.g., nylon), polyimide (e.g., Kapton), cellulose, derivatives thereof, or combinations thereof.

In some examples, the polymer layer of each of the one or more metallized polymer current collectors can independently have an average thickness of 1 micrometer or more (e.g., 2 micrometers or more, 3 micrometers or more, 4 micrometers or more, 5 micrometers or more, 6 micrometers or more, 7 micrometers or more, 8 micrometers or more, 9 micrometers or more, 10 micrometers or more, 11 micrometers or more, 12 micrometers or more, 13 micrometers or more, 14 micrometers or more, 15 micrometers or more, 16 micrometers or more, 17 micrometers or more, 18 micrometers or more, 19 micrometers or more, 20 micrometers or more, 25 micrometers or more, 30 micrometers or more, 35 micrometers or more, 40 micrometers or more, or 45 micrometers or more). In some examples, each of the one or more metallized polymer current collectors can independently have an average thickness of 50 micrometers or less (e.g., 45 micrometers or less, 40 micrometers or less, 35 micrometers or less, 30 micrometers or less, 25 micrometers or less, 20 micrometers or less, 19 micrometers or less, 18 micrometers or less, 17 micrometers or less, 16 micrometers or less, 15 micrometers or less, 14 micrometers or less, 13 micrometers or less, 12 micrometers or less, 11 micrometers or less, 10 micrometers or less, 9 micrometers or less, 8 micrometers or less, 7 micrometers or less, 6 micrometers or less, 5 micrometers or less, 4 micrometers or less, 3 micrometers or less, or 2 micrometers or less). The average thickness of each of the one or more metallized polymer current collectors can independently range from any of the minimum values described above to any of the maximum values described above. For example, each of the one or more metallized polymer current collectors can independently have an average thickness of from 1 micrometer to 50 micrometers (e.g., from 1 to 25 micrometers, from 25 to 50 micrometers, from 1 to 10 micrometers, from 10 to 20 micrometers, from 20 to 30 micrometers, from 30 to 40 micrometers, from 40 to 50 micrometers, from 1 to 45 micrometers, from 1 to 40 micrometers, from 1 to 30 micrometers, from 1 to 20 micrometers, from 1 to 15 micrometers, from 1 to 5 micrometers, from 2 to 50 micrometers, from 3 to 50 micrometers, from 4 to 50 micrometers, from 5 to 50 micrometers, from 10 to 50 micrometers, from 15 to 50 micrometers, from 20 to 50 micrometers, from 30 to 50 micrometers, from 35 to 50 micrometers, from 45 to 50 micrometers, from 2 to 45 micrometers, from 5 to 45 micrometers, or from 1 to 20 micrometers).

The first metal layer of each of the one or more metallized polymer current collectors can independently comprise any suitable material. For example, the first metal layer of each of the one or more metallized polymer current collectors can independently comprise a metal (e.g., one or more pure metals, alloy(s), or a combination thereof). For example, the first metal layer of each of the one or more metallized polymer current collectors can independently comprise a metal selected from the group consisting of Li, Be, B, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Tc, Ru, Rh, Pd, Ag, Cd, In, Sn, Sb, Te, Cs, Ba, Hf, Ta, W, Re, Os, Ir, Pt, Au, Hg, TI, Pb, Bi, La, Ce, Pr, Nd, Pm, Sm, Eu, Gd, Tb, Dy, Ho, Er, Tm, Yb, and combinations thereof. In some examples, the first metal layer of each of the one or more metallized polymer current collectors can independently comprise Al, Cu, Zn, Sn, Si, Pb, Ti, Li, or a combination thereof.

In some examples, the first metal layer of each of the one or more metallized polymer current collectors independently has an average thickness of 10 nanometers or more (e.g., 15 nanometers or more, 20 nanometers or more, 25 nanometers or more, 30 nanometers or more, 35 nanometers or more, 40 nanometers or more, 45 nanometers or more, 50 nanometers or more, 60 nanometers or more, 70 nanometers or more, 80 nanometers or more, 90 nanometers or more, 100 nanometers or more, 125 nanometers or more, 150 nanometers or more, 175 nanometers or more, 200 nanometers or more, 225 nanometers or more, 250 nanometers or more, 300 nanometers or more, 350 nanometers or more, 400 nanometers or more, 450 nanometers or more, 500 nanometers or more, 600 nanometers or more, 700 nanometers or more, 800 nanometers or more, 900 nanometers or more, 1 micrometer or more, 1.25 micrometers or more, 1.5 micrometers or more, 1.75 micrometers or more, 2 micrometers or more, 2.25 micrometers or more, 2.5 micrometers or more, 3 micrometers or more, 3.5 micrometers or more, 4 micrometers or more, or 4.5 micrometers or more). In some examples, the first metal layer of each of the one or more metallized polymer current collectors independently has an average thickness of 5 micrometers or less (e.g., 4.5 micrometers or less, 4 micrometers or less, 3.5 micrometers or less, 3 micrometers or less, 2.5 micrometers or less, 2.25 micrometers or less, 2 micrometers or less, 1.75 micrometers or less, 1.5 micrometers or less, 1.25 micrometers or less, 1 micrometer or less, 900 nanometers or less, 800 nanometers or less, 700 nanometers or less, 600 nanometers or less, 500 nanometers or less, 450 nanometers or less, 400 nanometers or less, 350 nanometers or less, 300 nanometers or less, 250 nanometers or less, 225 nanometers or less, 200 nanometers or less, 175 nanometers or less, 150 nanometers or less, 125 nanometers or less, 100 nanometers or less, 90 nanometers or less, 80 nanometers or less, 70 nanometers or less, 60 nanometers or less, 50 nanometers or less, 45 nanometers or less, 40 nanometers or less, 35 nanometers or less, 30 nanometers or less, 25 nanometers or less, 20 nanometers or less, or 15 nanometers or less). The average thickness of the first metal layer of each of the one or more metallized polymer current collectors can independently range from any of the minimum values described above to any of the maximum values described above. For example, the first metal layer of each of the one or more metallized polymer current collectors independently can have an average thickness of from 10 nanometers to 5 micrometers (e.g., from 10 nm to 500 nanometers, from 500 nanometers to 5 micrometers, from 10 nanometers to 100 nanometers, from 100 nanometers to 1 micrometer, from 1 micrometer to 5 micrometers, from 10 nanometers to 2.5 micrometers, from 10 nanometers to 1 micrometer, from 10 nanometers to 750 nanometers, from 10 nanometers to 250 nanometers, from 25 nanometers to 5 micrometers, from 50 nanometers to 5 micrometers, from 100 nanometers to 5 micrometers, from 250 nanometers to 5 micrometers, from 750 nanometers to 5 micrometers, from 25 nanometers to 4 micrometers, from 50 nanometers to 2.5 micrometers, or from 100 nanometers to 1 micrometer).

The second metal layer of each of the one or more metallized polymer current collectors can independently comprise any suitable material. For example, the second metal layer of each of the one or more metallized polymer current collectors can independently comprise a metal (e.g., one or more pure metals, alloy(s), or a combination thereof). For example, the second metal layer of each of the one or more metallized polymer current collectors can independently comprise a metal selected from the group consisting of Li, Be, B, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Tc, Ru, Rh, Pd, Ag, Cd, In, Sn, Sb, Te, Cs, Ba, Hf, Ta, W, Re, Os, Ir, Pt, Au, Hg, TI, Pb, Bi, La, Ce, Pr, Nd, Pm, Sm, Eu, Gd, Tb, Dy, Ho, Er, Tm, Yb, and combinations thereof. In some examples, the second metal layer of each of the one or more metallized polymer current collectors can independently comprise Al, Cu, Zn, Sn, Si, Pb, Ti, Li, or a combination thereof.

In some examples, the second metal layer of each of the one or more metallized polymer current collectors independently has an average thickness of 10 nanometers or more (e.g., 15 nanometers or more, 20 nanometers or more, 25 nanometers or more, 30 nanometers or more, 35 nanometers or more, 40 nanometers or more, 45 nanometers or more, 50 nanometers or more, 60 nanometers or more, 70 nanometers or more, 80 nanometers or more, 90 nanometers or more, 100 nanometers or more, 125 nanometers or more, 150 nanometers or more, 175 nanometers or more, 200 nanometers or more, 225 nanometers or more, 250 nanometers or more, 300 nanometers or more, 350 nanometers or more, 400 nanometers or more, 450 nanometers or more, 500 nanometers or more, 600 nanometers or more, 700 nanometers or more, 800 nanometers or more, 900 nanometers or more, 1 micrometer or more, 1.25 micrometers or more, 1.5 micrometers or more, 1.75 micrometers or more, 2 micrometers or more, 2.25 micrometers or more, 2.5 micrometers or more, 3 micrometers or more, 3.5 micrometers or more, 4 micrometers or more, or 4.5 micrometers or more). In some examples, the second metal layer of each of the one or more metallized polymer current collectors independently has an average thickness of 5 micrometers or less (e.g., 4.5 micrometers or less, 4 micrometers or less, 3.5 micrometers or less, 3 micrometers or less, 2.5 micrometers or less, 2.25 micrometers or less, 2 micrometers or less, 1.75 micrometers or less, 1.5 micrometers or less, 1.25 micrometers or less, 1 micrometer or less, 900 nanometers or less, 800 nanometers or less, 700 nanometers or less, 600 nanometers or less, 500 nanometers or less, 450 nanometers or less, 400 nanometers or less, 350 nanometers or less, 300 nanometers or less, 250 nanometers or less, 225 nanometers or less, 200 nanometers or less, 175 nanometers or less, 150 nanometers or less, 125 nanometers or less, 100 nanometers or less, 90 nanometers or less, 80 nanometers or less, 70 nanometers or less, 60 nanometers or less, 50 nanometers or less, 45 nanometers or less, 40 nanometers or less, 35 nanometers or less, 30 nanometers or less, 25 nanometers or less, 20 nanometers or less, or 15 nanometers or less). The average thickness of the second metal layer of each of the one or more metallized polymer current collectors can independently range from any of the minimum values described above to any of the maximum values described above. For example, the second metal layer of each of the one or more metallized polymer current collectors independently can have an average thickness of from 10 nanometers to 5 micrometers (e.g., from 10 nm to 500 nanometers, from 500 nanometers to 5 micrometers, from 10 nanometers to 100 nanometers, from 100 nanometers to 1 micrometer, from 1 micrometer to 5 micrometers, from 10 nanometers to 2.5 micrometers, from 10 nanometers to 1 micrometer, from 10 nanometers to 750 nanometers, from 10 nanometers to 250 nanometers, from 25 nanometers to 5 micrometers, from 50 nanometers to 5 micrometers, from 100 nanometers to 5 micrometers, from 250 nanometers to 5 micrometers, from 750 nanometers to 5 micrometers, from 25 nanometers to 4 micrometers, from 50 nanometers to 2.5 micrometers, or from 100 nanometers to 1 micrometer).

In some examples, the first metal layer and the second metal layer of each of the one or more metallized polymer current collectors independently are substantially the same. In some examples, each of the one or more metallized polymer current collectors is substantially the same.

In some examples, the one or more metallized polymer current collectors comprise a stack having a plurality of layers, the stack extending from a top surface to a bottom surface, and wherein the conductive material is further disposed between at least a portion of each of the plurality of layers such that the plurality of layers are joined together.

In some examples, a gap exists between at least a portion of a preceding layer and a subsequent layer within the stack (e.g., a gap exists between at least a portion of the second metal layer of the preceding layer and at least a portion of the first metal layer of the subsequent layer). For example, the gap can be due to the texturing.

In some examples, at least a portion of a preceding layer is disposed on and in physical contact with a subsequent layer within the stack (e.g., at least a portion of the second metal layer of the preceding layer is disposed on and in physical contact with at least a portion of the first metal layer of the subsequent layer).

In some examples, the one or more metallized polymer current collectors comprises a plurality of metallized polymer current collectors and the stack comprises the plurality of metallized polymer current collectors on top of each other from a first metallized polymer current collector to a last metallized polymer current collector, such that: the second metal layer of a preceding metallized polymer current collector is disposed above and proximate to the first metal layer of a subsequent metallized polymer current collector; the first metal layer of the first metallized polymer current collector is the top surface of the stack; and the second metal layer of the last metallized polymer current collector is the bottom surface of the stack.

In some examples, at least a portion of one or more of the one or more metallized polymer current collectors further comprises a texture (e.g., such that said portion is not flat). For example, the textured portion can include one or more protrusions and/or indentations. For example, the textured portion can be corrugated, grooved, ridged, knurled, etc.

In some examples, one or more of the one or more metallized polymer current collectors further comprises a puncture (e.g., one or more punctures) extending through said metallized polymer current collector. In some examples, the stack further comprises a puncture (e.g., one or more punctures) extending through the stack, the top surface, and the bottom surface.

In some examples, the puncture is at least partially filled with the conductive material.

The joint and/or the joined material can, for example, have improved mechanical and/or electrical properties.

In some examples, the joint can have an average mechanical pull strength of 1 Newton (N) or more (e.g., 2 N or more, 3 N or more, 4 N or more, 5 N or more, 10 N or more, 15 N or more, 20 N or more, 25 N or more, 30 N or more, 35 N or more, 40 N or more, 45 N or more, 50 N or more, 55 N or more, 60 N or more, 65 N or more, 70 N or more, 75 N or more, 80 N or more, 85 N or more, 90 N or more, or 95 N or more). In some examples, the joint can have an average mechanical pull strength of 100 N or less (e.g., 95 N or less, 90 N or less, 85 N or less, 80 N or less, 75 N or less, 70 N or less, 65 N or less, 60 N or less, 55 N or less, 50 N or less, 45 N or less, 40 N or less, 35 N or less, 30 N or less, 25 N or less, 20 N or less, 15 N or less, 10 N or less, 5 N or less, 4 N or less, 3 N or less, or 2 N or less). The average mechanical pull strength of the joint can range from any of the minimum values described above to any of the maximum values described above. For example, the joint can have an average mechanical pull strength of from 1 N to 100 N (e.g., from 1 N to 50 N, from 50 N to 100 N, from 1 N to 20 N, from 20 N to 40 N, from 40 N to 60 N, from 60 N to 80 N, from 80 N to 100 N, from 1 N to 90 N, from 1 N to 80 N, from 1 N to 70 N, from 1 N to 60 N, from 1 N to 40 N, from 1 N to 30 N, from 1 N to 10 N, from 1 N to 5 N, from 2 N to 100 N, from 3 N to 100 N, from 4 N to 100 N, from 5 N to 100 N, from 10 N to 100 N, from 20 N to 100 N, from 30 N to 100 N, from 40 N to 100 N, from 60 N to 100 N, from 70 N to 100 N, from 90 N to 100 N, from 2 N to 90 N, from 3 N to 75 N, from 4 N to 50 N, or from 5 N to 25 N).

In some examples, the joint can have an average mechanical peel strength of 0.1 Newton (N) or more (e.g., 0.2 N or more, 0.3 N or more, 0.4 N or more, 0.5 N or more, 0.75 N or more, 1 N or more, 1.25 N or more, 1.5 N or more, 1.75 N or more, 2 N or more, 2.5 N or more, 3 N or more, 3.5 N or more, 4 N or more, 4.5 N or more, 5 N or more, 6 N or more, 7 N or more, 8 N or more, 9 N or more, 10 N or more, 11 N or more, 12 N or more, 13 N or more, 14 N or more, 15 N or more, 16 N or more, 17 N or more, 18 N or more, or 19 N or more). In some examples, the joint can have an average mechanical peel strength of 20 N or less (e.g., 19 N or less, 18 N or less, 17 N or less, 16 N or less, 15 N or less, 14 N or less, 13 N or less, 12 N or less, 11 N or less, 10 N or less, 9 N or less, 8 N or less, 7 N or less, 6 N or less, 5 N or less, 4.5 N or less, 4 N or less, 3.5 N or less, 3 N or less, 2.5 N or less, 2 N or less, 1.75 N or less, 1.5 N or less, 1.25 N or less, 1 N or less, 0.75 N or less, 0.5 N or less, 0.4 N or less, 0.3 N or less, or 0.2 N or less). The average mechanical peel strength of the joint can range from any of the minimum values described above to any of the maximum values described above. For example, the joint can have an average mechanical peel strength of from 0.1 N to 20 N (e.g., 0.1 N to 10 N, from 10 N to 20 N, from 0.1 N to 5 N, from 5 N to 10 N, from 50 N to 15 N, from 15 N to 20 N, from 0.1 N to 15 N, from 0.1 N to 10 N, from 0.5 N to 20 N, from 1 N to 20 N, from 5 N to 20 N, 15 N to 20 N, from 0.5 N to 18 N, or from 1 N to 15 N). In some examples, the joint and/or the joined material supports a current of 1 milliAmpere (mA) or more for an amount of time (e.g., 2 mA or more, 3 mA or more, 4 mA or more, 5 mA or more, 10 mA or more, 15 mA or more, 20 mA or more, 25 mA or more, 30 mA or more, 35 mA or more, 40 mA or more, 45 mA or more, 50 mA or more, 60 mA or more, 70 mA or more, 80 mA or more, 90 mA or more, 100 mA or more, 125 mA or more, 150 mA or more, 175 mA or more, 200 mA or more, 225 mA or more, 250 mA or more, 300 mA or more, 350 mA or more, 400 mA or more, 450 mA or more, 500 mA or more, 600 mA or more, 700 mA or more, 800 mA or more, 900 mA or more, 1 Ampere (A, Amp) or more, 2 A or more, 3 A or more, 4 A or more, 5 A or more, 10 A or more, 15 A or more, 20 A or more, 25 A or more, 30 A or more, 35 A or more, 40 A or more, 45 A or more, 50 A or more, 60 A or more, 70 A or more, 80 A or more, or 90 A or more). In some example, the joint and/or the joined material supports a current of 100 Amperes (A, Amps) or less for an amount of time (e.g., 90 A or less, 80 A or less, 70 A or less, 60 A or less, 50 A or less, 45 A or less, 40 A or less, 35 A or less, 30 A or less, 25 A or less, 20 A or less, 15 A or less, 10 A or less, 5 A or less, 4 A or less, 3 A or less, 2 A or less, 1 A or less, 900 mA or less, 800 mA or less, 700 mA or less, 600 mA or less, 500 mA or less, 450 mA or less, 400 mA or less, 350 mA or less, 300 mA or less, 250 mA or less, 225 mA or less, 200 mA or less, 175 mA or less, 150 mA or less, 125 mA or less, 100 mA or less, 90 mA or less, 80 mA or less, 70 mA or less, 60 mA or less, 50 mA or less, 45 mA or less, 40 mA or less, 35 mA or less, 30 mA or less, 25 mA or less, 20 mA or less, 15 mA or less, 10 mA or less, 5 mA or less, 4 mA or less, 3 mA or less, or 2 mA or less). The current supported by the joint and/or the joined material can range from any of minimum values described above to any of the maximum values described above. For example, the joint and/or the joined material supports a current of from 1 mA to 100 A (e.g., from 1 mA to 1 A, from 1 A to 100 A, from 1 mA to 500 mA, from 500 mA to 1 A, from 1 A to 50 A, from 50 A to 100 A, from 1 mA to 75 A, from 1 mA to 50 A, from 1 mA to 25 A, from 1 mA to 10 A, from 1 mA to 900 mA, from 1 mA to 750 mA, from 1 mA to 250 mA, from 1 mA to 100 mA, from 5 mA to 100 A, from 10 mA to 100 A, from 25 mA to 100 A, from 50 mA to 100 A, from 75 mA to 100 A, from 100 mA to 100 A, from 250 mA to 100 A, from 500 mA to 100 A, from 750 mA to 100 A, from 5 A to 100 A, from 10 A to 100 A, from 25 A to 100 A, from 75 A to 100 A, from 5 mA to 90 A, from 10 mA to 80 A, from 50 mA to 75 A, from 100 mA to 50 A, or from 250 mA to 25 A).

In some examples, the amount of time the joint and/or the joined material supports the current can be 1 second or more (e.g., 2 seconds or more, 3 seconds or more, 4 seconds or more, 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 1 minute or more, 2 minutes or more, 3 minutes or more, 4 minutes or more, 5 minutes or more, 10 minutes or more, 15 minutes or more, 20 minutes or more, 25 minutes or more, 30 minutes or more, 35 minutes or more, 40 minutes or more, 45 minutes or more, 50 minutes or more, 55 minutes or more, 1 hour or more, 1.5 hours or more, 2 hours or more, 2.5 hours or more, 3 hours or more, 4 hours or more, 5 hours or more, 6 hours or more, 8 hours or more, 10 hours or more, 12 hours or more, 14 hours or more, 16 hours or more, 18 hours or more, 20 hours or more, 22 hours or more, 1 day or more, 1.5 days or more, 2 days or more, 2.5 days or more, 3 days or more, 4 days or more, 5 days or more, 6 days or more, 1 week or more, 1.5 weeks or more, 2 weeks or more, 2.5 weeks or more, 3 weeks or more, 3.5 weeks or more, 1 month or more, 1.5 months or more, 2 months or more, 2.5 months or more, 3 months or more, 3.5 months or more, 4 months or more, 5 months or more, 6 months or more, 7 months or more, 8 months or more, 9 months or more, 10 months or more, 11 months or more, 1 year or more, 1.5 years or more, 2 years or more, 2.5 years or more, 3 years or more, 3.5 years or more, 4 years or more, 4.5 years or more, 5 years or more, 6 years or more, 7 years or more, 8 years or more, or 9 years or more). In some examples, the amount of time the joint and/or the joined material supports the current can be 10 years or less (e.g., 9 years or less, 8 years or less, 7 years or less, 6 years or less, 5 years or less, 4.5 years or less, 4 years or less, 3.5 years or less, 3 years or less, 2.5 years or less, 2 years or less, 1.5 years or less, 1 year or less, 11 months or less, 10 months or less, 9 months or less, 8 months or less, 7 months or less, 6 months or less, 5 months or less, 4 months or less, 3.5 months or less, 3 months or less, 2.5 months or less, 2 months or less, 1.5 months or less, 1 month or less, 3.5 weeks or less, 3 weeks or less, 2.5 weeks or less, 2 weeks or less, 1.5 weeks or less, 1 week or less, 6 days or less, 5 days or less, 4 days or less, 3 days or less, 2.5 days or less, 2 days or less, 1.5 days or less, 1 day or less, 22 hours or less, 20 hours or less, 18 hours or less, 16 hours or less, 14 hours or less, 12 hours or less, 10 hours or less, 8 hours or less, 6 hours or less, 5 hours or less, 4 hours or less, 3 hours or less, 2.5 hours or less, 2 hours or less, 1.5 hours or less, 1 hour or less, 55 minutes or less, 50 minutes or less, 45 minutes or less, 40 minutes or less, 35 minutes or less, 30 minutes or less, 25 minutes or less, 20 minutes or less, 15 minutes or less, 10 minutes or less, 5 minutes or less, 4 minutes or less, 3 minutes or less, 2 minutes or less, 1 minute or less, 55 seconds or less, 50 seconds or less, 45 seconds or less, 40 seconds or less, 35 seconds or less, 30 seconds or less, 25 seconds or less, 20 seconds or less, 15 seconds or less, 10 seconds or less, 5 seconds or less, 4 seconds or less, 3 seconds or less, or 2 seconds or less). The amount of time that the joint and/or the joined material supports the current can range from any of the minimum values described above to any of the maximum values described above. For example, the amount of time the joint and/or the joined material supports the current can be from 1 second to 10 years (e.g., from 1 second to 1 week, from 1 week to 10 years, from 1 second to 1 minute, from 1 minute to 1 hour, from 1 hour to 1 day, from 1 day to 1 week, from 1 week to 1 month, from 1 month to 1 year, from 1 year to 10 years, from 10 seconds to 10 years, from 1 hour to 10 years, from 1 day to 10 years, from 1 week to 10 years, from 1 month to 10 years, from 1 year to 10 years, from 1 second to 5 years, from 1 second to 1 year, from 1 second to 1 month, from 1 second to 1 week, from 1 second to 1 day, from 1 second to 1 hour, from 1 second to 1 minute, from 5 seconds to 5 years, or from 10 seconds to 1 year).

In some examples, the joint and/or the joined material supports a current of 1 milliAmpere (mA) or more for an amount of time of 1 second or more. In some examples, the joint and/or the joined material supports a current of from 1 mA to 100 A for an amount of time from 1 second to 10 years.

In some examples, the joint and/or the joined material has a resistance of 1 ohms or less (e.g., 900 milliohms or less, 800 milliohms or less, 700 milliohms or less, 600 milliohms or less, 500 milliohms or less, 450 milliohms or less, 400 milliohms or less, 350 milliohms or less, 300 milliohms or less, 250 milliohms or less, 225 milliohms or less, 200 milliohms or less, 175 milliohms or less, 150 milliohms or less, 125 milliohms or less, 100 milliohms or less, 90 milliohms or less, 80 milliohms or less, 70 milliohms or less, 60 milliohms or less, 50 milliohms or less, 45 milliohms or less, 40 milliohms or less, 35 milliohms or less, 30 milliohms or less, 25 milliohms or less, 20 milliohms or less, 15 milliohms or less, 10 milliohms or less, 5 milliohms or less, 4 milliohms or less, 3 milliohms or less, or 2 milliohms or less). In some examples, the joint and/or the joined material has a resistance of 1 milliohm or more (e.g., 2 milliohms or more, 3 milliohms or more, 4 milliohms or more, 5 milliohms or more, 10 milliohms or more, 15 milliohms or more, 20 milliohms or more, 25 milliohms or more, 30 milliohms or more, 35 milliohms or more, 40 milliohms or more, 45 milliohms or more, 50 milliohms or more, 60 milliohms or more, 70 milliohms or more, 80 milliohms or more, 90 milliohms or more, 100 milliohms or more, 125 milliohms or more, 150 milliohms or more, 175 milliohms or more, 200 milliohms or more, 225 milliohms or more, 250 milliohms or more, 300 milliohms or more, 350 milliohms or more, 400 milliohms or more, 450 milliohms or more, 500 milliohms or more, 600 milliohms or more, 700 milliohms or more, 800 milliohms or more, or 900 milliohms or more). The resistance of the joint and/or the joined material can range from any of the minimum values described above to any of the maximum values described above. For example, the joint and/or the joined material can have a resistance of from 1 milliohm to 1 ohm (e.g., from 1 milliohm to 500 milliohms, from 500 milliohms to 1 ohm, from 1 milliohms to 200 milliohms, from 200 milliohms to 400 milliohms, from 400 milliohms to 600 milliohms, from 600 milliohms to 800 milliohms, from 800 milliohms to 1 ohm, from 1 milliohms to 900 milliohms, from 1 milliohms to 800 milliohms, from 1 milliohms to 700 milliohms, from 1 milliohms to 600 milliohms, from 1 milliohms to 400 milliohms, from 1 milliohms to 300 milliohms, from 1 milliohms to 200 milliohms, from 1 milliohms to 100 milliohms, from 1 milliohms to 50 milliohms, or from 1 milliohms to 10 milliohms).

Also disclosed herein are methods of making any of the joined materials herein. The joined materials can be made by any suitable method, such as any of the methods disclosed herein.

### Devices

Also disclosed herein are devices comprising the joint and/or joined material made by any of the methods disclosed herein. Also disclosed herein are devices comprising any of the joined materials disclosed herein.

In some examples, the device can comprise an energy storage device, an electronic device, or a combination thereof. In some examples, the device comprises a battery, such as a lithium ion battery. In some examples, the device comprises a capacitor or a supercapacitor.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Comparative Example

Background/Introduction. Since their commercial introduction in 1991, Li-ion battery (LIB) sales have grown 15% a year, due to cost reductions and significant technical improvements (K. W. Beard and T. B. Reddy, “Linden's Handbook of Batteries: Fifth Edition.” McGraw-Hill Education, 2019). As of 2017, Li-ion batteries power all personal-portable electronic devices and represent 60% of the battery market share (K. W. Beard and T. B. Reddy, “Linden's Handbook of Batteries: Fifth Edition.” McGraw-Hill Education, 2019). Additionally, Li-ion battery use will continue to see rapid growth in the electric vehicle (EV) market, as automakers and governments shift away from fossil fuels and internal combustion engines (ICE). In addition, as countries all over the world shift to a renewable energy-based power grid, short term and long-term energy storage is necessary for providing power when use outpaces generation. Li-ion battery storage is one possible option for grid energy storage (K. W. Beard and T. B. Reddy, “Linden's Handbook of Batteries: Fifth Edition.” McGraw-Hill Education, 2019).

Li-ion batteries have dominated the battery market due to their numerous advantages over other battery cells/chemistries. Li-ion batteries have a high specific energy (275 Wh/kg), energy density (730 Wh/L), and specific power (600-3000 W/kg) (K. W. Beard and T. B. Reddy, “Linden's Handbook of Batteries: Fifth Edition.” McGraw-Hill Education, 2019). A typical lead acid battery, in comparison, has a specific energy and energy density of 30-50 Wh/Kg and 70 Wh/L, respectively (K. W. Beard and T. B. Reddy, “Linden's Handbook of Batteries: Fifth Edition.” McGraw-Hill Education, 2019). Additionally, the Li-ion battery has advantages such as: long cycle life, large operation temperature range, long shelf life, low self-discharge rate, rapid charge capability, high power discharge, no memory effect, and design flexibility (cylindrical, prismatic cells) (K. W. Beard and T. B. Reddy, “Linden's Handbook of Batteries: Fifth Edition.” McGraw-Hill Education, 2019).

Conversely, disadvantages of Li-ion batteries include moderate initial cost, difficulty in sourcing active materials (Li, Co), degradation at high temperatures, capacity loss over time, and potential for thermal runaway events and battery fires (K. W. Beard and T. B. Reddy, “Linden's Handbook of Batteries: Fifth Edition.” McGraw-Hill Education, 2019).

Lithium-ion battery fires have made headlines and received scrutiny after fires in products such as EV's, smartphones, and E-cigarettes. After system battery fires within The Boeing 787 Dreamliner, the Dreamliner fleet was grounded temporarily, costing Boeing an estimated $600 Million, underscoring the high cost of recalls and fixing battery systems. While EV manufacturers such as Tesla will note that battery fires are rarer than ICE fires, battery fires are dangerous and difficult to put out. In fact, Tesla's own guidance is to allow an EV battery fire to burn itself out, which can take up to 24 hours.

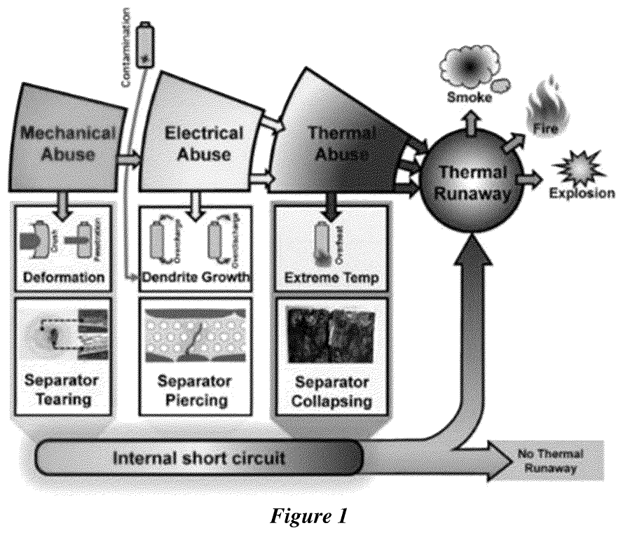

Thermal runaway in lithium-ion batteries, which can lead to fires and violent explosions, can have many different causes and characteristics (X. Feng et Al., “Energy Storage Materials, Vol. 10, pg. 246-267, 2018). The most common feature of thermal runaway is an internal short circuit (ISC), although others exist (external short circuit, external thermal abuse). The burst of energy resulting from an internal short circuit can initiate the Heat-Temperature-Reaction (HTR) loop, a chain reaction which contains individual exothermic reactions. Abuse conditions leading to an internal short circuit are shown in FIG. 1. There are four different modes of internal short circuits (M. Brand et al. Journal of Energy Storage, Vol. 12, pg. 45-54, 2017). The anode-cathode internal short circuit mode is the most probable, where separator failure occurs allowing an internal short circuit between anode and cathode (B. Liu et al., Energy Storage Materials, Vol. 25, pg. 85-112, 2020). There are three abuse conditions (mechanical, electrical, and thermal) that can cause separator failure and internal short circuit in a variety of ways such as crushing/penetration (mechanical), dendrite piercing (electrical), and shrinkage/collapse (thermal) (X. Feng et Al., “Energy Storage Materials, Vol. 10, pg. 246-267, 2018).

Batteries are constructed with one or more disconnect devices to prevent thermal runaway, such as a positive temperature coefficient device (PTC), current interrupt device (CID), and safety vents (K. W. Beard and T. B. Reddy, “Linden's Handbook of Batteries: Fifth Edition.” McGraw-Hill Education, 2019). In addition to disconnect devices, other intrinsic battery safety measures include the development and modification of materials (X. Feng et Al., “Energy Storage Materials, Vol. 10, pg. 246-267, 2018). The anode, cathode, electrolyte, separator, and current collectors (CC) can all be modified for increased thermal runaway resistance (X. Feng et Al., “Energy Storage Materials, Vol. 10, pg. 246-267, 2018).

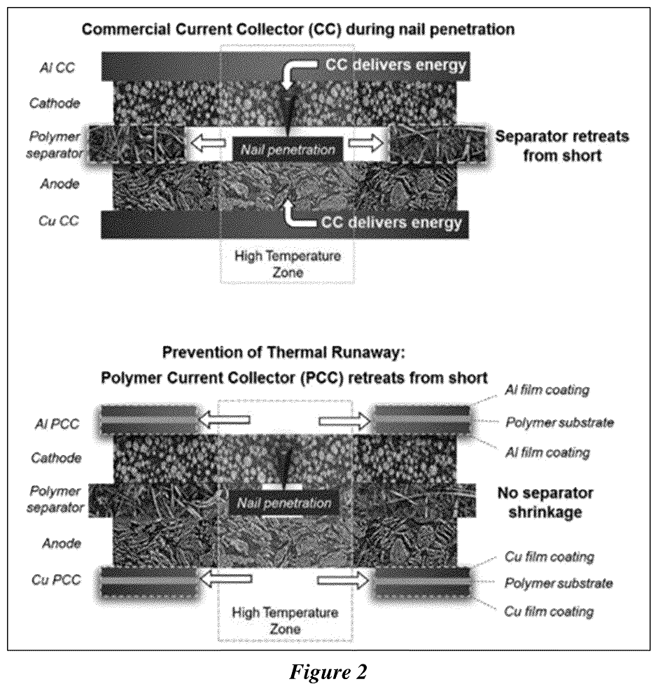

One innovative intrinsic measure to prevent thermal runaway and electrically isolate internal short circuits is by using metallized polymer current collectors (MPCC). When an internal short circuit occurs, the burst of energy at the short circuit location will instantaneously burn away the metallized polymer current collector and withdraw from the short circuit location, as shown in FIG. 2. Once the internal short circuit is electrically isolated, the risk of thermal runaway is negated, and the battery can even continue to function. This technology is similar to “self-healing” in metallized film capacitors, in which the metallized film electrodes are vaporized when a local discharge occurs, allowing the capacitor to continue to function, albeit at a lower capacitance (H. Li et al., Microelectronics Reliability, Vol. 55, pg. 945-951, 2015).

Pham et al. explored the effectiveness of metallized polymer current collectors in preventing thermal runaway in 18650 cylindrical Li-ion cells penetrated with a nail (M. Pham et al., Cell Reports Physical Science, Vol. 2, Issue 3, 2021, 100360). Pham et al. utilized aluminum and copper metallized polymer current collectors with a total thickness of 8 microns, and a metal thickness of 1 micron (0.5 micron on each side) (M. Pham et al., Cell Reports Physical Science, Vol. 2, Issue 3, 2021, 100360). The fabricated cells were divided into four groups with different combinations of aluminum and copper metallized polymer current collectors and traditional aluminum and copper current collectors. Each group was tested multiple times with the nail penetration test. Cells with the aluminum metallized polymer current collectors (groups 1,3) did not undergo thermal runaway in six out of six trials, and even maintained approximately 3.6 volts after 8 months (M. Pham et al., Cell Reports Physical Science, Vol. 2, Issue 3, 2021, 100360). Cells with the traditional aluminum and copper foil current collectors consistently experienced thermal runaway (M. Pham et al., Cell Reports Physical Science, Vol. 2, Issue 3, 2021, 100360). The cells with the copper metallized polymer current collectors and the aluminum foil current collectors (group 2) also experienced thermal runaway during nail penetration (M. Pham et al., Cell Reports Physical Science, Vol. 2, Issue 3, 2021, 100360). Group 2 experienced thermal runaway during nail penetration because the nail bridges the electrically negative can and the graphite anode layers, effectively bypassing any protection the copper metallized polymer current collector could offer (M. Pham et al., Cell Reports Physical Science, Vol. 2, Issue 3, 2021, 100360). Further testing is necessary in battery formats where the cell casing is electrically isolated from the battery.

In addition to acting as a safety mechanism against thermal runaway in batteries, metallized polymer current collectors have additional benefits such as reduced mass and manufacturing cost (M. Pham et al., Cell Reports Physical Science, Vol. 2, Issue 3, 2021, 100360). The reduced mass of the metallized polymer current collectors translates to a higher gravimetric energy density of cells (M. Pham et al., Cell Reports Physical Science, Vol. 2, Issue 3, 2021, 100360). In battery cells with traditional current collectors, the current collectors account for 15-50% of the total cell weight (B. Liu et al., Energy Storage Materials, Vol. 25, pg. 85-112, 2020). Current collectors account for such a high weight percentage of battery cells because traditional metal foil current collectors are manufactured to relatively large thickness to avoid material tearing during manufacturing (M. Pham et al., Cell Reports Physical Science, Vol. 2, Issue 3, 2021, 100360). The metallized polymer current collector cells fabricated by Pham et al. had an average mass of 2.2 g (5%) less than the cells fabricated with the traditional current collector (larger weight savings is possible in cells without a stainless-steel case) (M. Pham et al., Cell Reports Physical Science, Vol. 2, Issue 3, 2021, 100360). At similar thicknesses, the aluminum metallized polymer current collectors used by Pham et al. exhibited comparable tensile strength to Al current collectors, however the copper metallized polymer current collectors had significantly lower tensile strength than the copper current collectors (approximately 110 N·m² and 400 N·m², respectively) (M. Pham et al., Cell Reports Physical Science, Vol. 2, Issue 3, 2021, 100360). Ductility of the aluminum and copper metallized polymer current collectors (48%, 36.5%) is vastly improved over the aluminum and copper current collectors (4%, 4%) (M. Pham et al., Cell Reports Physical Science, Vol. 2, Issue 3, 2021, 100360). Additionally, while the specific polymer used for the metallized polymer current collector was not stated by Pham et al., mechanical property improvements could likely be made with stronger polymers such as polyaramids.

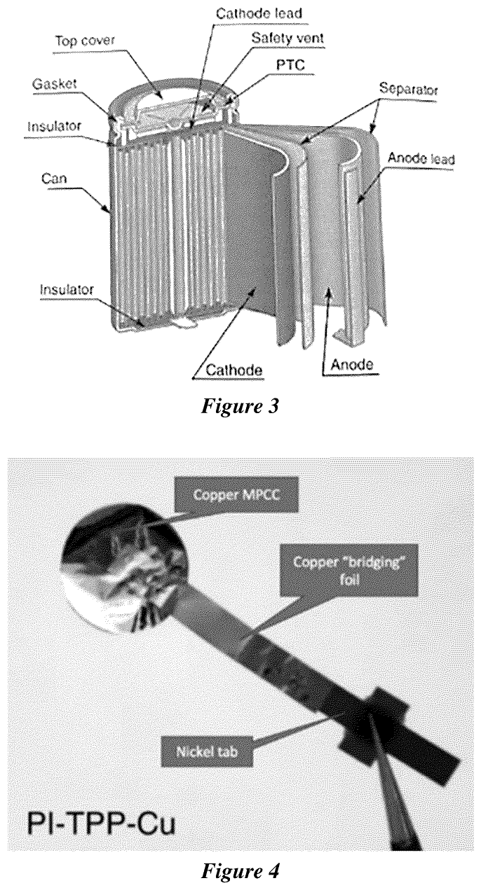

Due to the ultrathin metallized layers on metallized polymer current collector (0.5 micron in Pham et al.), forming a weld nugget with sufficient mechanical and electrical properties is difficult. To make the metallized polymer current collectors conductive in the thickness direction, the polymer layer that forms the base of the metallized polymer current collectors must be displaced to form contact between metallized layers. In Li-ion batteries, the copper anodic current collector must be welded to a tab (commonly nickel) and an aluminum cathodic current collector must also be welded to a tab (commonly aluminum). Depending on the Li-ion battery architecture one current collector may be welded to one tab or a stack of current collectors may be welded to a tab (K. W. Beard and T. B. Reddy, “Linden's Handbook of Batteries: Fifth Edition.” McGraw-Hill Education, 2019). In a cylindrical battery, shown in FIG. 3, the cathode and anode each have one tab (anode/cathode lead). To meet mechanical and electrical performance metrics, novel and innovative joining methods need to be considered.

The success of a joint can be characterized by performance metrics such as mechanical strength and electrical resistance/impedance. In addition to mechanical and electrical performance the joining method should be robust, cost competitive, and scalable to battery cell manufacturing.

Mechanical Joining. Mechanical joining (or force fitting) is sometimes used in Li-ion battery systems to form tab-to-tab or tab-to-busbar joints (module level). However, no examples of mechanical joints from current collector to tab joints (cell level) have been found. There are many methods and configurations for creating mechanical joints, including clinching, nut and bolt, flow drilling screws, rivets, and thread-forming screw connections (M. F. R. Zwicker et al., Journal of Advanced Joining Processes, 2020, 1, 100017). The benefits of mechanical joining include easy disassembly and recycling, easy repair, and no heat input (M. F. R. Zwicker et al., Journal of Advanced Joining Processes, 2020, 1, 100017), although easy repair and disassembly would be less useful in current collector to tab joints (cell level) compared to tab-to-tab joints (module level). Disadvantages of mechanical joining include potential mechanical damage, additional weight, high resistance, and cost of parts and labor. In mechanical joints contact pressure and material properties are key factors to electrical contact resistance (M. F. R. Zwicker et al., Journal of Advanced Joining Processes, 2020, 1, 100017). Other factors such as coatings and oxidation layers (especially aluminum) can also have a strong effect (M. F. R. Zwicker et al., Journal of Advanced Joining Processes, 2020, 1, 100017). Mechanical joints are prone to increases in resistance over time due to factors such as loosening and vibration (M. F. R. Zwicker et al., Journal of Advanced Joining Processes, 2020, 1, 100017). Galvanic corrosion may also be a concern in mechanical joints with dissimilar materials.

Brazing/Soldering. Like mechanical joining, brazing/soldering in battery applications is typically limited to module level joints (M. F. R. Zwicker et al., Journal of Advanced Joining Processes, 2020, 1, 100017). However, when comparing various joining processes (laser, resistance, ultrasonic, force fitting) for brass to 26650 battery joints, soldering was found to give the lowest contact resistance (M. F. R. Zwicker et al., Journal of Advanced Joining Processes, 2020, 1, 100017). Other advantages of brazing/soldering are the ability to join dissimilar materials as well as the wide adoption within the electronics industry (M. F. R. Zwicker et al., Journal of Advanced Joining Processes, 2020, 1, 100017). There are a huge variety of solders, types of flux, and heat input techniques. Disadvantages of brazing/soldering are the need for solder material/flux and additional process complexity (M. F. R. Zwicker et al., Journal of Advanced Joining Processes, 2020, 1, 100017).

When performing module level joining, temperature of the solder material should not exceed 150° C. to avoid damage of the battery cells (M. F. R. Zwicker et al., Journal of Advanced Joining Processes, 2020, 1, 100017). In dissimilar material brazing/soldering there is a direct connection between the thickness of intermetallic and connection resistance (M. F. R. Zwicker et al., Journal of Advanced Joining Processes, 2020, 1, 100017). Solder heat input techniques suitable for battery cells include iron soldering, induction heating, resistance soldering, laser, and reactive nanofoils (M. Brand et al. Journal of Energy Storage, Vol. 12, pg. 45-54, 2017). Iron soldering is more applicable for a lab or prototyping environment.

Ultrasonic Metal Welding. Ultrasonic metal welding (UMW) is the most common commercial joining method for electrode foil-to-tab welding (M. Shahid et al., Materials and Manufacturing Processes, Vol. 34, pg. 1217-1224, 2019). Ultrasonic metal welding utilizes a vibrating horn and stationary anvil to clamp together parts with high pressure. Ultrasonic metal welding creates a solid-state weld through shearing and breaking of surface oxide, followed by plastic deformation and formation of a nascent surface for the weldments (A. Das et al., World Electric Vehicle Journal, Vol. 9, 22, 2018). Ultrasonic metal welding is typically done at 20-40 kHz and reaches temperatures of 0.3-0.5 of the respective melting temperatures of the weldments (A. Das et al., World Electric Vehicle Journal, Vol. 9, 22, 2018). The knurl pattern on a horn can have a large effect on the joint quality (M. Shahid et al., Materials and Manufacturing Processes, Vol. 34, pg. 1217-1224, 2019). Because ultrasonic metal welding is a solid-state process, fewer brittle phases are produced during welding, compared to fusion welding (M. Shahid et al., Materials and Manufacturing Processes, Vol. 34, pg. 1217-1224, 2019). Ultrasonic metal welding may not be suitable for some applications where vibration under pressure may damage structural integrity (prismatic cells, terminal-to-busbar joints) (A. Das et al., World Electric Vehicle Journal, Vol. 9, 22, 2018).

M. Shahid et al. explored the effect of process parameters on the joint strength of a weld made between a nickel tab (100 micron), and two copper foils (10 micron) using ultrasonic metal welding (M. Shahid et al., Materials and Manufacturing Processes, Vol. 34, pg. 1217-1224, 2019). The researchers found that the interface between tab/foil and foil/foil demonstrated similar behavior during tensile testing with similar absolute strength values (M. Shahid et al., Materials and Manufacturing Processes, Vol. 34, pg. 1217-1224, 2019). Additionally, it was found that the types of failure were different for different process parameters, with interfacial separation with partial adhesion being the most dominant failure mechanism (M. Shahid et al., Materials and Manufacturing Processes, Vol. 34, pg. 1217-1224, 2019). Shahid et al. also found that material thinning only occurred on the copper side, due to the significant difference in relative thickness (M. Shahid et al., Materials and Manufacturing Processes, Vol. 34, pg. 1217-1224, 2019).

Edison Welding Institute (EWI) researchers explored various joints and joining techniques within Li-ion battery systems (Speth. “Final Report: EWI Project No. 52521GTH.” Edison Welding Institute, 2011). The researchers evaluated foil to tab joints using ultrasonic metal welding, resistance welding, and laser welding. Ultrasonic metal welding foil to tab welding was performed with copper or aluminum foils (10 layers, 25-micron) to a copper or aluminum tab (125 micron), respectively (no dissimilar joints). They used a 20-kHz transducer, an AmTech Ultraweld L20 weld head, and a sonotrode tip with a fine pitch wave knurl. The researchers found that the foil to tab joints were weaker than similar tab to tab joints, although they had comparable electrical resistance (Speth. “Final Report: EWI Project No. 52521GTH.” Edison Welding Institute, 2011). Finally, the researchers determined that ultrasonic metal welding proved to be the most capable process for making foil to tab connections (compared to resistance spot welding and laser welding) (Speth. “Final Report: EWI Project No. 52521GTH.” Edison Welding Institute, 2011).

In another investigation of ultrasonic metal welding of foil to tab joints, Mitch Matheny of EWI completed an optimization study of three ultrasonic horn design features to produce an optimal horn (Matheny, “Knurl Optimization for Foil-to-Tab Welding in Lithium-ion Battery Cells.” Edison Welding Institute, 2015). Traditional horn designs with closely packed knurls can tear thin foils or fail to make a weld with insufficient energy, resulting in a narrow process window (Matheny, “Knurl Optimization for Foil-to-Tab Welding in Lithium-ion Battery Cells.” Edison Welding Institute, 2015). Matheny varied knurl height, knurl angle, and knurl spacing. The final design produced yielded stronger welds in aluminum with less foil damage (Matheny, “Knurl Optimization for Foil-to-Tab Welding in Lithium-ion Battery Cells.” Edison Welding Institute, 2015). In copper, the final design produced welds with comparable strength but significantly reduced foil damage and weld energy (Matheny, “Knurl Optimization for Foil-to-Tab Welding in Lithium-ion Battery Cells.” Edison Welding Institute, 2015).

Resistance Spot Welding. Resistance spot welding of foils to tabs in Li-ion battery has several inherent challenges including the high thermal and electrical conductivity of aluminum and copper, making it difficult to form a weld (Speth. “Final Report: EWI Project No. 52521GTH.” Edison Welding Institute, 2011). Additionally, any strongly bonded oxide on aluminum's surface is tough to break up during welding (A. Das et al., World Electric Vehicle Journal, Vol. 9, 22, 2018). Electrode sticking is another problem when welding aluminum and copper (A. Das et al., World Electric Vehicle Journal, Vol. 9, 22, 2018). With projection welding it is possible to create a solid-state bond (rather than a fusion bond) and reduce electrode sticking, although the addition of the energy concentrating projections may complicate manufacturing.

EWI researchers developed lobe curves (process window of current versus weld time) for copper or aluminum foils (10 layers, 25-micron) welded to a copper or aluminum tab (125 micron), respectively (no dissimilar joints). They used a Miyachi IPB-5000A mid-frequency DC power supply, series 180A-EZ Air weld head, and non-specified electrodes (Speth. “Final Report: EWI Project No. 52521GTH.” Edison Welding Institute, 2011). When creating copper foil to copper tab welds the researchers were able to create “reasonable” lobe curves (Speth. “Final Report: EWI Project No. 52521GTH.” Edison Welding Institute, 2011). However, when welding aluminum foils to aluminum tabs, the lobe curves were very small indicating that the process will have very little consistency or repeatability (Speth. “Final Report: EWI Project No. 52521GTH.” Edison Welding Institute, 2011).

Laser Welding. Laser welding has been hailed as a potential alternative to ultrasonic metal welding for foil to tab joints in Li-ion battery, due to the potential for increased electrical and mechanical properties (A. Das et al., World Electric Vehicle Journal, Vol. 9, 22, 2018). One of the keys to laser welding a component with multiple interfaces is to ensure good contact of the foils/tabs (A. Das et al., World Electric Vehicle Journal, Vol. 9, 22, 2018). Additionally, battery foil and tab materials (copper, aluminum) have a high reflectivity at many laser wavelengths (A. Das et al., World Electric Vehicle Journal, Vol. 9, 22, 2018).

Researchers at EWI explored laser welding of copper or aluminum foils (10 layers, 25-micron) to a copper or aluminum tab (125 micron) (Speth. “Final Report: EWI Project No. 52521GTH.” Edison Welding Institute, 2011). The researchers utilized a 600-watt ytterbium fiber laser (1.07 μm wavelength), and they found that directly welding foil to tab was generally unsuccessful (tab either on top or bottom) (Speth. “Final Report: EWI Project No. 52521GTH.” Edison Welding Institute, 2011). When directly welding foils to tabs the researchers found that metal would “melt back” leaving gaps between the layers (Speth. “Final Report: EWI Project No. 52521GTH.” Edison Welding Institute, 2011). The EWI researchers found that sandwiching the foils between two tabs was a more successful technique, however the gaps between layers was still problematic (Speth. “Final Report: EWI Project No. 52521GTH.” Edison Welding Institute, 2011).

To improve laser welding of copper at 1 μm wavelength, Hess et al. utilized a green laser (515 nm wavelength) in tandem with their Trumpf disk laser (1.03 μm) (A. Hess et al., Physics Procedia, Vol. 12 Part A, pg. 88-94, 2011). The green laser significantly influenced the behavior of IR welding of copper alloys (A. Hess et al., Physics Procedia, Vol. 12 Part A, pg. 88-94, 2011). The green laser lowered the penetration threshold for the IR laser and reduced the amount of melt ejections that occurred during welding (A. Hess et al., Physics Procedia, Vol. 12 Part A, pg. 88-94, 2011).

Metallized Polymer Current Collector Joining. Ye et al. embedded flame retardant triphenyl phosphate within the polymer of a copper metallized polymer current collector to further improve the safety of Li-ion battery (Y. Ye et al., Nature Energy, Vol 5, pg. 786-793, 2020). The copper metallized polymer current collectors had an overall thickness of 9 micron with a metallized copper thickness of 1 micron (0.5 micron on both sides) (Y. Ye et al., Nature Energy, Vol 5, pg. 786-793, 2020). Ye et al. utilized a 12-micron copper foil to bridge between the copper metallized polymer current collector and nickel tab to form a “satisfactory” weld (Y. Ye et al., Nature Energy, Vol 5, pg. 786-793, 2020), as shown in FIG. 4. Unfortunately, neither the welding method nor the mechanical/electrical properties of the joint were specified.

Tab Designs/Tabless Batteries. Although Li-ion batteries are made by more than 100 manufacturers worldwide (K. W. Beard and T. B. Reddy, “Linden's Handbook of Batteries: Fifth Edition.” McGraw-Hill Education, 2019) the design between batteries of the same architecture is generally the same. In cylindrical batteries, such as in FIG. 3, two electrode tabs are typically used, one positive and one negative. In a cylindrical battery, the number of tabs and tab positions can affect battery temperature, performance, and safety (X.-Y. Yao et al., IEEE Access, Vol. 7, pg. 24,082-24,095, 2019). Tab design is especially critical in high-power batteries (X.-Y. Yao et al., IEEE Access, Vol. 7, pg. 24,082-24,095, 2019). When only two tabs are used in a cylindrical battery, electrons must travel long distances during charging and discharging, this leads to an increase in ohmic resistance and voltage drop, as well as non-uniform current density and high temperatures at the tabs (X.-Y. Yao et al., IEEE Access, Vol. 7, pg. 24,082-24,095, 2019). Non-uniform current density will effectively decrease energy density, create aging gradients (T. Waldmann et al. Journal of Energy Storage, Vol. 5, pg. 163-168, 2016) and may lead to overcharge/over-discharge conditions (X.-Y. Yao et al., IEEE Access, Vol. 7, pg. 24,082-24,095, 2019). Spotnitz et al. developed software to simulate current density with various tab locations and current collector thickness (R. Spotnitz et al., ECS Transactions, Vol. 50, pg. 209-218, 2013). The researchers found that increasing the number of positive tabs to two with one negative tab significantly increases capacity and voltage, while further increases in number of tabs only produced a marginal benefit (R. Spotnitz et al., ECS Transactions, Vol. 50, pg. 209-218, 2013). The effect of multiple current collector tabs on current density is shown in FIG. 4 (X.-Y. Yao et al., IEEE Access, Vol. 7, pg. 24,082-24,095, 2019).

The concept of multiple tabs to reduce current density variation, ohmic resistance, and temperature can be expanded to a “tabless” configuration in which the edge of both current collectors acts as the tab. In addition to the aforementioned benefits, a tabless battery could save material and simplify manufacturing. Some battery fires have been associated with welding tab defects and burrs (X.-Y. Yao et al., IEEE Access, Vol. 7, pg. 24,082-24,095, 2019). While the concept of a tabless battery is not new, Tesla recently made headlines with a patent application of a new battery with a tabless design. Tesla utilizes a conductive edge strip on each current collector that can be slit and folded over to form the connection to the battery terminals (US 2020/0144676 A1). The patent application states that the current collector to battery terminal connection may be made with laser welding, ultrasonic welding, or mechanically (with compressive force) (US 2020/0144676 A1). A tabless configuration is of interest for metallized polymer current collector applications because joining of metallized polymer current collector's is so difficult and any method that can remove a metallized polymer current collector to tab joint could be beneficial.

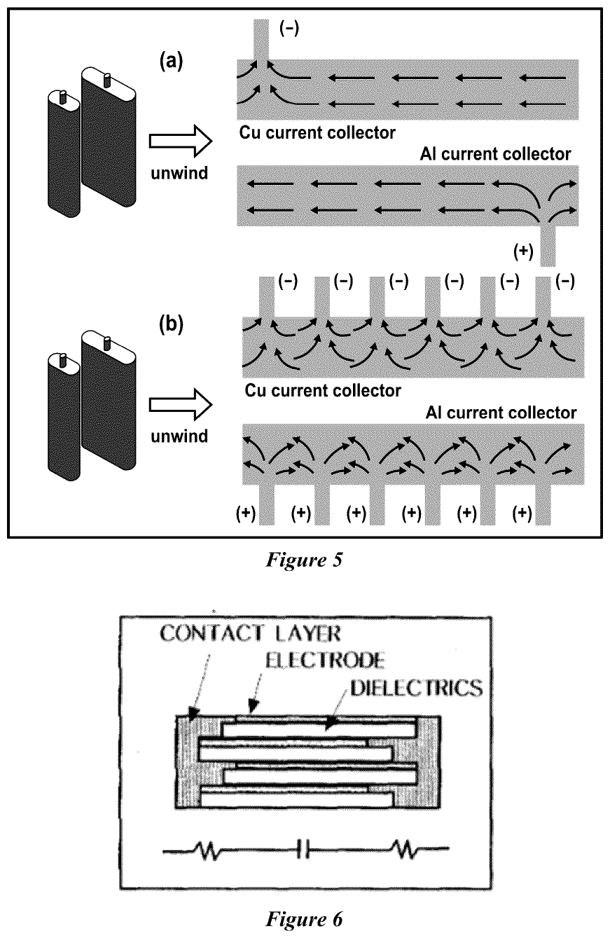

Metallized Film Capacitors and Metal Contact Layer Fabrication. Metalized film capacitors are widely used in modern electronics due to their good electrical characteristics such as low dielectric loss and low dependence on temperature and frequency (H. Li et al., Microelectronics Reliability, Vol. 55, pg. 1046-1053, 2015). In addition, metalized film capacitors display “self-healing” upon local dielectric breakdown, which is like the behavior of metallized polymer current collector during internal short circuit (H. Li et al. Microelectronics Reliability, Vol. 55, pg. 945-951, 2015). Metalized film capacitors have a polymer thickness (commonly polypropylene or PET) between 5-10 micron and metallization (aluminum or zinc) of a few nanometers (H. Li et al., Microelectronics Reliability, Vol. 55, pg. 1046-1053, 2015). Wound capacitors are constructed by winding the metallized films around a mandrel to form a cylinder (M. H. El-Husseini et al., Journal of Physics D: Applied Physics, Vol. 36, pg. 2295-2303, 2003). The two electrode films are slightly offset (a few millimeters) during winding so that one electrode extends off the end of the other electrode (M. H. El-Husseini et al., Journal of Physics D: Applied Physics, Vol. 36, pg. 2295-2303, 2003). Finally, a hot metal (typically zinc or zinc-tin alloy) is sprayed one both ends (known as schoopage) to make an electrical connection with the offset electrode (M. H. El-Husseini et al., Journal of Physics D: Applied Physics, Vol. 36, pg. 2295-2303, 2003), as shown in FIG. 5.

The quality of the contact layer has a direct impact on the capacitor properties, including the equivalent series resistance of the capacitor (H. Li et al., Microelectronics Reliability, Vol. 55, pg. 1046-1053, 2015). The contact layer is also one of the most critical reasons for capacitor failure (H. Li et al., Microelectronics Reliability, Vol. 55, pg. 1046-1053, 2015), as lifetime experiments have shown that metallized film capacitors with lower equivalent series resistance have longer lifetimes in high current pulse applications (H. Li et al., Microelectronics Reliability, Vol. 55, pg. 1046-1053, 2015). Peak current surge pulses can cause rapid temperature rises in the contact layer, causing thermal stresses and sometimes electrode self-healing (US 2020/0144676 A1). Sang Shik Park et al. explored the effect of morphology, size, and temperature of sprayed particles on the electrical properties of metallized film capacitors (S. S. Park et al., Proceedings of the 5th International Conference on Properties and Applications of Dielectric Materials, 1997, 2, 697-700). The researchers utilized zinc as a spray material with particles of irregular shape ranging in size from 50 μm to 80 μm (S. S. Park et al., Proceedings of the 5th International Conference on Properties and Applications of Dielectric Materials, 1997, 2, 697-700). The particles sprayed at 4 bars of pressure (versus 2, 3 bar) had the smallest particle size and most dense depositions, resulting in a low equivalent series resistance and dissipation factor. Metalized film capacitors are of interest because of their similarity in materials (metallized film/polymer) and architecture (cylindrical structure), as well as an external connection which does not require welding metalized films to electrode tabs.

Joining Metallized Polymer Current Collectors. Metallized polymer current collectors, unlike standard foil current collectors, are not electrically conductive from one metal surface to the other, due to the insulating polymer in between. Therefore, to form an electrical connection, polymer must be partially or fully displaced in the weld region. Displacing the polymer without destroying the metal foils on either side has proven difficult in initial testing. Furthermore, displacing the polymer can weaken the joint, as the polymer is the main source of strength in the metallized polymer current collectors. The thickness of the metal layer may become a critical parameter. Welding stacks of the metallized polymer current collectors may also present additional challenges, compared to welding one metallized polymer current collector to a tab. Lastly, any process must display appropriate robustness and repeatability to be feasible in a manufacturing environment. Displacing polymer then creating a metal weld in stacks may make a robust process difficult, which is why novel joining methods may need to be considered.

As materials science has progressed, welding and joining of next generation materials has proved to be a recurrent bottle neck in the progress of technology and society. Improving energy storage technology is imperative to shifting away from fossil fuels and slowing the rapid warming of the planet. Increasing energy density and safety of Li-ion battery while also decreasing cost is essential to implementation of Li-ion battery, especially in vehicles. Metallized polymer current collectors have demonstrated their ability to prevent thermal runaway and battery fires during nail penetration tests (M. Pham et al., Cell Reports Physical Science, Vol. 2, Issue 3, 2021, 100360). Additionally, metallized polymer current collectors require less copper and aluminum, resulting in battery cell weight reductions, energy density improvements, as well as cost reduction. However, as with many advanced composite materials, welding of metallized polymer current collector has proven to be difficult. Developing a solution for welding metallized polymer current collector could result in faster adoption of metallized polymer current collector which would be another step forward for Li-ion battery technology.

Creating welds between current collectors and battery tabs is already a difficult engineering problem with mechanical, electrical, and metallurgical challenges. Metallized polymer current collectors further exacerbate welding difficulties by necessitating polymer displacement/ablation to make metal to metal contact and a full penetration weld. In the case of resistance spot welding, current will not even pass through the metallized polymer current collectors until the polymer is displaced and metal to metal contact occurs. Additionally, a weld nugget composed of the two or more thin metallization layers will be very thin and may not have the required mechanical properties. A bridging foil, adhesive, interlayer, or filler metal may be necessary to create a mechanically and electrically stable joint. Otherwise, tabless architectures may need to be explored to remove the necessity of metallized polymer current collector to tab joints. While welding of metallized polymer current collector is a difficult engineering problem, joining has proved to be the bottleneck on this important and impactful technology, and the ability to create reliable welds could be a breakthrough in battery safety.

In a typical foil current collector-to-tab joint with multiple current collectors, flux and braze/solder material could simply be applied between each current collector and between the final current collector/tab. However, because of the electrically insulating polymer within metallized polymer current collector, this would not provide an electrically conductive joint. Theoretically, the polymer could be displaced with a pre-joining step, allowing metal to metal contact. Another approach would be to ablate (laser) a section of overlapped tab/metallized polymer current collector and apply the flux and solder/braze material through the ablated region, allowing capillary action to spread solder/braze material and form a sufficient contact area. Additionally, a stamping process could be used to form surface channels in the metallized polymer current collector to promote capillary action of the solder/braze material.

A tabless configuration can also be explored for a brazed/soldered joint. Like a metallized film capacitor, flux and liquid braze/solder material could be applied to the face of a battery with overextended current collectors via spray (schoopage). Alternatively, a strip of solder/braze material could be pre applied to the current collectors with vapor deposition, and various heating methods could be used to melt the solder and form the current collector to exterior connection joint.

Along with process parameter optimization and horn knurl pattern optimization, various metallized polymer current collector to tab joint designs can be tested and analyzed. For cylinder battery architectures, only one or two metallized polymer current collectors to one tab (for each the positive and negative current collectors) needs to be made. For stacked anode/cathode architectures multiple current collectors can be welded to one or two tabs. Various joint designs include tab on top, tab on bottom, tab on top and bottom (sandwiching metallized polymer current collector), and a bridging foil between metallized polymer current collector and tab can be tested.

Stamping could also be used to create channels for the solder/braze material to flow. The joints can be evaluated on several metrics including electrical and mechanical performance. For electrical performance, the electrical impedance, resistance, and current carrying ability can be measured. An impedance analyzer can be used to measure the electrical impedance of the joint as a function of frequency for 0.5 Hz to 10 KHz. Impedance can be used as a metric for battery and battery weld quality (T. Gao et al. Electrochimica Acta, Vol. 363, 2020, 137197; Z. Stoynov et al. Journal of Power Sources, Vol. 30, pg. 301-207, 1990). The electrical contact resistance can be measured using one of the methods described in ASTM B539-20-Standard Test Methods for Measuring Resistance of Electrical Connections (Static Contacts). Finally, different current levels can be transmitted through the joint while measuring its temperature using an Infrared camera. The current level where the temperature becomes too high or where the metallized layer in the metallized polymer current collector burns out (pulls away). For mechanical performance, the peel strength and tensile strength of the joint can be measured. In addition to joint metrics, other tools can be employed to better understand the nature of metallized polymer current collector joints and the effect of different processes/parameters. Optical microscopy, scanning electron microscopy (SEM), and transmission electron microscopy (TEM) can be utilized when necessary to explore weld interfaces, polymer and metal squeeze flow, weld defects or impurities, and other aspects of a metallized polymer current collector joint. Electron Backscatter Diffraction (EBSD) can also be used to characterize microstructures in metallized polymer current collector joints. EBSD can be used to identify phases, grain sizes/shapes, and other materials characteristics.

### Overview of Metallized Polymer Current Collector, Ultrasonic Plastic Welding, Ultrasonic Metal Welding, Displacing Polymer with Plastic Welding, Laser Welding, Resistance Welding

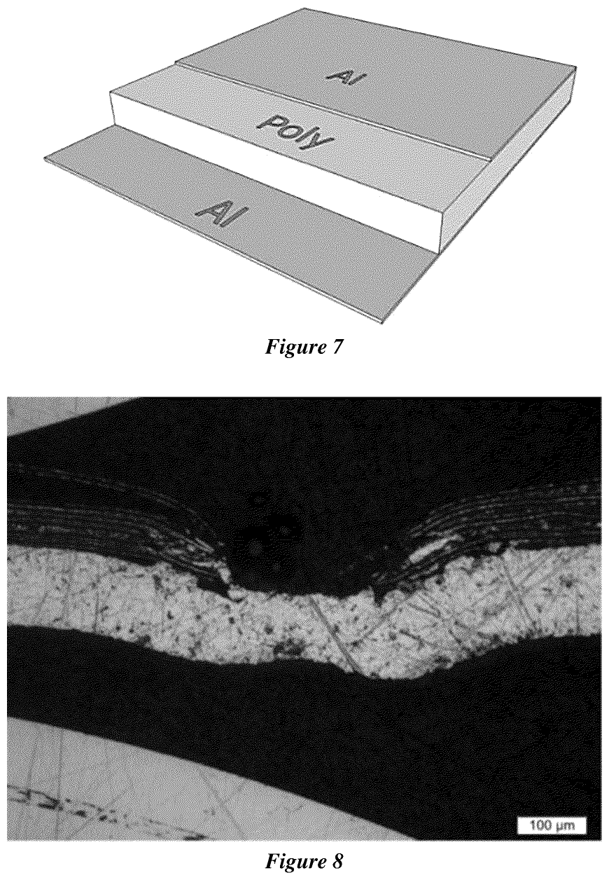

A schematic diagram of a metallized polymer film is shown in FIG. 7. The metal films (e.g., Al as shown in FIG. 7, Cu, etc.) have a thickness of about 1 micrometer and the polymer film (e.g., PET, Kapton, etc.) has a thickness of about 6 micrometers. An example metallized polymer film includes copper films as the metal and Kapton as the polymer layer (Kapton can be used because vapor depositing copper on PET is a challenge).

Several methods were investigated for joining metallized film current collectors/tabs, including ultrasonic welding (plastic and metal), laser welding, and resistance welding.

Ultrasonic plastic welding was investigated for joining metallized film current collectors by displacing polymer and creating mechanical interlocking. Various amounts of aluminum metallized polymer current collectors were used ranging from 2 films to 10 films. A Branson 2000ae ultrasonic welder was used with a 40 kHz converter, 1:1 gain booster, and 1:1.5 gain flat horn. Two different knurled surfaces were used as anvils to create localized high-pressure regions and mechanical interlocking. Additionally, a hot plate was also used to heat the anvil. Parameters ranging from 0.1s-10s weld time, 10%-100% amplitude, 200° C. -300° C., and 15 psi cylinder pressure-60 psi cylinder pressure were used in various combinations to attempt to create a joint. The joints were analyzed for electrical connection using a Fluke 83V multimeter using the ohmmeter function. One probe would be placed on the top film and another on the bottom film, a non-existent electrical connection would be indicated by very high (1 ohm+) or infinite resistance. At high weld pressures (55 psi cylinder pressure) and after the top film in the stack was removed, an electrical connection capable of carrying 3.2 amps at 0.19 ohms was found. This current carrying capacity could have been due to the edges folding over at the high pressures. Additionally, less than 50% of the joints created using this method were found to have any current carrying capacity, and this method would not be conducive to larger stacks of current collectors.

Experiments were performed that attempted to squeeze out the polymer layer within a single current collector to create metal to metal contact within a single film using the setup and parameter described during the testing of the ultrasonic plastic welding process above. Theoretically, this would allow for resistance welding of a stack of films and potentially easier laser welding. However, due to the aspect ratio of the films, squeezing out the polymer (6 micron thick) and getting the 1-micron thick layer of metals in contact with each other without destroying the films is extremely difficult. Additionally, this would not be possible of Kapton is used as the polymer base, rather than PET. Also, the ability to resistance weld such a film (even with PET displaced) is unlikely due to the low mechanical strength of 1 micron of metal and the high conductivity of the aluminum/copper layers.

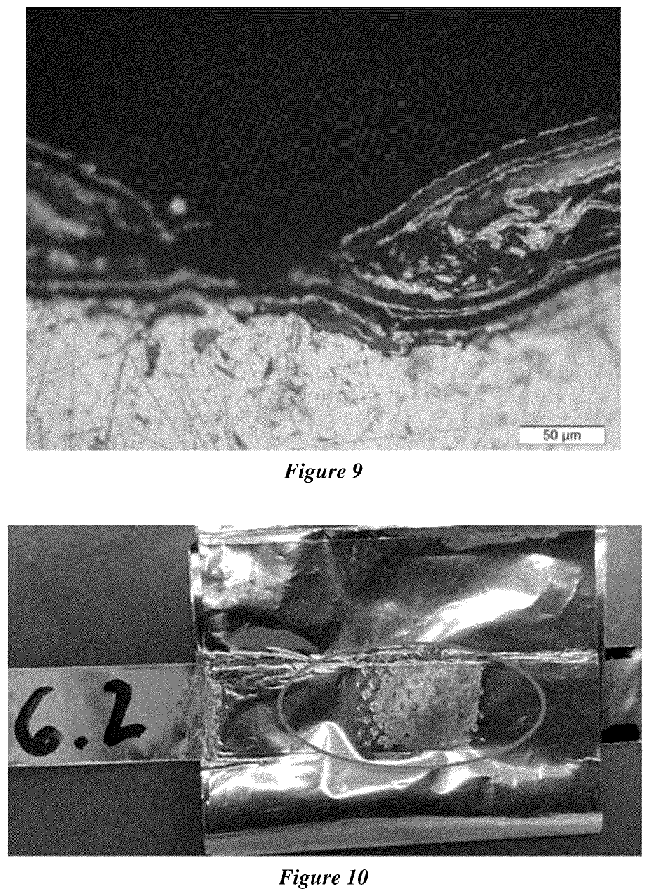

Ultrasonic metal welding was attempted for joining aluminum metallized film current collectors to a 0.1 mm thick aluminum tab using a Branson L20 ultrasonic welder. Welds capable of carrying current were made using parameters of 120 J (energy mode), 70 psi weld pressure, and an amplitude of 40-micron. The welds created using ultrasonic metal welding had fragile film-to-film and film-to-tab joint. A cross sectioned weld divot can be seen in FIG. 8 and FIG. 9. Likely, the melted plastic and mechanical interlocking was providing the (low) strength of the ultrasonic metal welds and allowing for physical contact and current carrying. The joints were analyzed for electrical connection using a Fluke 83V multimeter using the ohmmeter function. One probe was placed on the top film and another on the tab, a poor electrical connection is indicated by very high (1 ohm+) or infinite resistance. It was found that less than 50% of the welds had an electrical connection on each layer in the stack. Even with other process improvement methods (e.g., aluminum foil between layers in welds), an acceptable manufacturing yield for welds made with ultrasonic metal welding is unlikely due to the randomized deformation and folding of each layer.

For laser welding, a 300 watt, Nd:YAG (1064 nm) laser was used. The process only resulted in boring holes in stacks of tabs and films with significant spatter. No mechanical or electrical joints were produced.

Resistance welding is not possible without displacing PET as current will not flow due to PET. Displacement of PET was attempted with ultrasonic plastic welding (hot and cold) before resistance welding. Resistance welding was done with a conventional 60 Hz resistance spot welder with varying current levels and welding forces. No current ran through the metallized polymer current collectors during the weld cycle, indicating that the insulating polymer layer still remained.

### Example 2—Initial UAS Trials and Feasibility Demonstration

Ultrasonic assisted soldering was investigated as a method to join metallized polymer current collectors without the use of a corrosive flux. A flux is typically necessary when soldering aluminum or copper to remove the oxide surface and facilitate wetting of the solder. However, because of the thinness of the metal layer in metallized polymer current collectors, a flux simply burns holes through the entire current collector. Additionally, a flux could potentially cause contamination in a battery system.

In Ultrasonic Assisted Soldering (UAS), pressure from ultrasonic forms vapor filled cavities in liquid, when cavities implode, they produce a shock wave with high pressure (˜10⁹ N/m²) and a jet stream (˜500 m/s) directed towards solid surface in the fluid (cavitation). The jet stream removes oxides from the solid surface and allows for wetting of solder. Ultrasonic assisted soldering can tailor crystallization behavior of solder layer (fine grains), dramatically affecting the physical-chemical interaction at the liquid solder/base metal interface. Ultrasonic assisted soldering can allow soldering at lower temperatures than other methods. Typically, in Ultrasonic assisted soldering the solder joint is brought to a temperature lower than the solder melting point and internal heat generation in the solder (from ultrasonics) provides the rest of the heating. Methods of application: specialized ultrasonic soldering iron, ultrasonic solder bath, longitudinal ultrasonic (ultrasonic plastic welder).

The ultrasonic assisted soldering process equipment included a Branson 2000ae ultrasonic welder with a 40 kHz converter, 1:1 gain booster, and 1:1.5 gain flat horn. A hotplate sits on a silicone rubber mat (which can improve parallelism), on the anvil region of the welder. Teflon tape covers the flat ultrasonic horn (8 mm×30 mm).

An initial wetting test was performed on one aluminum metalized polymer current collector (approximately 30 mm×30 mm) using a 4 mm×4 mm solder that was 0.1 mm thick. The hot plate was brought up to a temperature of approximately 218° C. (slightly below solder melting point). Then, ultrasonics were applied at 50% amplitude for 0.5 seconds, with a hold time of 3 seconds. A Sn-Ag solder was used (melting point 220° C.). Two aluminum metallized polymer current collectors were used. The solder wetted well, but the ultrasonics were applied for too long and/or the temperature was too high, which destroyed the metallized polymer current collector.

Reducing the weld time to 0.2 s resulted in a successful joint between two metallized polymer current collectors. The joined metallized polymer current collectors were subjected to a manual peel test, which resulted in failure of the metallized polymer current collector at the solder interface. It was difficult to conduct electrical and/or mechanical testing with overlaying sheets, so further tests used a lap joint configuration.

It was easier to perform current to failure and tensile-shear mechanical test with overlapped samples (8 mm overlap). For such samples, two 4 mm×4 mm pieces of solder were used to bond two 30 mm×30 mm current collectors.

For mechanical testing, a tensile-shear test was used. One film was fixed in a force transducer and the other was manually pulled vertically. For a test on the two joined layers, the peak force was 3.9 lbf and the sample failed at the interface between the solder and the metallized polymer current collector.

Current to failure was tested by attaching the solder joint to an Agilent E3633A DC power supply and applying an increasing voltage. When the power supply displayed 6.3 A and 2.2 V, the solder joint began to thermally degrade, although the degradation was outside the overlap (solder joint) area.

Various methods were investigated to create an initial through-hole for solder placement and flow, which allows for electrical conduction in the through-thickness direction.

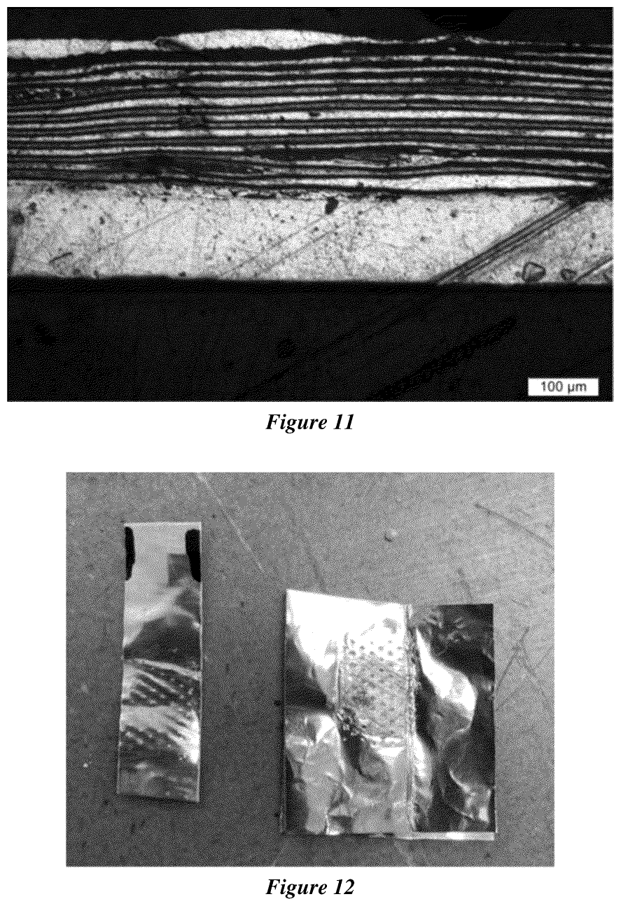

A knurling tool on mill was tested on a 16-film stack. Ultrasonic assisted soldering was performed on the films punctured with the knurling tool (FIG. 10). The ultrasonic assisted soldering was performed with a Branson 2000ae ultrasonic welder with a 40 kHz converter, 1:1 gain booster, 1:1.5 gain flat horn, and a hotplate set on the welder anvil. It was difficult to locate the weld divots in the cross section, but the optical microscopy shown in FIG. 12 still showed good wetting. However, not every interface showed good wetting (FIG. 11) (200× magnification). Moreover, the tab side of the solder joint showed little solder penetration (FIG. 12), and the tab-to-film was weakly bonded. Additional solder could be placed on the tab to create a better bond between the tab and the film stack. Because the knurling tool relies on deformation rather the material removal, consistent paths to the tab were not created.

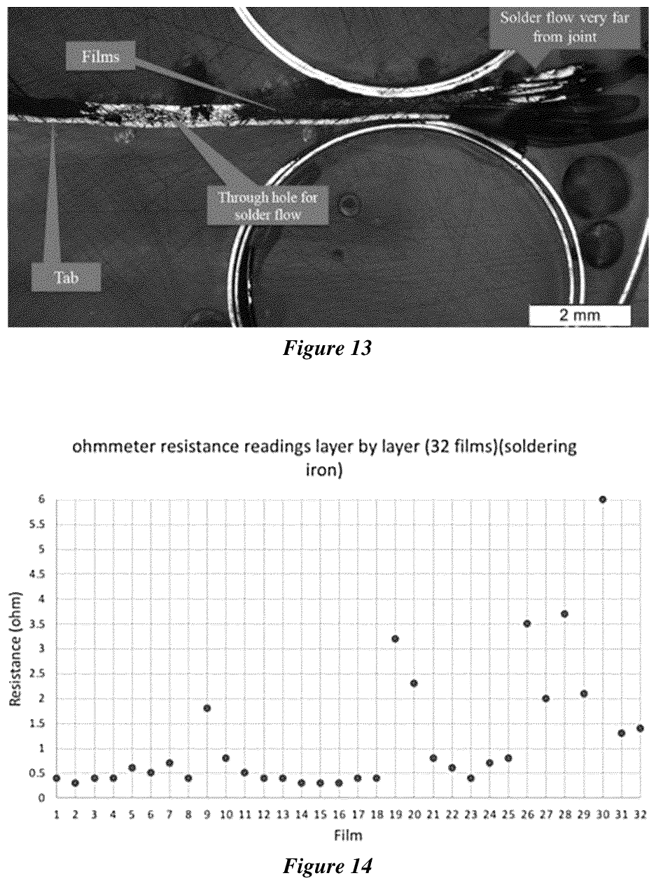

A hot soldering iron was used to create the through hole on a 32-film stack of aluminum metallized polymer current collectors. Ultrasonic assisted soldering was performed on the films punctured with the soldering iron with materials and methods similar to what was described above in the knurling tool- ultrasonic assisted soldering (UAS) joints. Optical microscopy of the solder joint shows that there was good solder flow between some layers, but poor solder flow between other layers (FIG. 11). The soldering iron (or other non-rapid methods of making a hole using heat) are problematic because the melted plastic can seal off the channels between films. Despite the melted plastic, solder was found ˜6 mm from the solder joint in some cases (FIG. 13). Ultrasonic assisted soldering (UAS) is effective at promoting solder flow. Solder can flow preferentially down paths which offer low resistance to flow. To create a more balanced distribution of solder, all interlayer regions should offer similar levels of flow resistance.

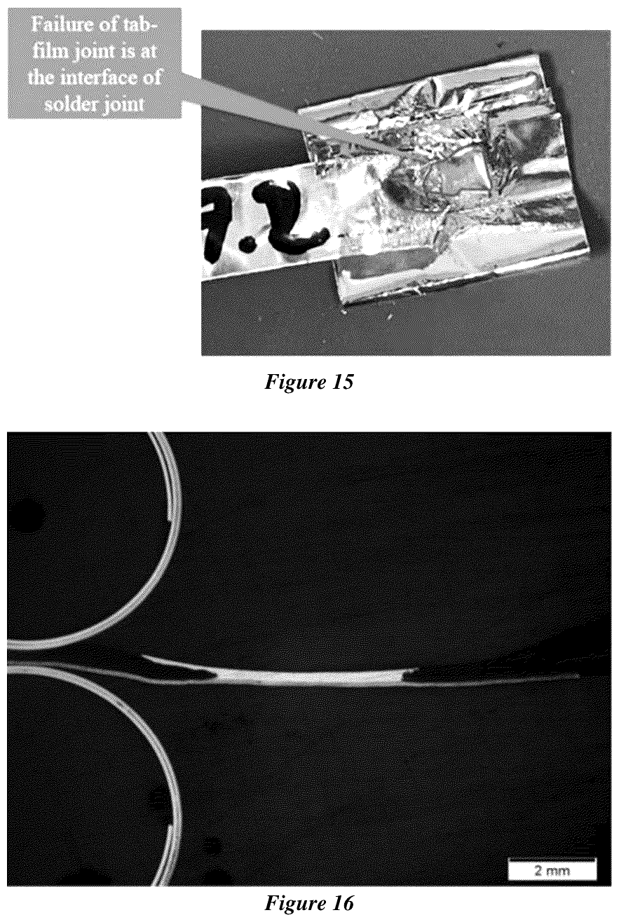

Layer by layer resistance measurements were performed on a sample prepared from a 32-film stack perforated with a soldering iron (FIG. 14). The layer-by-layer resistance analysis was done with a Fluke 83V multimeter (ohmmeter function). One multimeter probe was placed 5 mm from the solder through hole, with the other probe placed on the tab, 5 mm from the edge of the metallized polymer current collector, resulting in an approximately 25 mm current path between the probes. Once a specific layer resistance measurement was taken, the measured film was peeled off and the process repeated for each film. Because the measurements were performed with an ohmmeter without precise regulation of probe-force and distance from solder joint, this analysis is not meant to provide a resistance of the solder joint, but instead to find outliers (resistance above quartile three +(1.5) (interquartile range)) which could indicate poor connection to the solder joint. The melted plastic was blocking interlayer channels and therefore there were many layers with high resistances (FIG. 14). According to the outlier definition proposed above and the layer resistances found, four outliers (>3.15 ohm) were found. A Tab-film joint prepared using this method and manually pulled in tension failed in the tab region (FIG. 15).

Possibilities for increasing the consistency of the interlayer wetting are: using a fixture that can clamp around the desired solder area that prevents excessive solder spread in some layers (with preferential solder paths) and builds up pressure for consistent interlayer spread; stamping channels into films using other methods and/or weaving a thin solder wire to join films and then ultrasonic soldering to melt and wet.

Accordingly, a punch tool was tested for creating through-holes in stacks of current collectors. The punch tool can cut holes in the films with minimal physical damage, which may facilitate even amounts of solder spread between layers. A grid of straight holes can increase the chances of complete interlayer wetting and have a large bonding area on the tab. Such punch tools are available in a variety of diameters (such as 3/16″, 5/16″, ⅜″, 7/16″, ½″), but the tools are prone to dulling. Once the through-hole is formed, the solder piece can be placed in the through hole, prior to ultrasonic assisted soldering.

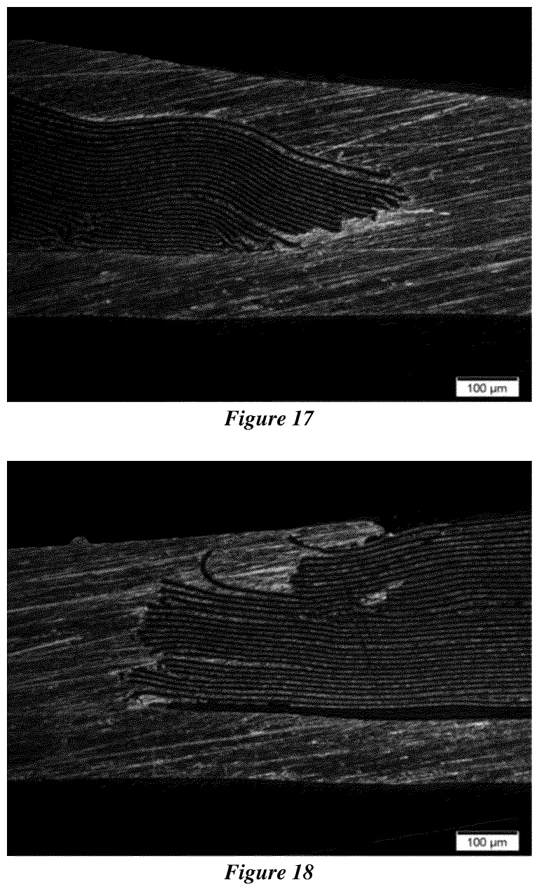

An example cross-section of a solder disk/hole punch joint is shown in FIG. 16 (12.5× magnification). The solder foil thickness was 0.2 mm. A stack of 32 current collector films has a thickness of 0.256 mm. Typical solder application is a 5 mm diameter disk in the middle of the film stack and an 8 mm diameter disk on top of the film stack. Optical microscopy images of the solder disk/hole punch joint are also shown in FIG. 17 and FIG. 18 (200× magnification). It can be seen in FIG. 16 that films folded onto each other prevented interlayer solder spread; potential solutions are to use a “stepwise” or upside-down pyramid shape (e.g., multiple hole punches with increasing diameter and mechanical stops). It can be seen in FIG. 18 that there was good solder flow between most films. However, it was difficult to verify the presence of solder between some layers using optical microscopy; SEM and/or CT scanning can be used to analyze/qualify the presence of solder and joins more thoroughly.

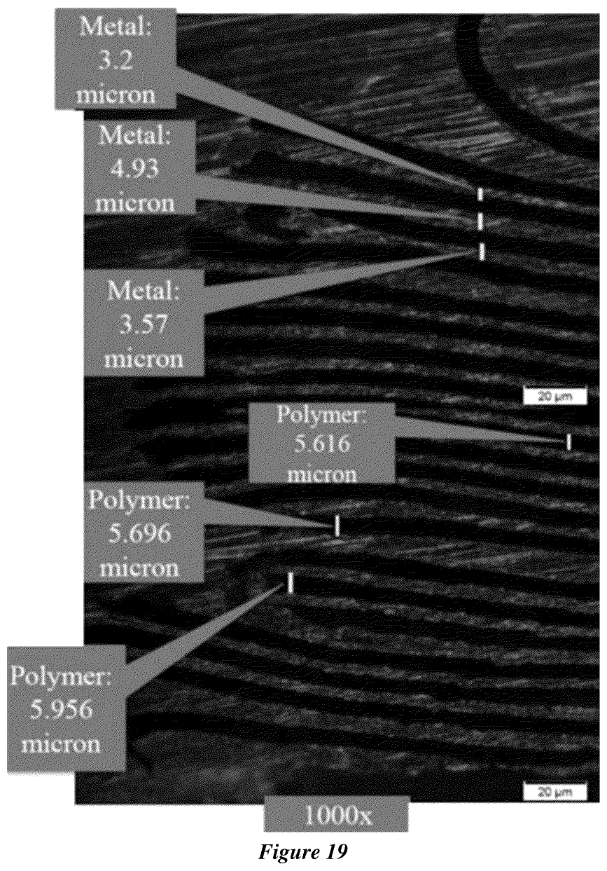

Optical microscopy and image analysis software (Image J) was utilized to assess the thickness of the metal regions between films and to try and detect the presence of solder. Each film should be about 1 micron of metal on each side of the film. Therefore, theoretically, without solder, there should be 2 microns of metal at a film-film interface. Image analysis of a film is shown in FIG. 19.

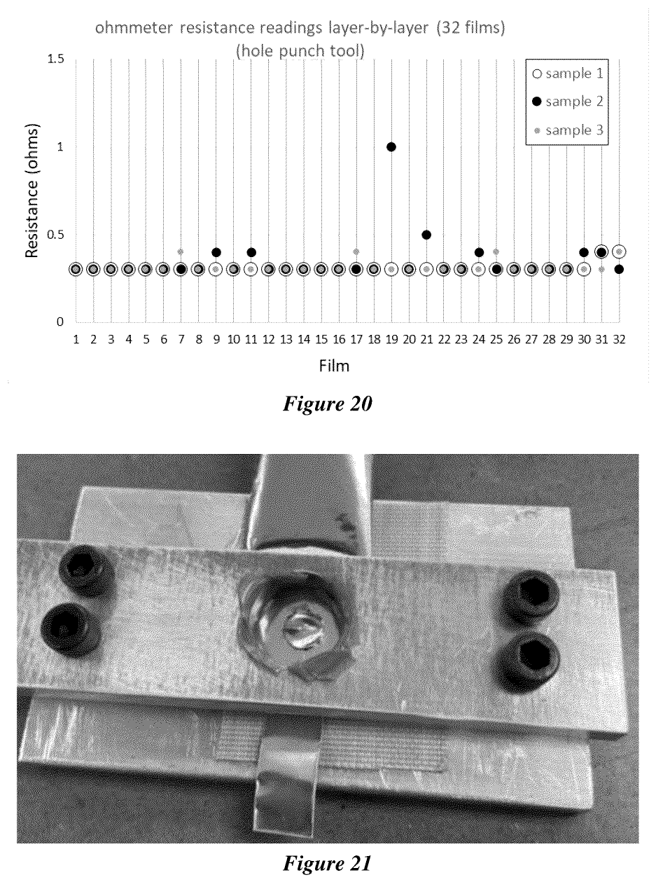

Layer by layer resistance measurements were performed similarly to those described above, in the solder through holes made with a hot iron. FIG. 20 shows the ohmmeter resistance readings layer by layer (32 films) for 3 samples formed using the hole punch tool. Comparing the layer-by-layer resistances it can be seen that joint consistency improved using the hole punch tool compared to the soldering iron.

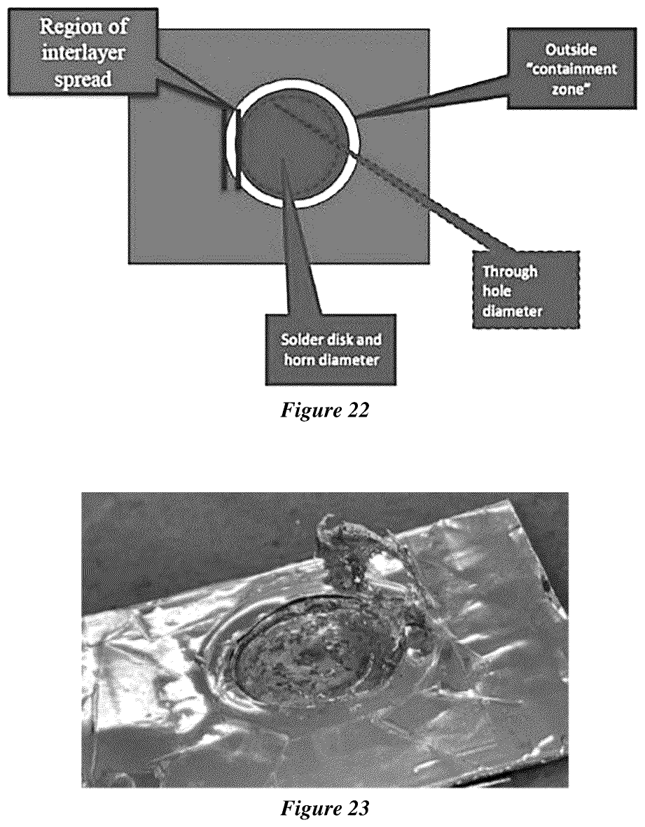

Next, a fixture was used to attempt to increase interlayer wetting (FIG. 21). The fixture was designed as a mechanical clamp that holds tab and films within. Top clamp has a through hole that is slightly larger to allow the horn to pass through the clamp to create the joint but allow solder to spread radially before it is halted by the inner diameter of the top mechanical clamp. The fixture can create a “containment zone” to build up pressure in the solder area and prevent massive solder spread in some layers over others. In order for the fixture to work, the size of the fixture, ultrasonic horn, and solder through-hole need to be the correct sizes (e.g., as shown in FIG. 22). Further, the set-up suffers from various weaknesses: it is difficult to remove the sample from the fixture, so solder stays molten after removal from hotplate; the top “cap” would ideally be Teflon or Kapton; and temperature control is more difficult. As can be seen in FIG. 23, some samples vertically ejected the solder due to the fixture.

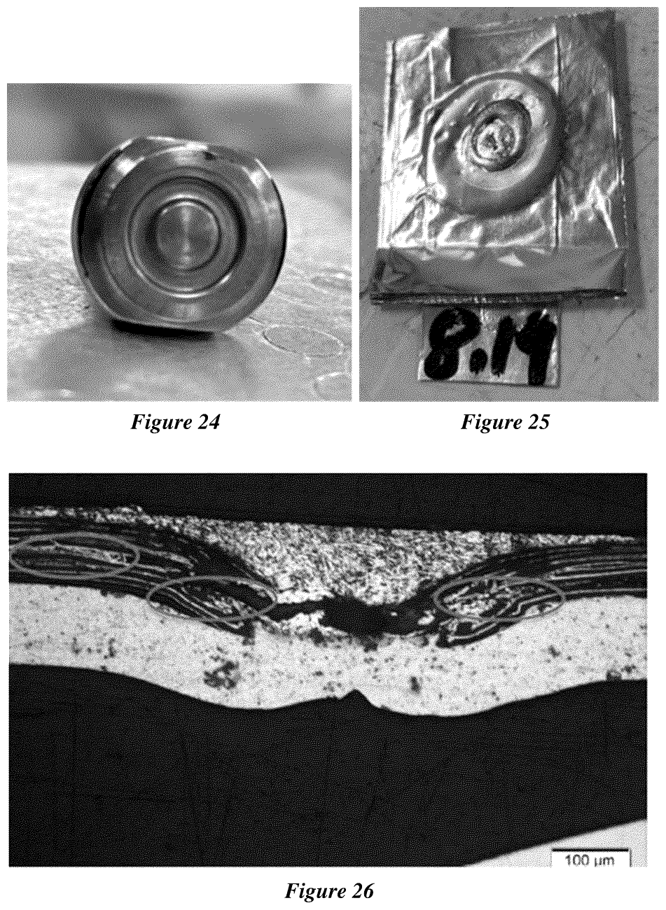

Next, the ability of the geometry of the horn attachment to increase interlayer wetting was investigated. An example horn attachment used in an ultrasonic staking process is shown in FIG. 24. The staking horn did result in some shaping of the solder joint (FIG. 25), but not in a manner that was desired.

### Example 3—Conductive Adhesive Bonding of Metallized Polymer Current Collectors to Themselves and to Tabs for Li-Ion Batteries

Electrically conductive adhesive can also be applied to metallized polymer current collector ultrasonic metal welds to improve mechanical and electrical properties. Ultrasonic vibration can also help the adhesive penetrate and flow between the films, similar to ultrasonic assisted soldering. The ultrasonic vibration also helps heat and cure the adhesive rapidly.

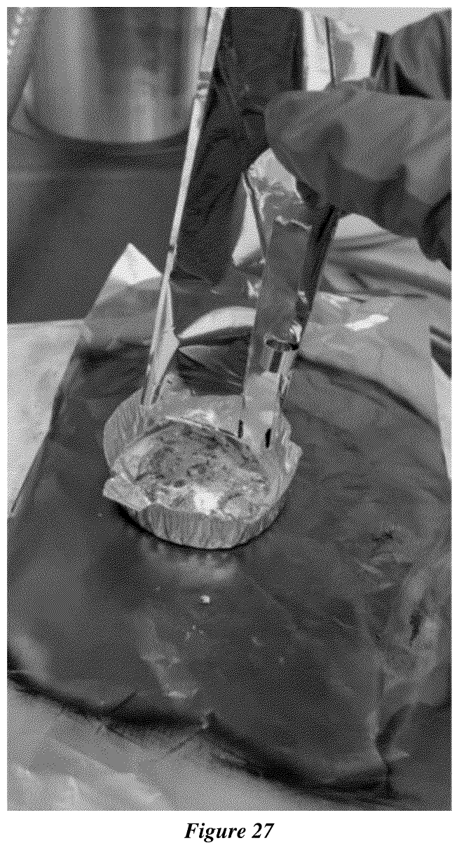

A silver based electrically conductive adhesive (ECA) (69% Ag flakes and epoxy resin) was applied to 8-film thick ultrasonic metal welds of metallized polymer current collectors to test a hybrid adhesive/ultrasonic metal weld joint. Approximately 0.07 g of electrically conductive adhesive was applied to the four welds, then ultrasonics were applied to the joint with parameters of 1.5 s weld time, 18 psi cylinder pressure, and 80% amplitude. The joints were then connected to an Agilent E3633A DC power supply to test their current to failure. Because the power supply could not apply constant current at the resistance levels of the weld, voltage was increased to approximate 0.1 A increases in current. At each increase in current, the weld was allowed to sit for 1 min at that current level. The four hybrid samples had respective currents at failure of 0.3 A, 0.42 A, 1 A, and 0.42 A indicating that the joints did not have robust electrical connections. Cross-sections of the hybrid joints (FIG. 26) showed a small amount of electrically conductive adhesive penetration between layers. The cost of the electrically conductive adhesive is itself prohibitive for many applications, however there may be certain applications where using electrically conductive adhesive is more desirable than solder.

### Example 4—Solder Dipping (No Ultrasonics)

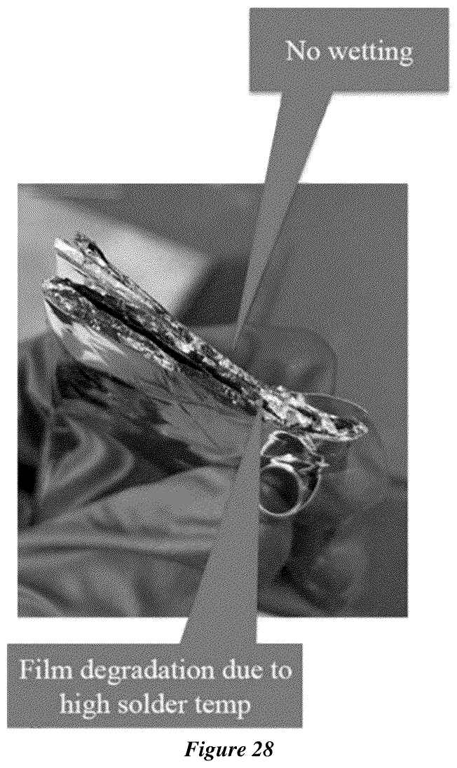

Solder dipping is another method to create z-axis conductivity between a stack of metallized polymer current collectors. By solder dipping, the through thickness connection can be made at the edges of the films, therefore, no through holes are necessary. Solder bath tests were performed by melting SAC305 solder on a hotplate. An image of the solder bath is shown in FIG. 27. Solder baths require an operating temperature that is significantly higher (e.g., by 80-100° C.) than the solder melting point (200° C.). Tests were performed by dipping a tab with 8 layers of film into solder (no ultrasonics) (FIG. 27). The hot plate temperature was 320° C. The results shows that there was no wetting and there was film degradation due to the high solder temperature (FIG. 28).

### Example 5—Ultrasonic solder dipping

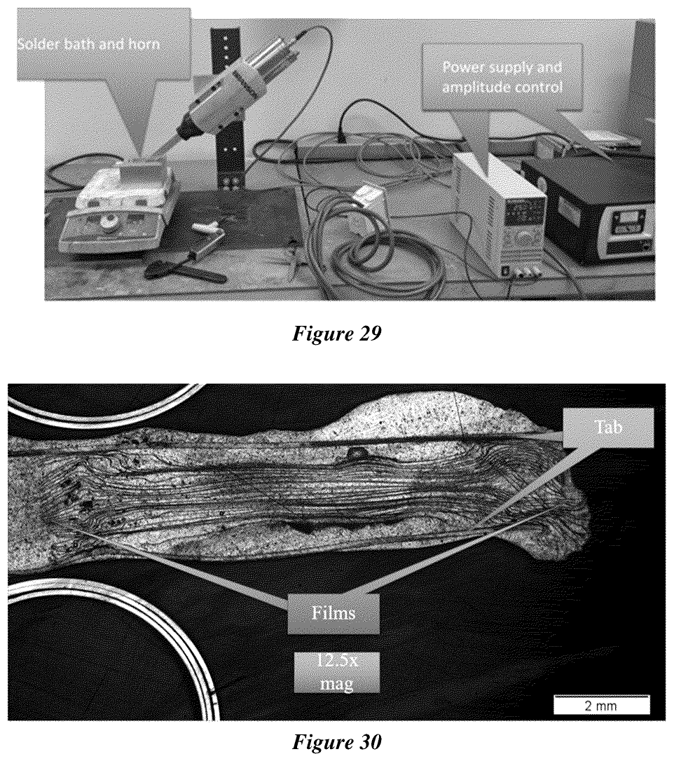

Ultrasonic solder dipping is a viable method of joining metallized polymer current collectors to themselves and a tab, where the ultrasonics promote wetting and bonding between the metallized current collectors/tab and the solder. An ultrasonic solder bath was created by machining a slot in a block of aluminum, which held the molten solder and was wide enough for an ultrasonic horn to be inserted at a 45° angle. The block of aluminum was set on top of a hotplate to provide the heating. The ultrasonic system used was a 20 kHz Branson DCX power supply with a 1:1 gain booster, and a custom-built rectangular aluminum horn. The ultrasonic solder bath system is shown in FIG. 29. The solder used for the ultrasonic solder bath was Sn-Zn alloy and the hot plate temperature was 270° C.

Solder dip samples were constructed by sandwiching 32 metallized polymer current collectors (25 mm width and 100 mm length) between two 0.1 mm thick aluminum tabs (15 mm width and 75 mm width). Two tabs were utilized in order to provide rigidity to the stack during dipping. At 90% amplitude significant solder adhesion to the film stack was seen. One test stack weighed 0.155 g before dipping and weighed 0.495 g after dipping for 15 seconds. A cross-section of a dipped stack can be seen in FIG. 30 showing significant solder adhesion.

### Example 6—UMW and Hybrid UMW/UAS Joints

Ultrasonic metal welding can be used to join MPCC's to a tab, however the joint between the tab and the films is not consistent. Immediately following UMW the tab may fall off of the welded films. Ultrasonic metal welds of 32 aluminum metallized polymer current collectors to a 0.1 mm thick aluminum tab were made using a Branson L20 ultrasonic welder with the tab on the anvil side. The tabs had dimensions of approximately 15 mm width by 75 mm length. The films had approximate dimensions of 25 mm width and 100 mm length, with a 20 mm overlap with the tab. Welds were made using parameters of 550 J (energy mode), 80 psi weld pressure, and an amplitude of 72-microns. 21 welds were made with the aforementioned parameters and configuration. The ultrasonic horn was 12 mm by 12 mm with a flattened pyramid knurl pattern. 13 of the welds had a tab that was bonded to the films. For the other 8 welds, the tab immediately fell off the stack of films following welding.

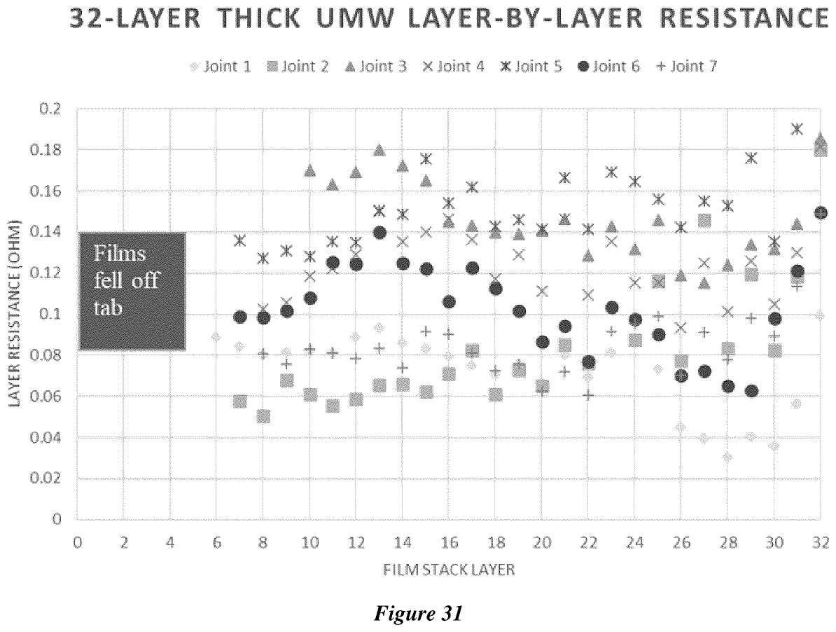

Layer-by-layer resistances of the hybrid joints was analyzed with the four-point probe function of a Hewlett Packard 34401A multimeter. The probes that applied current were clipped to the end of the tab and the end of the film in question. One voltage probe was placed 5 mm away from the edge of the weld, the other was placed on the tab, 5 mm from the edge of the metallized polymer current collector film stack, on the tab. First, the topmost film was analyzed for resistance, then peeled off of the stack. Additionally, an insulating film was placed between the film in question and the films below. Reading hold setting from multimeter gives resistance value when three consecutive readings within 0.1% of “sensitivity band” are found. The layer-by-layer resistance measurements of the seven ultrasonic metal welds are shown in FIG. 31. In all 7 of the joints, the last 5-10 films fell off upon attempting to analyze them, indicating a poor mechanical bond of the films closest to the tabs. The average resistance of an individual MPCC in the ultrasonic metal welds was 0.11 ohms.

Full stack peel and pull testing was done with the ultrasonic metal welds and hybrid joints using an Instron 4468 tensile tester. A 50 lbf force transducer (Omega Engineering) was set in the top tensile tester grip and connected to a data acquisition system which collected peak load. The force transducer had a wire connected to a mechanical grip to hold onto the samples in question. The crosshead speed used during testing was 100 mm/min. For full stack pull testing, all the films in the stack (32) were held by the force transducer grip while the tab was held by the bottom tensile tester grip. For full stack peel testing, the portion of the tab extending past the weld region was held in the force transducer grip, while the films were folded 180° and held in the bottom grip.

Three ultrasonic metal welds were tested for both full stack pull and peel strength. The peak loads in pull were: 56.5 N, 39.1 N, and 19.6 N. The peak loads in peel were 1.3 N, 0.9 N, and 0.9 N. For the ultrasonic metal welds in both peel and pull, failure occurred at the interface between the tab and the films.

Hybrid ultrasonic metal weld (UMW) and ultrasonic assisted solder (UAS) joints can be made by performing ultrasonic assisted soldering on a metallized polymer current collector ultrasonic metal weld. Ultrasonic metal welds of 32 aluminum metallized polymer current collectors to a 0.1 mm thick aluminum tab were made using a Branson L20 ultrasonic welder. The tabs had dimensions of approximately 15 mm width by 75 mm length. The films had approximate dimensions of 25 mm width and 100 mm length, with a 20 mm overlap with the tab. Welds were made using parameters of 550 J (energy mode), 80 psi weld pressure, and an amplitude of 72-micron. The ultrasonic horn was 12 mm by 12 mm with a flattened pyramid knurl pattern. 21 ultrasonic metal welds were made in order to create hybrid joints. Of the 21 ultrasonic metal welds, 14 had the tab bonded to the stack of films. For the other 7 welds, the tab immediately fell off of the stack of films, following welding.

The ultrasonic assisted soldering of the hybrid joints was performed with a Branson 2000ae ultrasonic welder with a 40 kHz converter, 1:1 gain booster, 1:1.5 gain flat horn, and a hotplate set on the welder anvil. For the ultrasonic assisted soldering 0.5 seconds of weld time, 24 psi cylinder pressure, 100% amplitude and a hotplate setpoint of 217° C. was used. For each hybrid joint, approximately 0.1 g of flattened SAC305 solder rod was used.

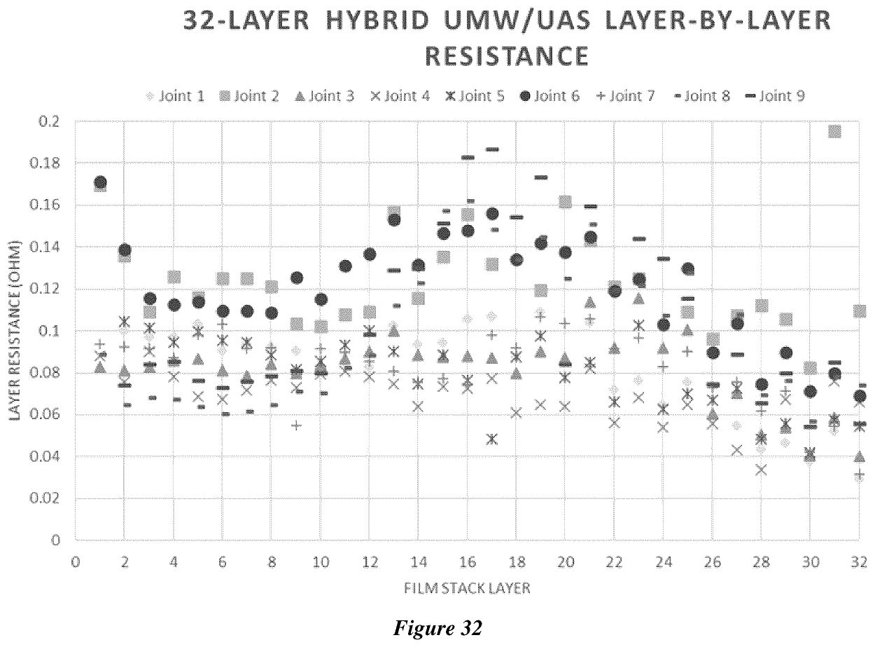

Layer-by-layer resistances of the hybrid joints was analyzed with the four-point probe function of a Hewlett Packard 34401A multimeter. The probes that applied current were clipped to the end of the tab and the end of the film in question. One voltage probe was placed 5 mm away from the edge of the weld, the other was placed on the tab, 5 mm from the edge of the metallized polymer current collector film stack, on the tab. First, the topmost film was analyzed for resistance, then peeled off of the stack. Additionally, an insulating film was placed between the film in question and the films below. Reading hold setting from multimeter gives resistance value when three consecutive readings within 0.1% of “sensitivity band” are found. The layer-by-layer resistance measurements of the 9 hybrid joints are shown in FIG. 32. The average resistance of an individual MPCC in the hybrid joints was 0.098 ohms.

Three hybrid joints were tested for both full stack pull and full stack peel strength. The peak loads in pull were: 60.5 N, 70.7 N, and 5.3 N. For two out of three of the hybrid joints (full stack pull), failure occurred in the tab. The full stack pull sample that failed at 5.3 N displayed failure at the interface of the tab and films. The peak loads in peel were 1.8 N, 6.7 N, and 3.6 N. All three of the full stack peel hybrid samples failed at the interface of the tab and films.

The average individual layer resistance of the hybrid joints was 0.12 ohms less than the ultrasonic metal welds, likely due to the solder penetration. However, in both processes, the ultrasonic metal weld struggles to consistently bond the stack of films to the tab. Additionally, the ultrasonic metal welding step (in both processes) required the maximum weld pressure to join 32 films to a tab. With more than 32 films, the ultrasonic metal welder was unable to penetrate the film stack to create the weld.

### Example 7—Through Hole Ultrasonic Assisted Soldering of 64 Film Thick Joints, Layer by Layer Resistance Measurements, Full Stack and Layer by Layer Mechanical Measurements

Consistent film to tab joints can be made by actuating horn when solder is at elevated temperature, but still a solid. The horn compresses the solid/semi-solid solder and causes it to expand against film-hole walls. A high “trigger force” gives solder time-under-pressure to rapidly heat up before ultrasonics is applied. Trigger force is the parameter set to activate ultrasonics once a certain cylinder pressure is achieved. “High trigger force” in this context would be a trigger force that is just slightly lower than the cylinder pressure in order to maximize the time under pressure before ultrasonics are actuated.

Samples were prepared from 64 films Al attached to a tab. A single 4 mm through hole was made in the sample using a hole punch tool. 12 solder joints were prepared with the same parameters. Of those 13 samples, 11 were analyzed layer by layer, I was excluded (excessive solder sticking to Kapton tape on horn surface), and I was cross-sectioned.

The ultrasonic assisted soldering was performed with a Branson 2000ae ultrasonic welder with a 40 kHz converter, 1:1 gain booster, 1:1.5 gain flat horn, and a hotplate set on the welder anvil. The ultrasonic assisted soldering parameters were: 0.6 second weld time, 80% amplitude, 217° C. hot plate temperature, tab on bottom (hot plate), 0.1-0.12g of SAC solder (wire solder flattened with hammer to ˜4 mm diameter, solder consumable height ˜1-1.5 mm (64 metallized polymer current collector films=0.5 mm)). Sources of variation in ultrasonic assisted soldering included: shape of solder consumable (height, weight, fit in through hole, area contacting hot tab); temperature of solder consumable when horn makes contact (time from placement of solder with tweezers to actuation of ultrasonic horn); horn temperature (joints were made individually); solder interaction with Kapton on horn; quality of through hole cut; and placement of joint/parallelism of setup.

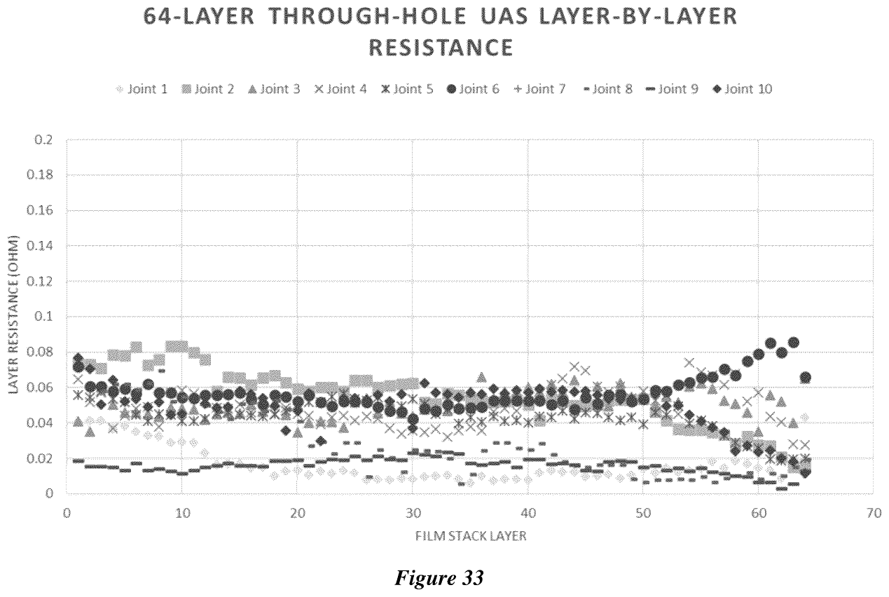

Layer-by-layer resistances of the hybrid joints was analyzed with the four-point probe function of a Hewlett Packard 34401A multimeter. The probes that applied current were clipped to the end of the tab and the end of the film in question. One voltage probe was placed 5 mm away from the edge of the weld, the other was placed on the tab, 5 mm from the edge of the metallized polymer current collector film stack, on the tab. First, the topmost film would be analyzed for resistance, then peeled off of the stack. Additionally, an insulating film would be placed between the film in question and the films below. Reading hold setting from multimeter gives resistance value when three consecutive readings within 0.1% of “sensitivity band” are found. Composite results for the layer-by-layer measurements are shown in FIG. 33. The layer-by-layer results indicate that 64-film think joints can consistently be made with low-resistances. The film-to-film resistances are relatively consistent.

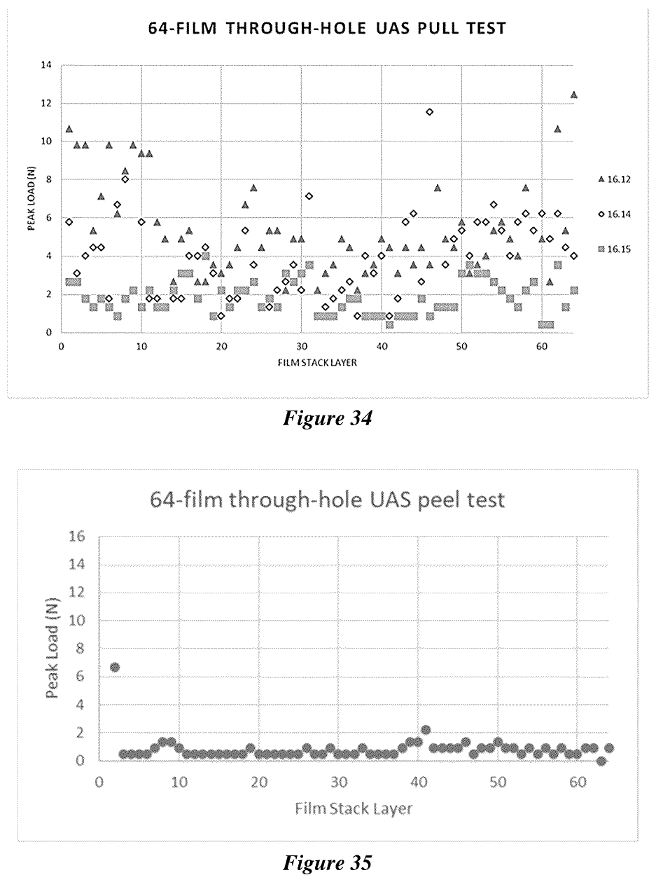

Layer-by-layer mechanical testing was done on the 64-film thick through-hole ultrasonic assisted soldering joints using an Instron 4468 tensile tester. A 50 lbf force transducer (Omega Engineering) was set in the top tensile tester grip and connected to a data acquisition system which collected peak load. The force transducer had a wire connected to a mechanical grip to hold onto the samples in question. The crosshead speed used during testing was 100 mm/min. For the layer-by-layer pull testing, a single layer would be clamped in the force transducer grip and the tab would be clamped in the bottom tensile tester grip. Three joints were analyzed for layer-by-layer pull strength; the results can be seen in FIG. 34. The average layer-by-layer pull strength for the two samples was 5.30, 3.81 N, and 1.86 N, respectively.

For the layer-by-layer peel testing, the portion of the tab extending past the weld region was held in the force transducer grip, while the films were folded 180° and held in the bottom grip. One joint was analyzed for layer-by-layer peel strength, the results can be seen in FIG. 35. The average layer-by-layer peel strength for the one sample was 0.8 N.

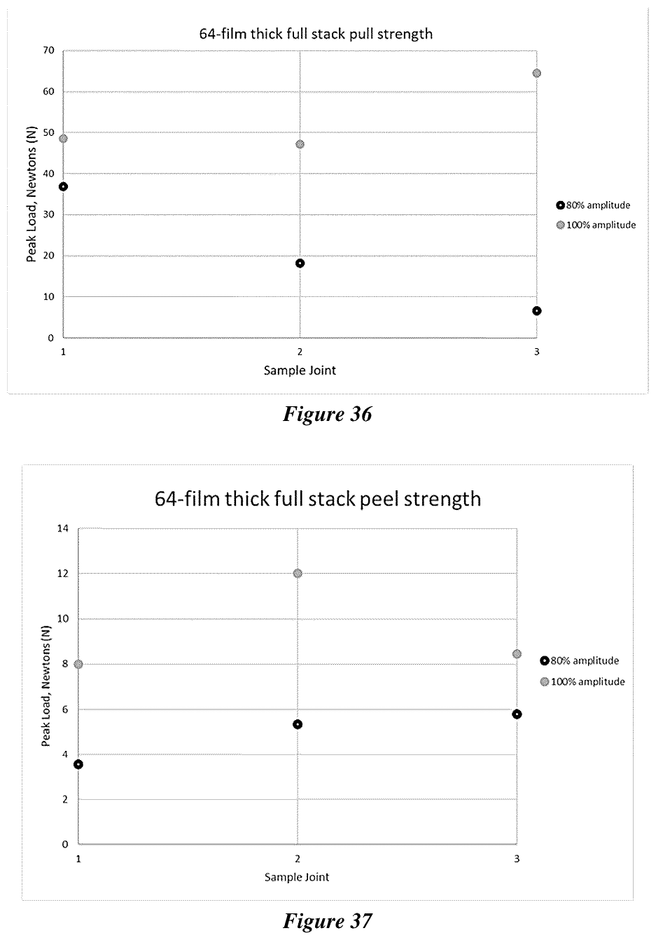

Full stack peel and pull testing was done with the 64-film thick through-hole ultrasonic assisted soldering joints using an Instron 4468 tensile tester. For both pull and peel testing two sets of samples were made, one with 80% amplitude and another with 100% amplitude (all other materials and methods identical to described above, in example 6). A 50 lbf force transducer was set in the top tensile tester grip and connected to a data acquisition system which collected peak load. The force transducer had a wire connected to a mechanical grip to hold onto the samples in question. The crosshead speed used during testing was 100 mm/min. For full stack pull testing, all the films in the stack (64) were held by the force transducer grip while the tab was held by the bottom tensile tester grip. The results of the full stack pull testing at 80% and 100% amplitude can be seen in FIG. 36. At 80% amplitude, failure occurred at the interface of the solder and the tab. At 100% amplitude the failure occurred in the tab, at higher peak loads (compared to 80% amplitude).

For full stack peel testing, the portion of the tab extending past the weld region was held in the force transducer grip, while the films were folded 180° and held in the bottom grip. The results of the full stack peel testing at 80% and 100% amplitude can be seen in FIG. 37. At 80% amplitude, failure occurred at the interface of the solder and the tab. At 100% amplitude the failure occurred in the tab, at higher peak loads (compared to 80% amplitude).

### Example 8—Through Hole Ultrasonic Assisted Soldering of 32 Film Thick Joints with 1:1.5 Booster, Double Tab, and Layer-by-Layer Mechanical Testing

Full stack mechanical testing in Example 6 demonstrated that increasing amplitude can improve mechanical properties for through hole ultrasonic assisted soldering joints. However, with the booster used in Example 6, the amplitude could not be increased further. Therefore, to investigate the effects of further increasing amplitude, a 1:1.5 booster was utilized in this example. Ultrasonic assisted soldering was performed with a Branson 2000ae ultrasonic welder with a 40 kHz converter, 1:1.5 gain booster, 1:1.5 gain flat horn, and a hotplate set on the welder anvil. 32 aluminum metallized polymer current collectors were joined to a 0.1 mm aluminum tab, with the same geometry and methods described in Example 6.

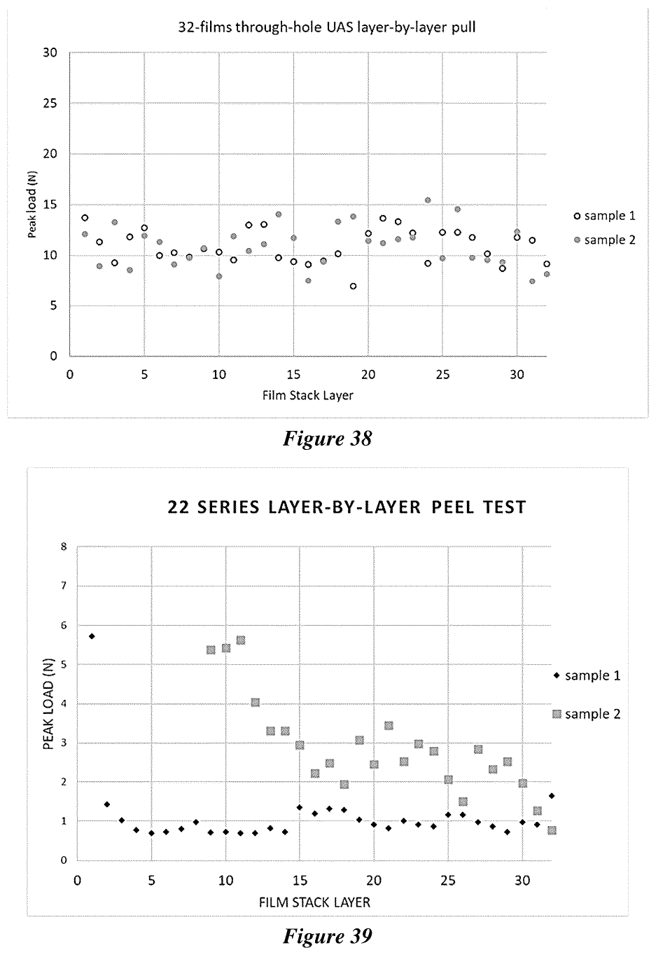

Two samples were created for layer-by-layer pull testing. The first sample (sample ID 22.1) had parameters of 26 psi weld cylinder pressure, 219° C., 0.6 weld time, and 65% amplitude. The second sample (sample ID 22.2) had parameters of 26 psi weld cylinder pressure, 219° C., 0.25 weld time, and 95% amplitude. The results of the layer-by-layer peel testing can be seen in FIG. 38. Sample 22.1 had an average layer peak pull load of 10.88, sample 22.2 had an average layer peak pull load of 10.90 N. When comparing to the layer-by-layer pull testing shown in FIG. 34 (1:1) booster, increasing the amplitude by changing the booster had a positive effect on the peak pull loads.

Two samples were created for layer-by-layer peel testing. The first sample (sample ID 22.3) had parameters of 24 psi weld cylinder pressure, 219° C., 0.6 weld time, and 60% amplitude. The second sample (sample ID 22.4) had parameters of 26 psi weld cylinder pressure, 219° C., 0.25 weld time, and 95% amplitude. The results of the layer-by-layer peel testing can be seen in FIG. 39. Sample 22.3 had an average layer peak peel load of 1.11, sample 22.4 had an average layer peak peel load of 2.89 N. When comparing to the layer-by-layer peel testing shown in FIG. 35 (1:1) booster, increasing the amplitude by changing the booster had a positive effect on the peak peel loads.

In addition to increasing the amplitude with a 1:1.5 booster, a tab on both the top and bottom of the film stack may also further improve mechanical properties by applying a compressive force to the films and altering the stress concentrations within the joints. With the 1:1.5 booster, double-tab samples were made for layer-by-layer mechanical testing. To create samples with a tab on top and bottom, the tab would be folded over so the ultrasonic horn would contact the tab on top.

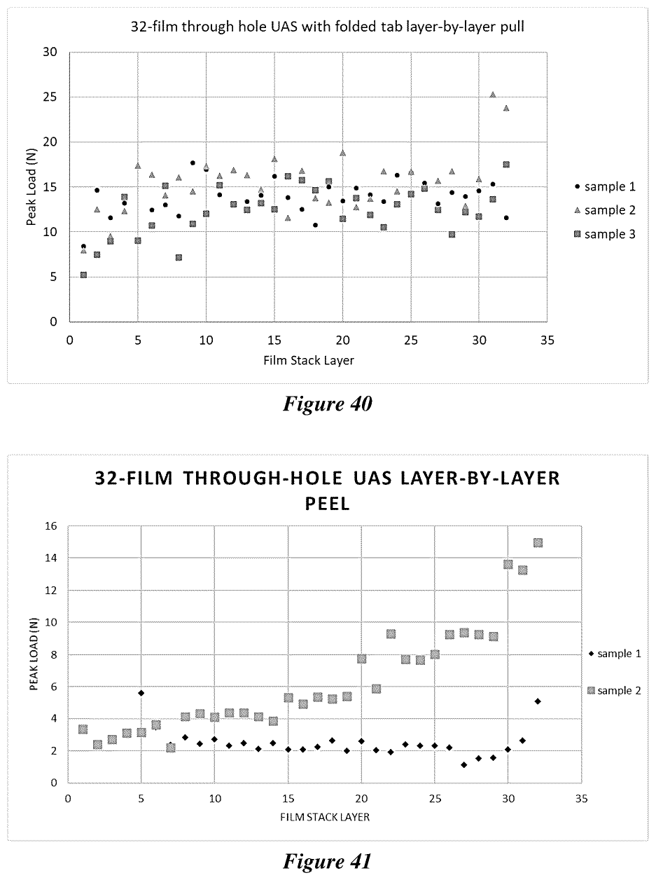

Three samples were created for layer-by-layer pull testing (1:1.5 booster, double tab). The first sample (sample ID 21.9) had parameters of 24 psi weld cylinder pressure, 217° C., 0.3 s weld time, and 95% amplitude. The second sample (sample ID 21.10) had parameters of 24 psi weld cylinder pressure, 217° C., 0.25 s weld time, and 95% amplitude. The third sample (sample ID 21.11) had parameters of 24 psi weld cylinder pressure, 217° C., 0.25 s weld time, and 92% amplitude. The results of the layer-by-layer pull testing can be seen in FIG. 40. Sample 21.9, 21.10, and 21.11 had average layer peak pull loads of 13.71 N, 15.45 N, and 12.39 N, respectively.

Two samples were created for layer-by-layer peel testing (1:1.5 booster, double tab). The first sample (sample ID 21.12) had parameters of 26 psi weld cylinder pressure, 219° C., 0.27 s weld time, and 95% amplitude. The second sample (sample ID 21.14) had parameters of 26 psi weld cylinder pressure, 219, 0.6 weld time, and 60% amplitude. The results of the layer-by-layer peel testing can be seen in FIG. 41. Sample 21.12, and 21.14 had average layer peak peel loads of 2.51 N and 6.3 N, respectively.

### Example 9—Through Hole Ultrasonic Assisted Soldering of 1 Film Thick Joints with 1:1.5 Booster, Single Tab, and Resistance and Pull Strength Measurements

The through-hole ultrasonic assisted soldering method can also be used to join a single film to a tab, such as in a cylindrical cell. The purpose of the through-hole is to create an electrical connection between both sides of the metallized polymer current collector and the tab. Samples were prepared by punching a 4 mm diameter through hole in aluminum metallized polymer current collector sheets (25 mm width by 100 mm length) and stacking the punched film over an aluminum tab (15 mm width by 75 mm length) with a 20 mm overlap (through-hole centered within overlap). The ultrasonics were applied using a Branson 2000ae ultrasonic welder with a 40 kHz converter, 1:1.5 gain booster, 1:1.5 gain flat horn and a hotplate set on the welder anvil. The ultrasonic horn was covered with Kapton tape to prevent solder sticking.

A solder consumable (0.1 g of ⅛″ diameter Sn-Zn wire solder hammered flat) was placed in the through-hole, under the ultrasonic horn prior to horn actuation. The hot plate readout temperature was 209° C. The ultrasonic parameters used were: 30% amplitude, 1.5 seconds weld time, and 25 psi weld pressure.

The resistances of the through-hole single film to tab joints were analyzed with the four-point probe function of a Hewlett Packard 34401A multimeter. Each side of the metallized current collector was separately measured. The probes that applied current were clipped to the end of the tab and the end of the film in question. One voltage probe was placed 5 mm away from the edge of the weld, the other was placed on the tab, 5 mm from the edge of the metallized polymer current collector film, on the tab. An insulating film was placed between the side of the metallized film that was not being measured and the probes. The resistances are shown in Table 1, where the A side of the film is the side facing away from the tab.

TABLE 1
Electrical resistances for through hole ultrasonic
assisted soldering of 1 film thick joints.

| Sample | A side (Ω) | B side (Ω) |
|---|---|---|
| 1 | 0.030 | 0.020 |
| 2 | 0.016 | 0.034 |
| 3 | 0.014 | 0.017 |
| 4 | 0.033 | 0.025 |
| 5 | 0.021 | 0.037 |

Mechanical testing of the through-hole single film to tab joints was done by pull testing the film against the tab in an Instron 4468 tensile tester. A 50 lbf. force transducer (Omega Engineering) was set in the top tensile tester grip and connected to a data acquisition system which collected peak load. The force transducer had a wire connected to a mechanical grip to hold onto the samples in question. The crosshead speed used during testing was 100 mm/min. The results of the pull testing are shown in Table 2.

TABLE 2
Peak pull loads for mechanical testing of through hole
ultrasonic assisted soldering of 1 film thick joints.

| Sample | Peak Pull (lbf) |
|---|---|
| 1 | 3.11 |
| 2 | 4.095 |
| 3 | 3.53 |
| 4 | 1.58 |
| 5 | 2.16 |

### Example 10—Folded Tab Ultrasonic Assisted Soldering of 1 Film Thick Joints with 1:1.5 Booster, Single Tab, and Resistance and Pull Strength Measurements

An alternative method to create an electrical connection between both sides of a single metallized polymer current collector and a tab is to bend the tab in a U-shape to contact both sides of the film and creating ultrasonic solder joints at both film-tab interfaces.

To create the joints a single tab (15 mm width by 75 mm length) was folded around a single aluminum metallized polymer current collector (25 mm width by 100 mm length) parallel to the long axis. Ultrasonic assisted soldering of 1 film thick joints was done with a Branson 2000ae ultrasonic welder with a 40kHz converter, 1:1.5 gain booster, 1:1.5 gain flat horn and a hotplate set on the welder anvil. The ultrasonic horn was covered with Kapton tape to prevent solder sticking.

A solder consumable (0.1 g of ⅛″ diameter Sn-Zn wire solder hammered flat) was placed at both of the interfaces between tab and film, under the ultrasonic horn prior to horn actuation. The hot plate readout temperature was 209° C. The ultrasonic parameters used were: 30% amplitude, 1.5 seconds weld time, and 25 psi weld pressure.

The resistances of the through-hole single film to tab joints were analyzed with the four-point probe function of a Hewlett Packard 34401A multimeter. Each side of the metallized current collector was separately measured. The probes that applied current were clipped to the end of the tab (where it was folded) and the end of the film in question. One voltage probe was placed 5 mm away from the edge of the weld, the other was placed on the tab, 5 mm from the edge of the metallized polymer current collector film, on the tab. An insulating film was placed between the side of the metallized film that was not being measured and the probes. The resistances are shown in Table 3, where the A side of the film is the side facing away from the tab.

TABLE 3
Electrical resistances for folded tab ultrasonic
assisted soldering of 1 film thick joints.

| Sample | A side (Ω) | B side (Ω) |
|---|---|---|
| 1 | 0.053 | 0.034 |
| 2 | 0.036 | 0.046 |
| 3 | 0.054 | 0.046 |

Mechanical testing of the folded tab single film to tab joints was done by pull testing the film against the tab in an Instron 4468 tensile tester. A 50 lbf. force transducer (Omega Engineering) was set in the top tensile tester grip and connected to a data acquisition system which collected peak load. The force transducer had a wire connected to a mechanical grip to hold onto the samples in question. The crosshead speed used during testing was 100 mm/min. The results of the pull testing are shown in Table 4.

TABLE 4
Peak pull loads for mechanical testing of folded tab
ultrasonic assisted soldering of 1 film thick joints.

| Sample | Peak Pull (lbf) |
|---|---|
| 1 | 3.38 |
| 2 | 3.83 |
| 3 | 4.12 |

### Example 11—Joining of Single Film to Tab with Active Solder

Active solders are a type of solder that contain elements that will react with surface oxides on metals in order to provide a clean metal surface that the solder can bond with (R. Smith, Welding Journal, Vol. 80, Issue 10, 2001). Active elements include In, Ti, Hf, and Zr. Active solders do not require chemical fluxes as the active elements act as flux that disrupt surface oxides (R. Smith, Welding Journal, Vol. 80, Issue 10, 2001). However, active solders must be mechanically disrupted due to the oxide that forms on the molten solder surface (R. Smith, Welding Journal, Vol. 80, Issue 10, 2001). Methods of mechanical disruption include wire brushing, abrasion, or application of ultrasonics (R. Smith, Welding Journal, Vol. 80, Issue 10, 2001). Active solders can be used to join metallized polymer current collectors to themselves and to tabs. It is possible that active solders can be used in ultrasonic assisted soldering, which would allow a decreased amplitude of vibration, and reduce damage due to excess amplitude of vibration.

Active solder alloy SB220 was purchased for S-bond Technologies in order to test the feasibility of joining metallized polymer current collectors to a tab using active solder. SB220 was purchased in the form of 33.3-gram ingots and was re-melted to create small 0.1g solder consumables.

Using a single aluminum metallized polymer current collector (25 mm width by 100 mm length) was placed over a 0.1 mm thick aluminum tab (15 mm width by 75 mm length) with 0.1 gram of active solder in between. The metallized polymer current collector and tab was placed on a hotplate with a temperature of 210° C. and the metallized polymer current collector was mechanically agitated by moving the metallized polymer current collector in small circles for one minute. When the metallized polymer current collector and tab were taken off the hotplate and allowed to cool, bonding was seen between the metallized polymer current collector and tab.

### EXEMPLARY ASPECTS

In view of the described lithium ion conductors and batteries (such as pseudo solid-state and all solid-state batteries) and methods of making and use thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.

Example 1: A joining method (e.g., a method of forming a joined material), the method comprising: placing one or more metallized polymer current collectors proximate a tab, such that at least a portion of the one or more metallized polymer current collectors overlaps with at least a portion of the tab in an overlap region; placing a conductive material proximate the overlap region; inducing flow of the conductive material such that the conductive material flows at least between the portion of the one or more metallized polymer current collectors and the portion of the tab in the overlap region; and subsequent to inducing flow, solidifying the conductive material, thereby forming a joint that joins the one or more metallized polymer current collectors to the tab; wherein each of the one or more of metallized polymer current collectors independently comprises: a polymer layer having a first surface and a second surface opposite and spaced apart from the first surface; a first metal layer disposed on the first surface of the polymer layer; and a second metal layer disposed on the second surface of the polymer layer; such that the polymer layer is sandwiched between and in physical contact with the first metal layer and the second metal layer.

Example 2: The method of any examples herein, particularly example 1, wherein inducing flow of the conductive material comprises applying ultrasonics, applying thermal energy, or a combination thereof.

Example 3: The method of any examples herein, particularly example 2, wherein inducing flow comprises applying ultrasonics.

Example 4: The method of any examples herein, particularly example 3, wherein the method further comprises: positioning at least a portion of the one or more polymer current collectors, at least a portion of the tab, and at least a portion of the conductive material between an ultrasonic horn and an anvil; subsequently applying ultrasonics for an amount of time via the ultrasonic horn to thereby induce flow of the conductive material; and after the amount of time, ceasing to apply ultrasonics.

Example 5: The method of any examples herein, particularly example 4, wherein the ultrasonic horn comprises a knurled horn.

Example 6: The method of any examples herein, particularly examples 3-5, wherein ultrasonics are applied for an amount of time of from 0.1 second to 10 seconds.

Example 7: The method of any examples herein, particularly examples 3-6, wherein the ultrasonics are applied at an amplitude of from 1 μm to 50 μm.

Example 8: The method of any examples herein, particularly examples 3-7, wherein the method further comprises applying a pressure to at least a portion of the one or more metallized polymer current collectors during the application of ultrasonics, wherein the pressure is from 0.1 psi to 100 psi.

Example 9: The method of any examples herein, particularly examples 3-8, wherein inducing flow further comprises applying thermal energy before and/or concurrently with the application of ultrasonics in order to induce flow of the conductive material.

Example 10: The method of any examples herein, particularly examples 2-9, wherein the method further comprises ceasing ultrasonics, removing thermal energy, or a combination thereof thereby solidifying the conductive material.

Example 11: The method of any examples herein, particularly examples 1-10, further comprising forming a stack having a plurality of layers comprising the one or more metallized polymer current collectors, the stack extending from a top surface to a bottom surface, such that:

placing the one or more metallized polymer current collectors on the tab comprises placing the stack on the tab, inducing flow of the conductive material further causes the conductive material to flow between at least partially between each of the plurality of layers, and the joint formed by the method further joins the plurality of layers of the stack together.

Example 12: The method of any examples herein, particularly example 11, wherein forming the stack comprises stacking and/or folding the one or more metallized polymer current collectors.

Example 13: The method of any examples herein, particularly example 11 or example 12, wherein the one or more metallized polymer current collectors comprises a plurality of metallized polymer current collectors and forming the stack comprises stacking the plurality of metallized polymer current collectors on top of each other from a first metallized polymer current collector to a last metallized polymer current collector, such that: the second metal layer of a preceding metallized polymer current collector is disposed above and proximate to the first metal layer of a subsequent metallized polymer current collector; the first metal layer of the first metallized polymer current collector is the top surface of the stack; and the second metal layer of the last metallized polymer current collector is the bottom surface of the stack.

Example 14: The method of any examples herein, particularly examples 11-13, wherein a gap exists between at least a portion of a preceding layer and a subsequent layer within the stack. Example 15: The method of any examples herein, particularly examples 11-14, wherein at least a portion of a preceding layer is disposed on and in physical contact with a subsequent layer within the stack.

Example 16: The method of any examples herein, particularly examples 1-15, wherein at least a portion of one or more of the one or more metallized polymer current collectors further comprises a texture (e.g., such that said portion is not flat).

Example 17: The method of any examples herein, particularly example 16, further comprising texturing at least a portion of one or more of the one or more metallized polymer current collectors.

Example 18: The method of any examples herein, particularly examples 1-17, wherein one or more of the one or more metallized polymer current collectors further comprises a puncture (e.g., one or more punctures) extending through said metallized polymer current collector.

Example 19: The method of any examples herein, particularly examples 11-17, wherein the stack further comprises a puncture (e.g., one or more punctures) extending through the stack, the top surface, and the bottom surface.

Example 20: The method of any examples herein, particularly example 18 or example 19, further comprising creating said puncture.

Example 21: The method of any examples herein, particularly example 20, wherein creating the puncture comprises using a punching tool, a laser, ultrasonic welding, chemical etching, or a combination thereof.

Example 22: The method of any examples herein, particularly examples 18-21, wherein inducing flow of the conductive material further causes the conductive material to flow at least partially through the puncture.

Example 23: The method of any examples herein, particularly examples 1-22, wherein the total number of metallized polymer current collectors is from 1 to 1000.

Example 24: The method of any examples herein, particularly examples 1-23, wherein the total number of metallized polymer current collectors is 3 or more, 8 or more, 16 or more, 32 or more, or 64 or more.

Example 25: The method of any examples herein, particularly examples 1-24, wherein each of the one or more metallized polymer current collectors independently has an average thickness of from 1 micrometer to 50 micrometers.

Example 26: The method of any examples herein, particularly examples 1-25, wherein the polymer layer of each of the one or more metallized polymer current collectors independently has an average thickness of from 1 micrometer to 50 micrometers.

Example 27: The method of any examples herein, particularly examples 1-26, wherein the polymer layer of each of the one or more metallized polymer current collectors independently comprises polypropylene, polyethylene, polyethylene terephthalate (PET), polyethylene napthalate (PEN), polyvinyl alcohol (PVA), polyaramid (e.g., Kevlar, Nomex), polyamides (e.g., nylon), polyimide (e.g., Kapton), derivatives thereof, or combinations thereof.

Example 28: The method of any examples herein, particularly examples 1-27, wherein the first metal layer of each of the one or more metallized polymer current collectors independently has an average thickness of from 10 nanometers to 5 micrometers.

Example 29: The method of any examples herein, particularly examples 1-28, wherein the first metal layer of each of the one or more metallized polymer current collectors independently comprises Al, Cu, Zn, Sn, Si, Pb, Ti, Li, or a combination thereof.

Example 30: The method of any examples herein, particularly examples 1-29, wherein the second metal layer of each of the one or more metallized polymer current collectors independently has an average thickness of from 10 nanometers to 5 micrometers.

Example 31: The method of any examples herein, particularly examples 1-30, wherein the second metal layer of each of the one or more metallized polymer current collectors independently comprises Al, Cu, Zn, Sn, Si, Pb, Ti, Li, or a combination thereof.

Example 32: The method of any examples herein, particularly examples 1-31, wherein the first metal layer and the second metal layer of each of the one or more metallized polymer current collectors independently are substantially the same.

Example 33: The method of any examples herein, particularly examples 1-32, wherein each of the one or more metallized polymer current collectors is substantially the same.

Example 34: The method of any examples herein, particularly examples 1-33, wherein the conductive material comprises soldering material.

Example 35: The method of any examples herein, particularly example 34, wherein the method comprises ultrasonic assisted soldering.

Example 36: The method of any examples herein, particularly example 34 or example 35, wherein the method comprises fluxless ultrasonic assisted soldering.

Example 37: The method of any examples herein, particularly examples 1-36, wherein the conductive material comprises an electrically conductive adhesive.

Example 38: The method of any examples herein, particularly example 37, wherein placing the conductive material proximate the overlap region comprises coating at least a portion of the one or more metallized polymer current collectors, at least a portion of the tab, or a combination thereof with the electrically conductive adhesive.

Example 39: The method of any examples herein, particularly example 37 or example 38, wherein the electrically conductive adhesive comprises an adhesive and a plurality of electrically conductive particles.

Example 40: The method of any examples herein, particularly examples 37-39, wherein the electrically conductive adhesive comprises an electrically conductive polymer.

Example 41: The method of any examples herein, particularly examples 1-40, wherein the joint and/or the joined material has improved mechanical and/or electrical properties relative to a joint and/or joined material made by a different method.

Example 42: The method of any examples herein, particularly examples 1-41, wherein the joint has an average mechanical pull strength of from 1 Newton (N) to 100 N, an average mechanical peel strength of from 0.1 N to 20 N, or a combination thereof.

Example 43: The method of any examples herein, particularly examples 1-42, wherein the joint and/or the joined material supports a current of 1 milliAmpere (mA) or more for an amount of time of 1 second or more.

Example 44: The method of any examples herein, particularly examples 1-43, wherein the join and/or the joined material has a resistance of 1 ohms or less.

Example 45: A device comprising the joint and/or joined material made by the method of any examples herein, particularly examples 1-44.

Example 46: The device of any examples herein, particularly example 45, wherein the device comprises an energy storage device, an electronic device, or a combination thereof.

Example 47: The device of any examples herein, particularly example 45 or example 46, wherein the device comprises a battery, a capacitor, or a supercapacitor.

Example 48: The device of any examples herein, particularly examples 45-47, wherein the device comprises a lithium ion battery.

Example 49: A joined material made by the method of any examples herein, particularly examples 1-44.

Example 50: A joined material comprising: one or more metallized polymer current collectors, a tab, and a conductive material; wherein the one or more metallized polymer current collectors are joined to the tab via a joint; wherein the joint comprises a conductive material; wherein at least a portion of the joint is sandwiched between the tab and the one or more metallized current collectors; and wherein each of the one or more of metallized polymer current collectors independently comprises: a polymer layer having a first surface and a second surface opposite and spaced apart from the first surface; a first metal layer disposed on the first surface of the polymer layer; and a second metal layer disposed on the second surface of the polymer layer; such that the polymer layer is sandwiched between and in physical contact with the first metal layer and the second metal layer.

Example 51: The joined material of any examples herein, particularly example 50, wherein the conductive material is not the same material as the tab and/or the one or more metallized current collectors.

Example 52: The joined material of any examples herein, particularly example 50 or example 51, wherein the one or more metallized current collectors comprise a stack having a plurality of layers, the stack extending from a top surface to a bottom surface, and wherein the conductive material is further disposed between at least a portion of each of the plurality of layers such that the plurality of layers are joined together.

Example 53: The joined material of any examples herein, particularly example 52, wherein a gap exists between at least a portion of a preceding layer and a subsequent layer within the stack.

Example 54: The joined material of any examples herein, particularly example 52 or example 53, wherein at least a portion of a preceding layer is disposed on and in physical contact with a subsequent layer within the stack.

Example 55: The joined material of any examples herein, particularly examples 50-54, wherein at least a portion of one or more of the one or more metallized polymer current collectors further comprises a texture (e.g., such that said portion is not flat).

Example 56: The joined material of any examples herein, particularly examples 50-55, wherein one or more of the one or more metallized polymer current collectors further comprises a puncture (e.g., one or more punctures) extending through said metallized polymer current collector.

Example 57: The joined material of any examples herein, particularly examples 52-56, wherein the stack further comprises a puncture (e.g., one or more punctures) extending through the stack, the top surface, and the bottom surface.

Example 58: The joined material of any examples herein, particularly example 56 or example 57, wherein the puncture is at least partially filled with the conductive material.

Example 59: The joined material of any examples herein, particularly examples 50-58, wherein the total number of metallized polymer current collectors is from 1 to 1000.

Example 60: The joined material of any examples herein, particularly examples 50-59, wherein the total number of metallized polymer current collectors is 3 or more, 8 or more, 16 or more, 32 or more, or 64 or more.

Example 61: The joined material any examples herein, particularly examples 50-60, wherein each of the one or more metallized polymer current collectors independently has an average thickness of from 1 micrometer to 50 micrometers.

Example 62: The joined material of any examples herein, particularly examples 50-61, wherein the polymer layer of each of the one or more metallized polymer current collectors independently has an average thickness of from 1 micrometer to 50 micrometers.

Example 63: The joined material of any examples herein, particularly examples 50-62, wherein the polymer layer of each of the one or more metallized polymer current collectors independently comprises polypropylene, polyethylene, polyethylene terephthalate (PET), polyethylene napthalate (PEN), polyvinyl alcohol (PVA), polyaramid (e.g., Kevlar, Nomex), polyamides (e.g., nylon), polyimide (e.g., Kapton), derivatives thereof, or combinations thereof.

Example 64: The joined material of any examples herein, particularly examples 50-63, wherein the first metal layer of each of the one or more metallized polymer current collectors independently has an average thickness of from 10 nanometers to 5 micrometers.

Example 65: The joined material of any examples herein, particularly examples 50-64, wherein the first metal layer of each of the one or more metallized polymer current collectors independently comprises Al, Cu, Zn, Sn, Si, Pb, Ti, Li, or a combination thereof.

Example 66: The joined material of any examples herein, particularly examples 50-65, wherein the second metal layer of each of the one or more metallized polymer current collectors independently has an average thickness of from 10 nanometers to 5 micrometers.

Example 67: The joined material of any examples herein, particularly examples 50-66, wherein the second metal layer of each of the one or more metallized polymer current collectors independently comprises Al, Cu, Zn, Sn, Si, Pb, Ti, Li, or a combination thereof.

Example 68: The joined material of any examples herein, particularly examples 50-67, wherein the first metal layer and the second metal layer of each of the one or more metallized polymer current collectors independently are substantially the same.

Example 69: The joined material of any examples herein, particularly examples 50-68, wherein each of the one or more metallized polymer current collectors is substantially the same.

Example 70: The joined material of any examples herein, particularly examples 50-69, wherein the conductive material comprises soldering material.

Example 71: The joined material of any examples herein, particularly examples 50-70, wherein the conductive material comprises an electrically conductive adhesive.

Example 72: The joined material of any examples herein, particularly example 71, wherein the electrically conductive adhesive comprises an adhesive and a plurality of electrically conductive particles.

Example 73: The joined material of any examples herein, particularly example 71 or example 72, wherein the electrically conductive adhesive comprises an electrically conductive polymer.

Example 74: The joined material of any examples herein, particularly examples 50-73, wherein the joint and/or the joined material has improved mechanical and/or electrical properties.

Example 75: The joined material of any examples herein, particularly examples 50-74, wherein the joint has an average mechanical pull strength of from 1 Newton (N) to 100 N, an average mechanical peel strength of from 0.1 N to 20 N, or a combination thereof.

Example 76: The joined material of any examples herein, particularly examples 50-75, wherein the joint and/or the joined material supports a current of 1 milliAmpere (mA) or more for an amount of time of 1 second or more.

Example 77: The joined material of any examples herein, particularly examples 50-76, wherein the join and/or the joined material has a resistance of 1 ohms or less.

Example 78: A method of making the joined material of any examples herein, particularly examples 50-77, the method comprising the method of any examples herein, particularly examples 1-44.

Example 79: A device comprising the joined material of any examples herein, particularly examples 50-77.

Example 80: The device of any examples herein, particularly example 79, wherein the device comprises an energy storage device, an electronic device, or a combination thereof.

Example 81: The device of any examples herein, particularly example 79 or example 80, wherein the device comprises a battery, a capacitor, or a supercapacitor.

Example 82: The device of any examples herein, particularly examples 79-81, wherein the device comprises a lithium ion battery.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods, compositions, and devices of the appended claims are not limited in scope by the specific methods, compositions, and devices described herein, which are intended as illustrations of a few aspects of the claims and any methods, compositions, or devices that are functionally equivalent are intended to fall within the scope of the claims. Various modifications of the methods, compositions, and devices in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A method of forming a joined material, the method comprising:
placing one or more metallized polymer current collectors proximate a tab, such that at least a portion of the one or more metallized polymer current collectors overlaps with at least a portion of the tab in an overlap region;
placing a conductive material proximate the overlap region;
inducing flow of the conductive material such that the conductive material flows at least between the portion of the one or more metallized polymer current collectors and the portion of the tab in the overlap region; and
subsequent to inducing flow, solidifying the conductive material, thereby forming a joint that joins the one or more metallized polymer current collectors to the tab;
wherein each of the one or more of metallized polymer current collectors independently comprises:
a polymer layer having a first surface and a second surface opposite and spaced apart from the first surface;
a first metal layer disposed on the first surface of the polymer layer; and
a second metal layer disposed on the second surface of the polymer layer;
such that the polymer layer is sandwiched between and in physical contact with the first metal layer and the second metal layer.

2. The method of claim 1, wherein inducing flow of the conductive material comprises applying ultrasonics, applying thermal energy, or a combination thereof.

3. The method of claim 2, wherein inducing flow comprises applying ultrasonics.

4. The method of claim 3, wherein the method further comprises:
positioning at least a portion of the one or more polymer current collectors, at least a portion of the tab, and at least a portion of the conductive material between an ultrasonic horn and an anvil;
subsequently applying ultrasonics for an amount of time via the ultrasonic horn to thereby induce flow of the conductive material; and
after the amount of time, ceasing to apply ultrasonics.

5. The method of claim 3, wherein inducing flow further comprises applying thermal energy before and/or concurrently with the application of ultrasonics in order to induce flow of the conductive material.

6. The method of claim 2, wherein the method further comprises ceasing ultrasonics, removing thermal energy, or a combination thereof thereby solidifying the conductive material.

7. The method of claim 1, further comprising forming a stack having a plurality of layers comprising the one or more metallized polymer current collectors, the stack extending from a top surface to a bottom surface, such that:
placing the one or more metallized polymer current collectors on the tab comprises placing the stack on the tab,
inducing flow of the conductive material further causes the conductive material to flow between at least partially between each of the plurality of layers,
and the joint formed by the method further joins the plurality of layers of the stack together.

8. The method of claim 1, wherein at least a portion of one or more of the one or more metallized polymer current collectors further comprises a texture, such that said portion is not flat.

9. The method of claim 1, wherein one or more of the one or more metallized polymer current collectors further comprises a puncture extending through said metallized polymer current collector, and inducing flow of the conductive material further causes the conductive material to flow at least partially through the puncture.

10. The method of claim 7, wherein the stack further comprises a puncture extending through the stack, the top surface, and the bottom surface, and inducing flow of the conductive material further causes the conductive material to flow at least partially through the puncture.

11. The method of claim 1, wherein the total number of metallized polymer current collectors is from 1 to 1000.

12. The method of claim 1, wherein each of the one or more metallized polymer current collectors independently has an average thickness of from 1 micrometer to 50 micrometers.

13. The method of claim 1, wherein the polymer layer of each of the one or more metallized polymer current collectors independently comprises polypropylene, polyethylene, polyethylene terephthalate (PET), polyethylene napthalate (PEN), polyvinyl alcohol (PVA), polyaramid, polyamides, polyimide, derivatives thereof, or combinations thereof.

14. The method of claim 1, wherein each of the one or more metallized polymer current collectors is substantially the same.

15. The method of claim 1, wherein the conductive material comprises soldering material and/or an electrically conductive adhesive.

16. The method of claim 1, wherein the joint has an average mechanical pull strength of from 1 Newton (N) to 100 N, an average mechanical peel strength of from 0.1 N to 20 N, or a combination thereof.

17. The method of claim 1, wherein the joint and/or the joined material: supports a current of 1 milliAmpere (mA) or more for an amount of time of 1 second or more; has a resistance of 1 ohms or less; or a combination thereof.

18. A device comprising the joint and/or joined material made by the method of claim 1.

19. A joined material made by the method of claim 1.

20. A joined material comprising:
one or more metallized polymer current collectors, a tab, and a conductive material;
wherein the one or more metallized polymer current collectors are joined to the tab via a joint;
wherein the joint comprises a conductive material;
wherein at least a portion of the joint is sandwiched between the tab and the one or more metallized current collectors; and
wherein each of the one or more of metallized polymer current collectors independently comprises:
a polymer layer having a first surface and a second surface opposite and spaced apart from the first surface;
a first metal layer disposed on the first surface of the polymer layer; and
a second metal layer disposed on the second surface of the polymer layer;
such that the polymer layer is sandwiched between and in physical contact with the first metal layer and the second metal layer.
